(19) United States
(12) Patent Application Publication
(10) Pub. No.: US 2020/0027176 A1
(43) Pub. Date: Jan. 23, 2020

(54) SYSTEM, APPARATUS AND METHOD FOR ORGANIZING RESTAURANT TASKS AND PATRONS' AFFAIRS

(71) Applicants: Serfass Jack, Naples, FL (US); Serfass Nadine, Naples, FL (US); Turner M. Phil, Naples, FL (US)

(72) Inventors: Serfass Jack, Naples, FL (US); Serfass Nadine, Naples, FL (US); Turner M. Phil, Naples, FL (US)

(21) Appl. No.: 15/676,840

(22) Filed: Aug. 14, 2017

Related U.S. Application Data
(60) Provisional application No. 62/494,547, filed on Aug. 12, 2016.

(51) Int. Cl. G06Q 50/12; G06Q 10/08; G06Q 30/06

(52) U.S. Cl. CPC G06Q 50/12; G06Q 30/0635; G06Q 10/087

(57) ABSTRACT

A computer-based, cloud-oriented restaurant management system is provided to manage various logistical operations of a restaurant. Databases containing highly specific data tables related to the managed restaurant functions are contained within the cloud-based portion of the system. Independent and distinct client applications are provided on mobile devices located in the restaurant and operated by restaurant patrons, managers, and staff to interact with the cloud-oriented system portion and perform those operations. The client applications operate in several modes depending on the user of the devices and the level of database access granted to the users. Virtual wine lockers having gifting capabilities and kitchen management applications are two such restaurant system managed functions.

### CROSS-REFERENCE TO RELATED APPLICATIONS

This application is a non-provisional U.S. Patent Application that claims priority to U.S. Provisional Patent Applications, Ser. No. 62/494,547, titled “SYSTEM, APPARATUS AND METHOD FOR ORGANIZING RESTAURANT TASKS AND PATRONS' AFFAIRS,” filed on Aug. 12, 2016. The entire contents of this patent applications are incorporated by reference into the present patent application as if set forth herein in its entirety.

### COPYRIGHT & TRADEMARK/TRADENAME NOTICES

Certain marks referenced herein may be common law or registered trademarks of the applicant, the assignee or third-parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

### 1. Field of the Invention

The invention relates to computer-based systems, apparatus, and methods for organizing, operating, and implementing restaurant-related service functions. Cloud-based software and data storage environments are created to store and run computer programs that implement these restaurant-centric functions. Data generated and/or used by the cloud-based software and related to the restaurant operation is stored within the computer-based cloud structures. Client-based software applications, each directed to a different aspect of restaurant management, are accessed through graphical interfaces on mobile devices, as well as dedicated software on desktop and laptop devices or through equivalent cloud-accessible network interfaces on the same. The mobile devices contain local applications related to the restaurant functions and are used by restaurant patrons and managers to interact with and use the overall restaurant management system. System management functions, whether performed by the restaurant managers or by the overall restaurant system operator, can be also accessed by more powerful desktop and laptop personal computers and servers. Restaurant-centric system applications are innumerable but may include such functions as providing virtual wine lockers, providing digital menus for facilitating food and wine selections, providing training and presentation applications and metrics, and providing applications for preparing kitchens and bars for future use. In each of these activities, software applications within the system of the present invention make it easier to run the restaurant more efficiently and uniformly. Thus, the computer-based applications of the present system operate certain logistical aspects of the restaurant while allowing the patrons to enjoy the services associated with the dining experience unimpaired by the complications of the background logistics in providing those services and thereby enhancing the dining experience.

### 2. Description of Related Art

The US restaurant industry is estimated at approximately $1.4 trillion dollars in size. Despite this, computer-based automation has not been heretofore efficiently implemented for many of the more routine and mundane tasks performed as part of a restaurant's operations. This causes a fundamental portion of the restaurant's operation to be inherently disconnected from the hospitality and dining experience that patrons have come to expect. This is particularly acute at more-exclusive, high-quality dining establishments. The physical functions and operations of restaurant management distract the restaurant service personnel and its management from their customers (or patrons). Consequently, the physical means presently used to perform those functions can be often distracting or disappointing, at best, and unappealing at worst.

The table menus at most restaurants are still printed on paper. In fact, the majority of most current restaurant operations is conducted on paper. Most restaurants operate with antiquated manual systems running the restaurant's operational logistics, including everything from inventory management, preparation lists, training manuals, and table order recordation and transmittal to the kitchen. All this paper generates waste, requires paper replacement copies, and is notoriously error prone. In fact, most restaurant complaints are service-related and can often be traced to failures within the presently-used antiquated operational systems. These factors ultimately distract from a high-quality dining experience from the patron's perspective.

Further, lack of computer-based infrastructure leads to inefficiencies and waste that affect the restaurant owners as compared to its patrons. This waste occurs in many forms such as wasted time by the kitchen and wait staff the form of lost, missing, or incorrect food orders, and wasted food purchases by the restaurant due to inventory management failures. All of this results in lost restaurant profits and dissatisfied customers.

Prior art systems are known that address a host of specific problems concerning a restaurant's operation but not in the way and manner of the present invention.

One such system is provided in U.S. Pat. No. 8,560,394, issued Oct. 15, 2013 to Martucci et al. Martucci, et al. discloses a system for aiding a restaurant patron to make a wine selection from wines available in the restaurant wine inventory includes a plurality of dedicated patron display devices and a content management system including a processor, a communications interface and a database wherein the dedicated patron display devices are operable to receive and display screens transmitted from the content management system and transmit patron input to the content management system in order to select a wine from the restaurant inventory. (Abstract.) However, because of its limited databases structures and system interactions, Martucci et al. is only capable of performing the simplest of wine ordering functions and inventory control. Martucci et al. and does not operate to provide a restaurant system that can accommodate more complex and complete restaurant functions such as virtual wine lockers and kitchen preparation functions.

Another restaurant management system is provided in U.S. Pat. No. 8,620,763, issued Dec. 31, 2013 to Burns et al. Burns, et al. discloses a restaurant management system and method interface in which data from various restaurant operations is collected and stored for processing. The data is processed into useful metrics, such as those indicative of various categories of restaurant staffing, efficiency, performance and quality. The useful metrics can be displayed as a human-readable charts, graphs, or reports. The data can be processed in real time, permitting managers to promptly make adjustments and to alert restaurant workers or crew members of deficiencies so that prompt and effective remedial action can be taken to improve restaurant performance. Reports may be generated that provide the performance of restaurants individually and as a combined group. However, again because of its limited databases structures and system interactions, Burns, et al. is only capable of performing the most simple of restaurant management functions and in the context of a fast food establishment. Burns, et al. does not operate to provide a restaurant system that can accommodate more complex and complete restaurant functions such as virtual wine lockers and kitchen preparation functions.

Thus, a need exists in the art for an improved, computer-implemented, cloud-based restaurant management system that facilitates multiple operational aspects of a restaurant. In the present system, the majority of the system is ideally located off-site so that physical facilities are not required for much of the hardware, data storage and operational software. Further, the need exists for client-side, computer-based applications to be developed for these systems.

### BRIEF SUMMARY OF THE INVENTION

In one embodiment, a computer-based restaurant management system for storing and retrieving wines is provided within a restaurant, the computer-based restaurant management system including a computer-based mobile network, the computer-based restaurant management system comprising at least one computer-based mobile device employed by a restaurant patron within the restaurant management system, the mobile device coupled to the computer-based mobile network, the mobile device including a processor and an associated memory for storing instructions executed by the processor, the mobile device including a virtual wine locker client application operated from the associated memory by the processor; a computer-based cloud network, the computer-based cloud network coupled to the computer-based mobile network and the at least one computer-based mobile device, the computer-based cloud network implementing a virtual wine locker content management system for storing an inventory of wine for the restaurant patron, the virtual wine locker content management system including an application programing interface managed by the computer-based cloud network; a database managed by the computer-based cloud network, the application programming interface coupled to the database and transmitting computer-based instructions between the virtual wine locker client application operating on the mobile device and the database, the database containing a plurality of data tables, the date tables including a wine locker table containing wine locker owner data, a locker wines table containing at least one bottle of wine having a identifying wine id, and a venue wine database containing a bottle sales price; and wherein the application programming interface transmits the bottle sale price data to the virtual wine locker client application and the restaurant patron transmits a purchase message including the wine locker owner data to the application programming interface in response thereto, the application programming interface updating the locker wines table to include the wine having the identifying wine id.

In another embodiment, a computer-implemented method is provided for storing and retrieving wines within a restaurant using a computer-based restaurant management system coupled to a computer-based mobile network, the computer-based restaurant management system including at least one computer-based mobile device employed by a restaurant patron, the at least one mobile device including a processor and an associated memory for storing instructions executed by the processor, the at least one mobile device including a virtual wine locker client application operating from the associated memory under the direction of the processor, the computer-based restaurant management system including a computer-based cloud network, the computer-based cloud network coupled to the computer-based mobile network and the at least one computer-based mobile device, the computer-based cloud network implementing a virtual wine locker content management system for storing an inventory of wine for the restaurant patron, the virtual wine locker content management system including an application programing interface managed by the computer-based cloud network; the method includes transmitting with the applications program interface to the at least one computer-based mobile device a bottle sales price data from a venue wine data table, the database including the venue wine data table; receiving the bottle sales price data at the virtual wine locker client application; transmitting a purchase message including wine locker owner data from the virtual wine locker application on the at least one computer-based mobile device to the application programming interface, the wine locker owner data being contained within a wine locker table within the database; and updating a locker wines table having the wine locker owner data with an identifying wine id from a locker wines table, the locker wines table. The objects and features of the present invention may be applied jointly or severally in any combination or sub-combination by those skilled in the art.

### BRIEF DESCRIPTION OF THE SEVERAL VIEWS OF THE DRAWING(S)

Detailed embodiments of the present invention(s) are disclosed herein; however, it is to be understood that the disclosed embodiments are merely exemplary of the invention(s), which may be embodied in various forms. Therefore, specific structural and functional details disclosed herein are not to be interpreted as limiting, but merely as a basis for the claims and as a representative basis for teaching one skilled in the art to variously employ the present invention(s) in virtually any appropriately-detailed structure. Further, the terms and phrases used herein are not intended to be limiting, but rather to provide an understandable description of the invention(s).

The accompanying drawings, which are incorporated in and constitute part of this specification, illustrate embodiments and/or aspects of the invention and/or disclosure, and together with the written description, these drawings serve to explain the principles of the invention. Wherever possible, the same reference numbers are used throughout the drawings to refer to the same or like elements of an embodiment. The embodiments illustrated herein are presently preferred, it being understood, however, that the invention is not limited to the precise arrangements and instrumentalities shown, in which:

FIG. 1 shows a block diagram of the overall system architecture of the restaurant management system according to one embodiment of the present invention;

FIG. 2A shows an application level system diagram for the Virtual Wine Locker software application according to one embodiment of the present invention;

FIG. 2B shows an application process flow in connection with the Virtual Wine Locker software application of FIG. 2A according to one embodiment of the present invention;

FIG. 2C shows a computer rendered screen display as provided by the hardware and software implementing the present invention and displaying various data elements of the Virtual Wine Locker software application according to one embodiment of the present invention;

FIG. 2D shows a computer rendered screen display as provided by the hardware and software implementing the present invention and displaying various data elements of the Virtual Wine Locker software application according to one embodiment of the present invention;

FIG. 2E shows a computer rendered screen display as provided by the hardware and software implementing the present invention and displaying various data elements of the Virtual Wine Locker software application according to one embodiment of the present invention;

FIG. 2F shows a computer rendered screen display as provided by the hardware and software implementing the present invention and displaying various data elements of the Virtual Wine Locker software application according to one embodiment of the present invention;

FIG. 2G shows a computer rendered screen display as provided by the hardware and software implementing the present invention and displaying various data elements of the Virtual Wine Locker software application according to one embodiment of the present invention;

FIG. 2H shows a computer rendered screen display as provided by the hardware and software implementing the present invention and displaying various data elements of the Virtual Wine Locker software application according to one embodiment of the present invention;

FIG. 2I shows a computer rendered screen display as provided by the hardware and software implementing the present invention and displaying various data elements of the Virtual Wine Locker software application according to one embodiment of the present invention;

FIG. 2J shows a computer rendered screen display as provided by the hardware and software implementing the present invention and displaying various data elements of the Virtual Wine Locker software application according to one embodiment of the present invention;

FIG. 2K shows a computer rendered screen display as provided by the hardware and software implementing the present invention and displaying various data elements of the Virtual Wine Locker software application according to one embodiment of the present invention;

FIG. 2L shows a computer rendered screen display as provided by the hardware and software implementing the present invention and displaying various data elements of the Virtual Wine Locker software application according to one embodiment of the present invention;

FIG. 2M shows a computer rendered screen display as provided by the hardware and software implementing the present invention and displaying various data elements of the Virtual Wine Locker software application according to one embodiment of the present invention;

FIG. 2N shows a computer rendered screen display as provided by the hardware and software implementing the present invention and displaying various data elements of the Virtual Wine Locker software application according to one embodiment of the present invention;

FIG. 2O shows a computer rendered screen display as provided by the hardware and software implementing the present invention and displaying various data elements of the Virtual Wine Locker software application according to one embodiment of the present invention;

FIG. 2P shows a computer rendered screen display as provided by the hardware and software implementing the present invention and displaying various data elements of the Virtual Wine Locker software application according to one embodiment of the present invention;

FIG. 2Q shows a computer rendered screen display as provided by the hardware and software implementing the present invention and displaying various data elements of the Virtual Wine Locker software application according to one embodiment of the present invention;

FIG. 2R shows a computer rendered screen display as provided by the hardware and software implementing the present invention and displaying various data elements of the Virtual Wine Locker software application according to one embodiment of the present invention;

FIG. 2S shows a computer rendered screen display as provided by the hardware and software implementing the present invention and displaying various data elements of the Virtual Wine Locker software application according to one embodiment of the present invention;

FIG. 2T shows a computer rendered screen display as provided by the hardware and software implementing the present invention and displaying various data elements of the Virtual Wine Locker software application according to one embodiment of the present invention;

FIG. 2U shows a computer rendered screen display as provided by the hardware and software implementing the present invention and displaying various data elements of the Virtual Wine Locker software application according to one embodiment of the present invention;

FIG. 2W shows a computer rendered screen display as provided by the hardware and software implementing the present invention and displaying various data elements of the Virtual Wine Locker software application according to one embodiment of the present invention;

FIG. 2X shows a computer rendered screen display as provided by the hardware and software implementing the present invention and displaying various data elements of the Virtual Wine Locker software application according to one embodiment of the present invention;

FIG. 2Y shows a computer rendered screen display as provided by the hardware and software implementing the present invention and displaying various data elements of the Virtual Wine Locker software application according to one embodiment of the present invention;

FIG. 2Z shows a computer rendered screen display as provided by the hardware and software implementing the present invention and displaying various data elements of the Virtual Wine Locker software application according to one embodiment of the present invention;

FIG. 2AA shows a computer rendered screen display as provided by the hardware and software implementing the present invention and displaying various data elements of the Virtual Wine Locker software application according to one embodiment of the present invention;

FIG. 2AB shows a computer rendered screen display as provided by the hardware and software implementing the present invention and displaying various data elements of the Virtual Wine Locker software application according to one embodiment of the present invention;

FIG. 2AC shows a computer rendered screen display as provided by the hardware and software implementing the present invention and displaying various data elements of the Virtual Wine Locker software application according to one embodiment of the present invention;

FIG. 2AD shows a computer rendered screen display as provided by the hardware and software implementing the present invention and displaying various data elements of the Virtual Wine Locker software application according to one embodiment of the present invention;

FIG. 2AE shows a computer rendered screen display as provided by the hardware and software implementing the present invention and displaying various data elements of the Virtual Wine Locker software application according to one embodiment of the present invention;

FIG. 2AF shows a computer rendered screen display as provided by the hardware and software implementing the present invention and displaying various data elements of the Virtual Wine Locker software application according to one embodiment of the present invention;

FIG. 2AG shows a computer rendered screen display as provided by the hardware and software implementing the present invention and displaying various data elements of the Virtual Wine Locker software application according to one embodiment of the present invention;

FIG. 2AH shows a computer rendered screen display as provided by the hardware and software implementing the present invention and displaying various data elements of the Virtual Wine Locker software application according to one embodiment of the present invention;

FIG. 2AI shows a computer rendered screen display as provided by the hardware and software implementing the present invention and displaying various data elements of the Virtual Wine Locker software application according to one embodiment of the present invention;

FIG. 2AJ shows a computer rendered screen display as provided by the hardware and software implementing the present invention and displaying various data elements of the Virtual Wine Locker software application according to one embodiment of the present invention;

FIG. 2AK shows a computer rendered screen display as provided by the hardware and software implementing the present invention and displaying various data elements of the Virtual Wine Locker software application according to one embodiment of the present invention;

FIG. 2AL shows a computer rendered screen display as provided by the hardware and software implementing the present invention and displaying various data elements of the Virtual Wine Locker software application according to one embodiment of the present invention;

FIG. 2AM shows a computer rendered screen display as provided by the hardware and software implementing the present invention and displaying various data elements of the Virtual Wine Locker software application according to one embodiment of the present invention;

FIG. 2AN shows a computer rendered screen display as provided by the hardware and software implementing the present invention and displaying various data elements of the Virtual Wine Locker software application according to one embodiment of the present invention;

FIG. 2AO shows a computer rendered screen display as provided by the hardware and software implementing the present invention and displaying various data elements of the Virtual Wine Locker software application according to one embodiment of the present invention;

FIG. 2AP shows a computer rendered screen display as provided by the hardware and software implementing the present invention and displaying various data elements of the Virtual Wine Locker software application according to one embodiment of the present invention;

FIG. 2AQ shows a computer rendered screen display as provided by the hardware and software implementing the present invention and displaying various data elements of the Virtual Wine Locker software application according to one embodiment of the present invention;

FIG. 2AR shows a computer rendered screen display as provided by the hardware and software implementing the present invention and displaying various data elements of the Virtual Wine Locker software application according to one embodiment of the present invention;

FIG. 2AS shows a computer rendered screen display as provided by the hardware and software implementing the present invention and displaying various data elements of the Virtual Wine Locker software application according to one embodiment of the present invention;

FIG. 2AT shows a computer rendered screen display as provided by the hardware and software implementing the present invention and displaying various data elements of the Virtual Wine Locker software application according to one embodiment of the present invention;

FIG. 2AU shows a computer rendered screen display as provided by the hardware and software implementing the present invention and displaying various data elements of the Virtual Wine Locker software application according to one embodiment of the present invention;

FIG. 2AV shows a computer rendered screen display as provided by the hardware and software implementing the present invention and displaying various data elements of the Virtual Wine Locker software application according to one embodiment of the present invention;

FIG. 2AW shows a computer rendered screen display as provided by the hardware and software implementing the present invention and displaying various data elements of the Virtual Wine Locker software application according to one embodiment of the present invention;

FIG. 2AX shows a computer rendered screen display as provided by the hardware and software implementing the present invention and displaying various data elements of the Virtual Wine Locker software application according to one embodiment of the present invention;

FIG. 2AY shows a computer rendered screen display as provided by the hardware and software implementing the present invention and displaying various data elements of the Virtual Wine Locker software application according to one embodiment of the present invention;

FIG. 2AZ shows a computer rendered screen display as provided by the hardware and software implementing the present invention and displaying various data elements of the Virtual Wine Locker software application according to one embodiment of the present invention;

FIG. 2AAA shows a computer rendered screen display as provided by the hardware and software implementing the present invention and displaying various data elements of the Virtual Wine Locker software application according to one embodiment of the present invention;

FIG. 2AAB shows a computer rendered screen display as provided by the hardware and software implementing the present invention and displaying various data elements of the Virtual Wine Locker software application according to one embodiment of the present invention;

FIG. 2AAC shows a computer rendered screen display as provided by the hardware and software implementing the present invention and displaying various data elements of the Virtual Wine Locker software application according to one embodiment of the present invention;

FIG. 3A shows an application level system diagram for the kitchen preparation software application (also called Kitchen Sync or KS) according to one embodiment of the present invention;

FIG. 3B shows an application process flow in connection with the kitchen preparation software application of FIG. 3A according to one embodiment of the present invention;

FIG. 3C shows a computer rendered screen display as provided by the hardware and software implementing the present invention and displaying various data elements of the kitchen preparation software application according to one embodiment of the present invention;

FIG. 3D shows a computer rendered screen display as provided by the hardware and software implementing the present invention and displaying various data elements of the kitchen preparation software application according to one embodiment of the present invention;

FIG. 3E shows a computer rendered screen display as provided by the hardware and software implementing the present invention and displaying various data elements of the kitchen preparation software application according to one embodiment of the present invention;

FIG. 3F shows a computer rendered screen display as provided by the hardware and software implementing the present invention and displaying various data elements of the kitchen preparation software application according to one embodiment of the present invention;

FIG. 3G shows a computer rendered screen display as provided by the hardware and software implementing the present invention and displaying various data elements of the kitchen preparation software application according to one embodiment of the present invention;

FIG. 3H shows a computer rendered screen display as provided by the hardware and software implementing the present invention and displaying various data elements of the kitchen preparation software application according to one embodiment of the present invention;

FIG. 3I shows a computer rendered screen display as provided by the hardware and software implementing the present invention and displaying various data elements of the kitchen preparation software application according to one embodiment of the present invention;

FIG. 3J shows a computer rendered screen display as provided by the hardware and software implementing the present invention and displaying various data elements of the kitchen preparation software application according to one embodiment of the present invention;

FIG. 3K shows a computer rendered screen display as provided by the hardware and software implementing the present invention and displaying various data elements of the kitchen preparation software application according to one embodiment of the present invention;

FIG. 3L shows a computer rendered screen display as provided by the hardware and software implementing the present invention and displaying various data elements of the kitchen preparation software application according to one embodiment of the present invention;

FIG. 3M shows a computer rendered screen display as provided by the hardware and software implementing the present invention and displaying various data elements of the kitchen preparation software application according to one embodiment of the present invention;

FIG. 3N shows a computer rendered screen display as provided by the hardware and software implementing the present invention and displaying various data elements of the kitchen preparation software application according to one embodiment of the present invention;

FIG. 3O shows a computer rendered screen display as provided by the hardware and software implementing the present invention and displaying various data elements of the kitchen preparation software application according to one embodiment of the present invention;

FIG. 3P shows a computer rendered screen display as provided by the hardware and software implementing the present invention and displaying various data elements of the kitchen preparation software application according to one embodiment of the present invention;

FIG. 3Q shows a computer rendered screen display as provided by the hardware and software implementing the present invention and displaying various data elements of the kitchen preparation software application according to one embodiment of the present invention;

FIG. 3R shows a computer rendered screen display as provided by the hardware and software implementing the present invention and displaying various data elements of the kitchen preparation software application according to one embodiment of the present invention;

FIG. 3S shows a computer rendered screen display as provided by the hardware and software implementing the present invention and displaying various data elements of the kitchen preparation software application according to one embodiment of the present invention;

FIG. 3T shows a computer rendered screen display as provided by the hardware and software implementing the present invention and displaying various data elements of the kitchen preparation software application according to one embodiment of the present invention;

FIG. 3U shows a computer rendered screen display as provided by the hardware and software implementing the present invention and displaying various data elements of the kitchen preparation software application according to one embodiment of the present invention;

FIG. 3V shows a computer rendered screen display as provided by the hardware and software implementing the present invention and displaying various data elements of the kitchen preparation software application according to one embodiment of the present invention;

FIG. 3W shows a computer rendered screen display as provided by the hardware and software implementing the present invention and displaying various data elements of the kitchen preparation software application according to one embodiment of the present invention;

FIG. 3X shows a computer rendered screen display as provided by the hardware and software implementing the present invention and displaying various data elements of the kitchen preparation software application according to one embodiment of the present invention;

FIG. 3Y shows a computer rendered screen display as provided by the hardware and software implementing the present invention and displaying various data elements of the kitchen preparation software application according to one embodiment of the present invention;

FIG. 3Z shows a computer rendered screen display as provided by the hardware and software implementing the present invention and displaying various data elements of the kitchen preparation software application according to one embodiment of the present invention;

FIG. 3AA shows a computer rendered screen display as provided by the hardware and software implementing the present invention and displaying various data elements of the kitchen preparation software application according to one embodiment of the present invention;

FIG. 3AB shows a computer rendered screen display as provided by the hardware and software implementing the present invention and displaying various data elements of the kitchen preparation software application according to one embodiment of the present invention;

FIG. 3AC shows a computer rendered screen display as provided by the hardware and software implementing the present invention and displaying various data elements of the kitchen preparation software application according to one embodiment of the present invention;

FIG. 3AD shows a computer rendered screen display as provided by the hardware and software implementing the present invention and displaying various data elements of the kitchen preparation software application according to one embodiment of the present invention;

FIG. 3AE shows a computer rendered screen display as provided by the hardware and software implementing the present invention and displaying various data elements of the kitchen preparation software application according to one embodiment of the present invention;

FIG. 3AF shows a computer rendered screen display as provided by the hardware and software implementing the present invention and displaying various data elements of the kitchen preparation software application according to one embodiment of the present invention;

FIG. 3AG shows a computer rendered screen display as provided by the hardware and software implementing the present invention and displaying various data elements of the kitchen preparation software application according to one embodiment of the present invention;

To facilitate understanding, identical reference numerals have been used, where possible, to designate identical elements that are common to the figures.

### DETAILED DESCRIPTION OF THE INVENTION

To facilitate a clear understanding of the present invention, illustrative examples are provided herein which describe certain aspects of the invention. However, it is to be appreciated that these illustrations are not meant to limit the scope of the invention and are provided herein to illustrate certain concepts associated with the invention.

It is also to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable computer architecture. Preferably, the machine is implemented on a computer platform having hardware such as one or more central processing units (CPU), a random-access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed. Specifically, any of the computers or devices may be interconnected using any existing or later-discovered networking technology and may also all be connected through a lager network system, such as a corporate network, metropolitan network, or a global network, such as the internet.

The entire description below is provided in the particular context of a restaurant management system. However, the invention of the present application is generally applicable to any consumer-based catering system in which computer-based management of physical, logistical considerations are required and in which the management of those logistics is integral with the service provided to a customer at the physical location of the service being provided. Further, the restaurant management system of the present invention is designed using commercially available cloud-based computing and hosting solutions. For clarity, cloud computing is a style of computing in which scalable and configurable information technology (IT) enabled capabilities are delivered as a service using internet technologies. Cloud infrastructure as a service (IaaS) is a type of cloud computing service and it parallels the infrastructure and physical data center initiatives of IT. The broader IaaS market also includes cloud storage and cloud printing. Other cloud-based services include cloud storage, platform as a service (PaaS), software as a service (SaaS), cloud service brokerage (CSB) or any other type of cloud service. Those of skill in the art realize that similar systems can be designed using standard IT components and services.

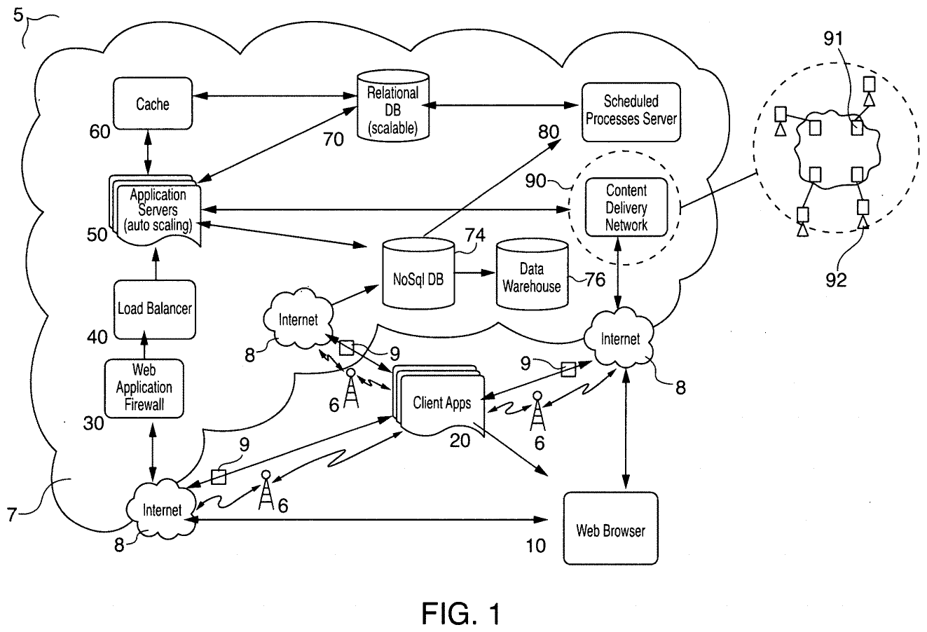

FIG. 1 shows a block diagram of the overall system architecture of the restaurant management system 5 of the present invention. Two physical system sub-portions, or regions, are shown containing the system components, including all hardware, software, and data elements. This arrangement is preferred as being one of the most economical and least intrusive system arrangements available to the restaurant operators.

The first system sub-portion is the cloud 7. Cloud 7 can be any cloud-oriented computer-based environment created using proprietary or commercially available cloud-based services, hardware, and software. Cloud 7 may be a private or public cloud-based computing, storage, and networking environment. Amazon Web Service (AWS) is one such suite of cloud- based services offered by Amazon. AWS provides, among other services, the following computer-based, cloud services in connection with the present invention: computing services, networking services, content delivery services, storage and database services, management services, application services and analytic services. Competitor cloud services providing similar functionality include Google Cloud Functions and Hewlett Packard Hybrid Cloud.

Cloud 7 is coupled to the non-cloud-based portion of the present invention through internet connections 8 and its associated hardware and software. Internet connections 8 may be any form of mobile, wireless, or fixed networking connections including but not limited to mobile network connection towers and Wi-Fi modems 6 or high-capacity fixed network facilities such as fiber-optic cables and associated modems, routers, and network connection points 9. It should be noted that while the specific examples provided herein are primarily directed to mobile devices operating within a mobile network, the general concepts of the system disclosed in this invention may be equally applied to any non-mobile devices connected to an associated network and where the associated network possesses similar system architectures and functional capabilities. Further, the actual mobile connections illustrated herein may be any one or combination of known or later-developed mobile access technologies, including by not limited to: cellular mobile, Wi-Fi, PAN, RFID, Bluetooth, NFC, radio, IR, and satellite. Finally, as used herein, the term “mobile network” is used to denote the sum of the wireless access devices and the entire network to which they provide wireless access. That means that the “mobile network” is the entire network found behind and including the sum of wireless access points and to which a mobile device may connect using any of the supported communications protocols. In this regard, the wireless network includes wireless and wired devices behind the wireless access cloud. The “mobile network” may be proprietary, a public cloud network or it may be considered to include the entire web or internet. In sum, the mobile network is the totality of all networked devices for which wireless access is permitted such that any mobile device may be provided access to public portions or user specific portions of the interconnected devices comprising both the wired and mobile portions of the network

The second system sub-portion, or region, is the client-side devices and their associated software 10 and 20. Web browser 10 may be any standard software application running on suitable computer-based hardware that is used to access and interact through the internet 8 and with cloud 7 and its associated components. Web browser 10 may reside on any computer device that support web browsing application such as a mobile device (e.g. iPad tablet, mobile phone, etc.) or a stand-alone non-mobile computing device (e.g. desktop or laptop personal computer, application server, blade server etc.). Client application(s) 20 are any number of computer applications that is used to access and interact through the internet 8 and with cloud 7 and its associated components. Client application(s) may reside on any computer-based device that has networking connectivity and preferably resides on a mobile device. Client applications include both patron-based applications for placing restaurant orders, as well as restaurant management applications used to perform restaurant management functions in satisfying those orders.

Whether accessed by the client applications 20 or through web browser 10, relational database(s) 70 are accessed through a series of cloud-based hardware and software components, applications, and related services. These include but are not limited to web application firewall 30, load balancer 40, a plurality of application servers 50 and cache 60. Similarly, client applications 20 access the non-relational database(s) 74 and data warehouse databases 76 through internet connections 8 and via restaurant-based networking facilities or commercial mobile networks.

A brief description of the cloud-based components is provided below including the AWS services that are used by the present invention to implements those functions. It should be appreciated that those of skill in the art can program custom individual pieces to implement the same or similar functions and that competing cloud-based services may alternatively be used to do the same.

Web application firewall 30 optimizes system website displays to provide best network performance. Firewall 30 also blocks threats and limits malware such as bots and crawlers, all in order to minimize spam and improve security overall system security.

Application servers 50 comprise a plurality of server machines (computing platforms) each independently running the restaurant management cloud-based application. The number of machines may be scaled manually or automatically depending on the system load at any particular time. The AWS Elastic Compute Cloud (EC2) is the preferred and present IaaS service providing virtual servers controllable by an API, based on the Xen hypervisor. Load balancer 40 directs incoming application traffic to the most available application server. The AWS Elastic Load Balancing (ELB) is the preferred and present load balancing service that automatically distributes incoming traffic across multiple AWS EC2 instances.

The AWS Elastic Beanstalk is the preferred and present IaaS service for hosting applications and encompasses the services provided by the web applications firewall 30, the load balancer 40 and the application servers 50.

Cache 60 is a highly available memory that stores responses to recent system requests. Cache 60 is capable of returning responses pertaining to duplicative or redundant requests from the client systems without accessing other larger and slower system databases. Amazon ElastiCache provides in-memory caching for web applications.

Scheduled processes server 80 is an application server dedicated to running scheduled processes. Amazon Simple Queue Service (SQS) provides a hosted message queue for web applications. This is needed to schedule processes to receive new/updated wine info from customer systems run in batch due to large volume of data. Data is separate so as not to impact speed of customer interactions with system data. In other examples, trending wines and newly added wines across the system highlight new and most popular wines to help with increased ROI.

Content delivery network 90 is a worldwide network for storing images and other file associated with the overall system and specifically the displays provided on the devices displaying the client applications. Client delivery network 90 is specifically designed for speed and reliability and distributes the network transmission functions to edge network nodes 91 and edge servers 92 so as to be in closer network proximity with the end clients. This is important given the data throughputs and file sizes involved in the transfers managed by system 5. The Simple Storage Service with the AWS CloudFront service is the present and preferred content delivery network (CDN) for distributing objects to network “edge locations” near the requester.

A plurality of different database storage solutions and related services are used within the present invention. Relational database (DB) 70 is a structured query language (SQL) database implementation solution for storing data. SQL DB 70 may consist of one or more actual physical databases, distributed geographically, within the cloud database structure of cloud 7. Further these DBs may be manually scaled with multiple read-only instances so as to increase response times during peak system usage. Amazon Relational Database Service (RDS) provides scalable database servers with MySQL, Oracle, SQL Server, and PostgreSQL support.

A plurality of non-relational databases (NoSQL DB) 74 and 76 storage solutions and related services are also provided for collecting touch data from the restaurant system client applications. This is chosen to be non-SQL since Touches are captured in real-time making this solution faster without impacting the MYSQL data storage & retrieval which is integral to customer-facing services. NoSQL Touch data is also stored and accessed later through Redshift for reporting. Amazon DynamoDB provides a scalable, low-latency NoSQL online Database Service backed by SSDs for use with the data warehousing functions. Amazon DynamoDB provides a scalable, low-latency NoSQL online Database Service backed by SSDs.

Data warehouse 76 is a SQL solution to store and analyze touch data from restaurant system client applications. Amazon Redshift provides petabyte-scale data warehousing with column-based storage and multi-node compute.

AWS Lambda is the preferred and present data warehousing service and runs code in response to AWS internal or external events, such as http requests, and transparently provides the resources required by system 5.

Various analytics are also performed on the data. Amazon Kinesis is a cloud-based service for real-time data processing over large, distributed data streams. It streams data in real time with the ability to process thousands of data streams on a per-second basis. The service, designed for real-time apps, allows developers to pull any amount of data, from any number of sources, scaling up or down as needed.

Virtual Wine Locker (VWL) Client Application—Patron Application

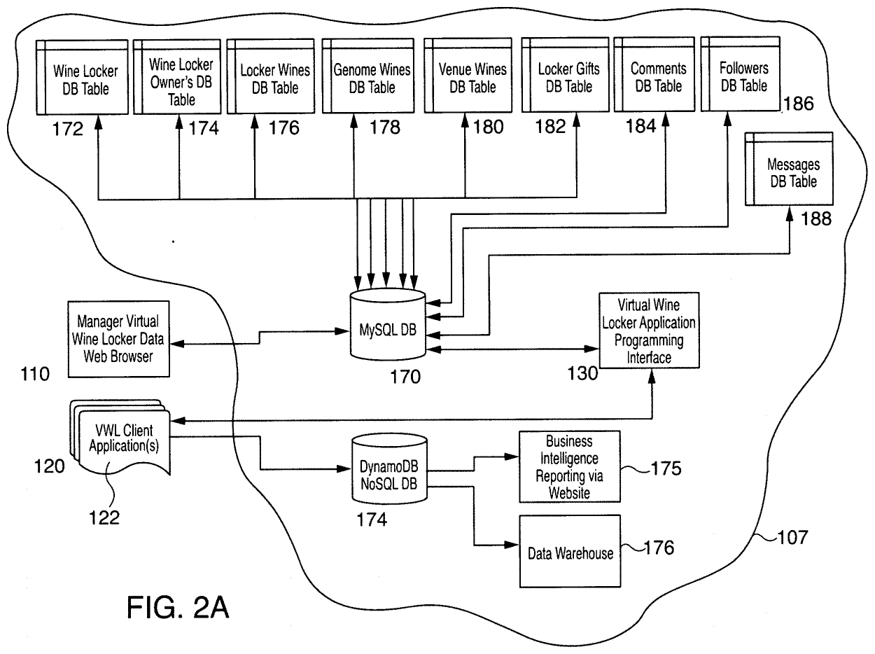

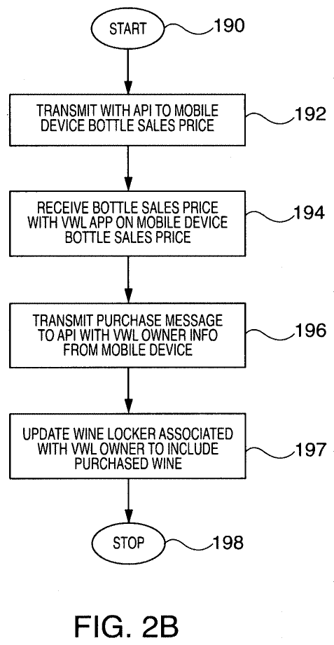

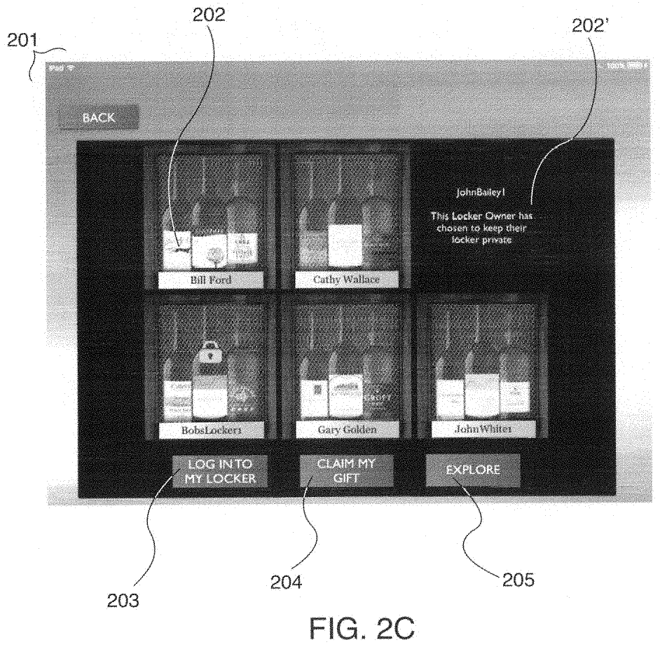

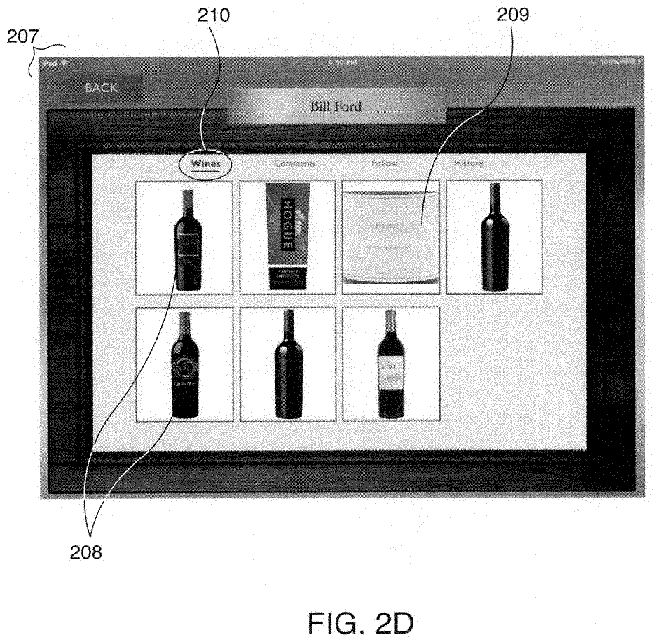

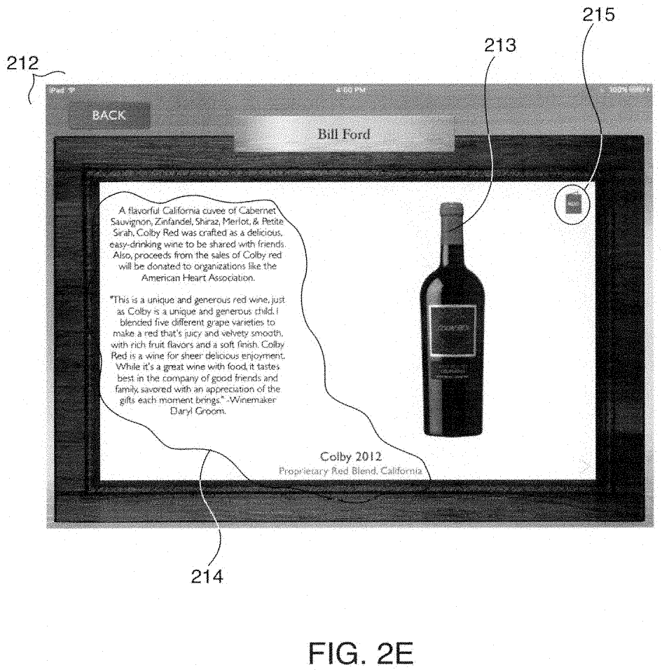

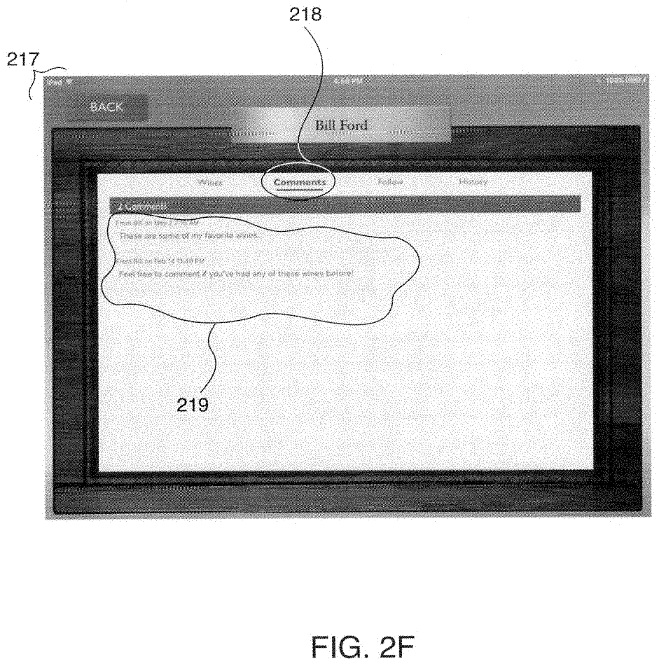

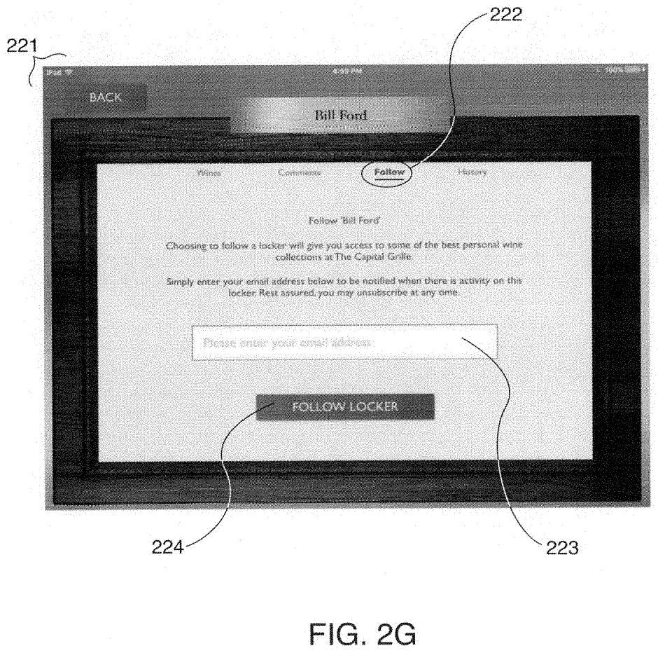

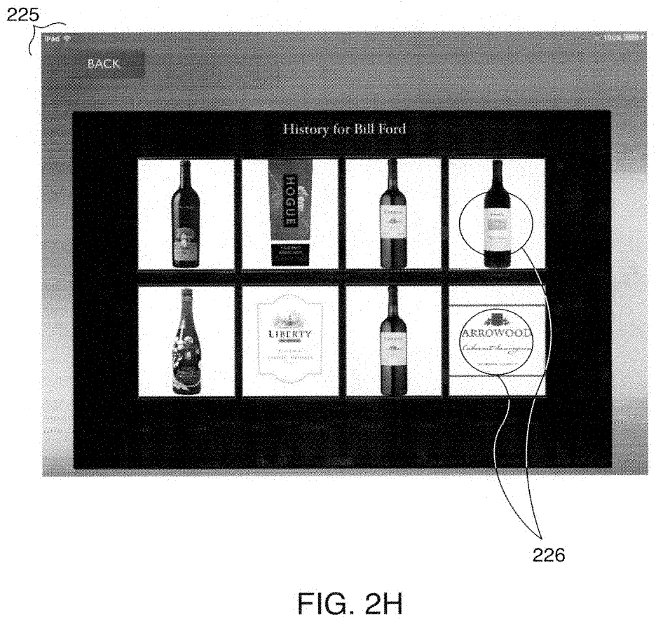

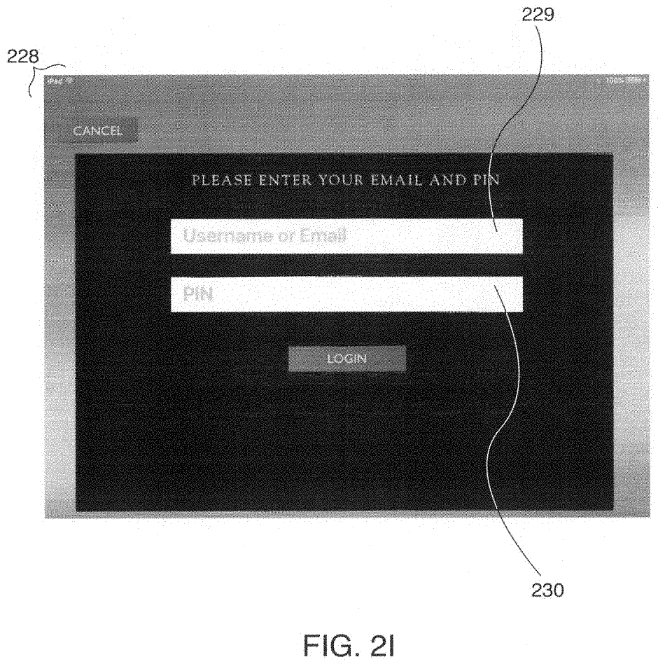

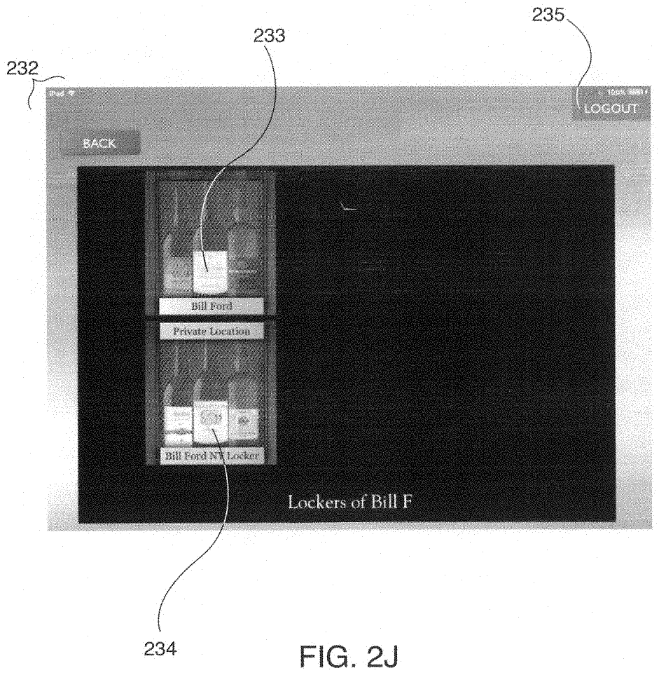

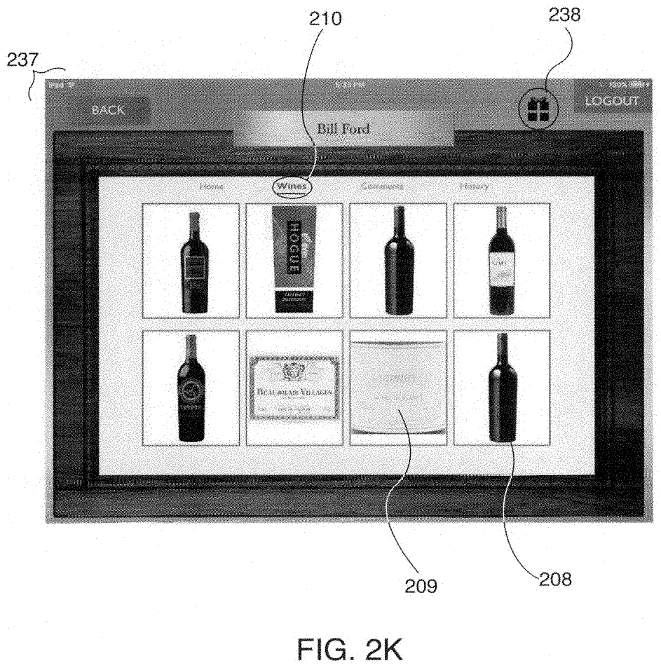

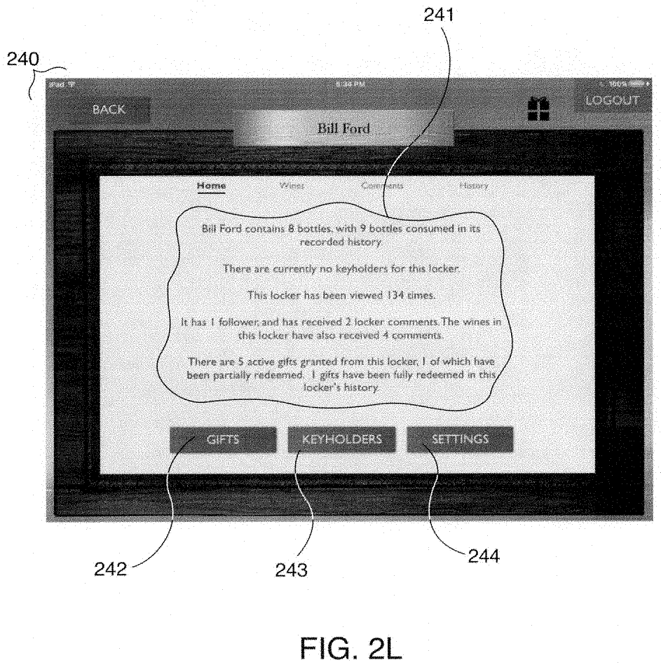

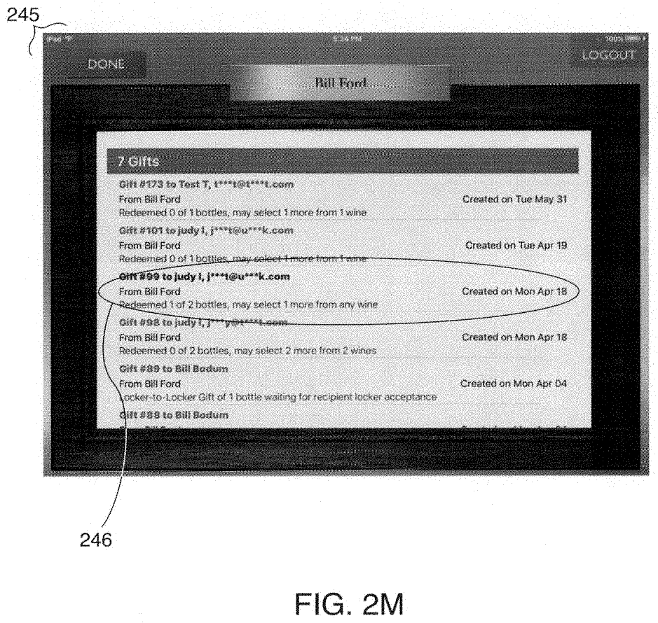

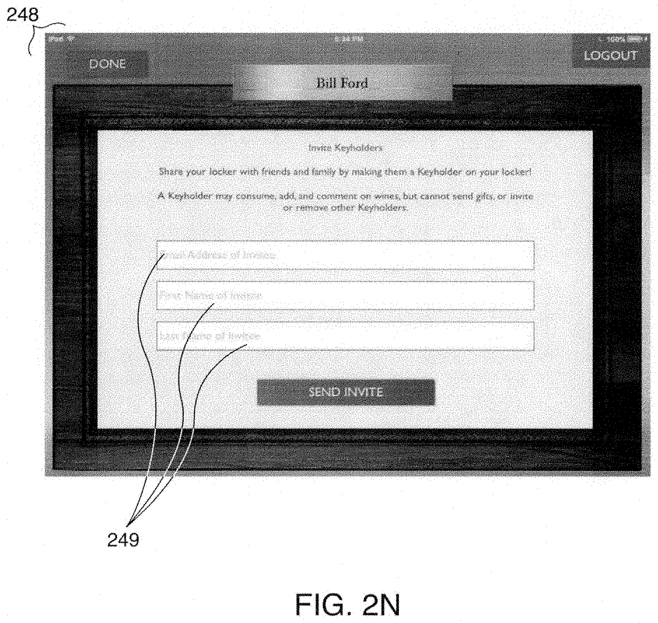

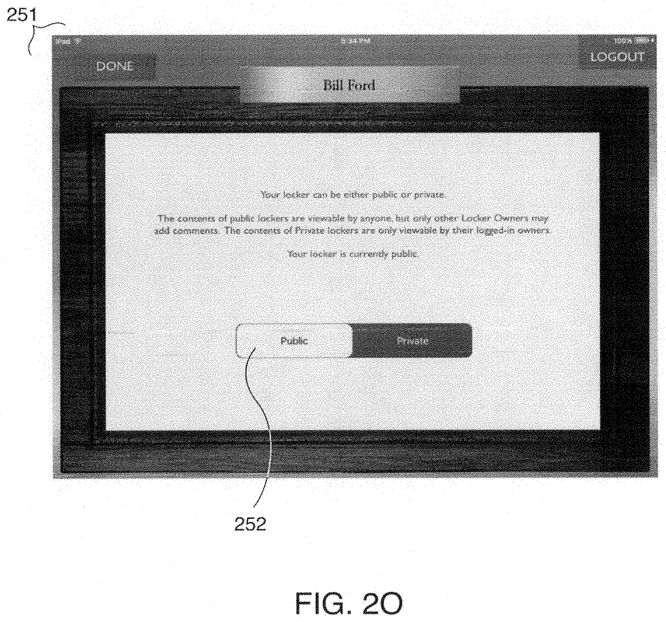

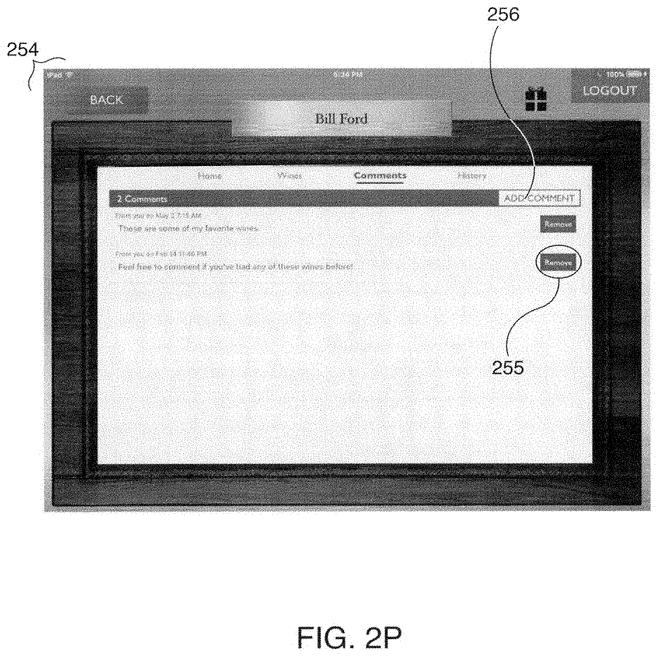

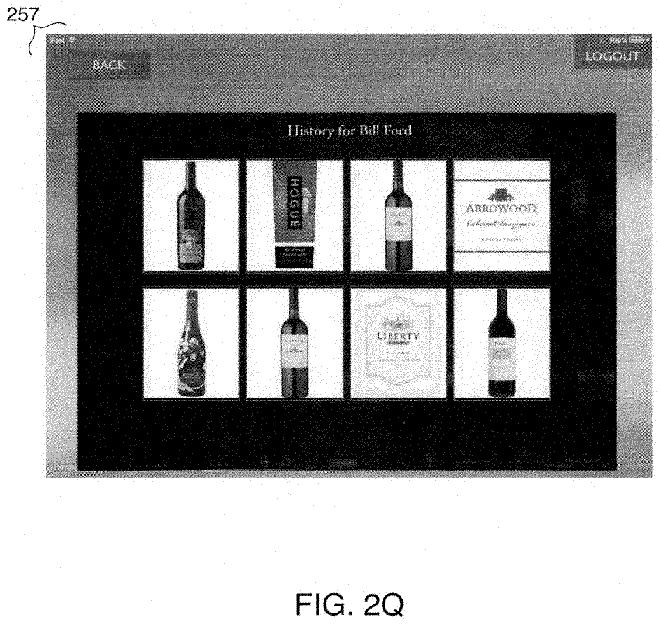

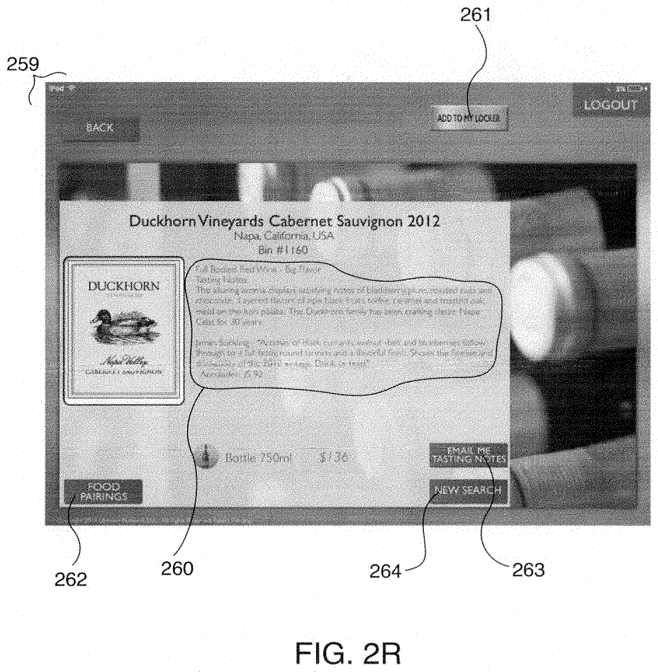

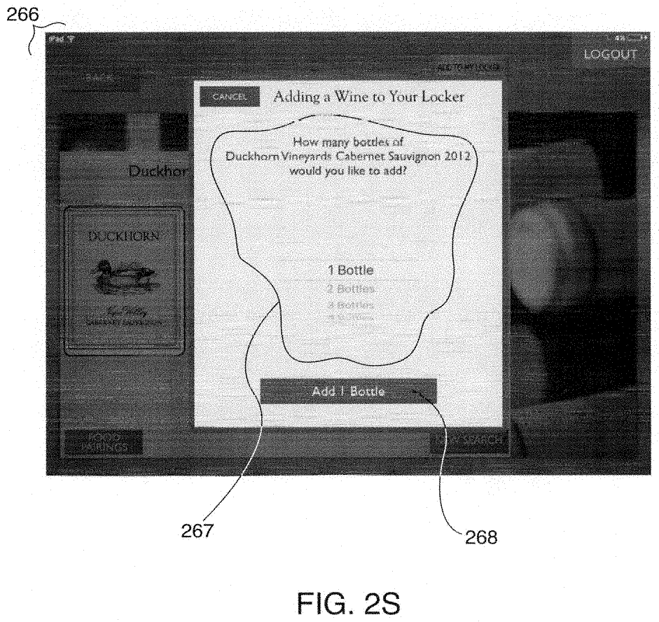

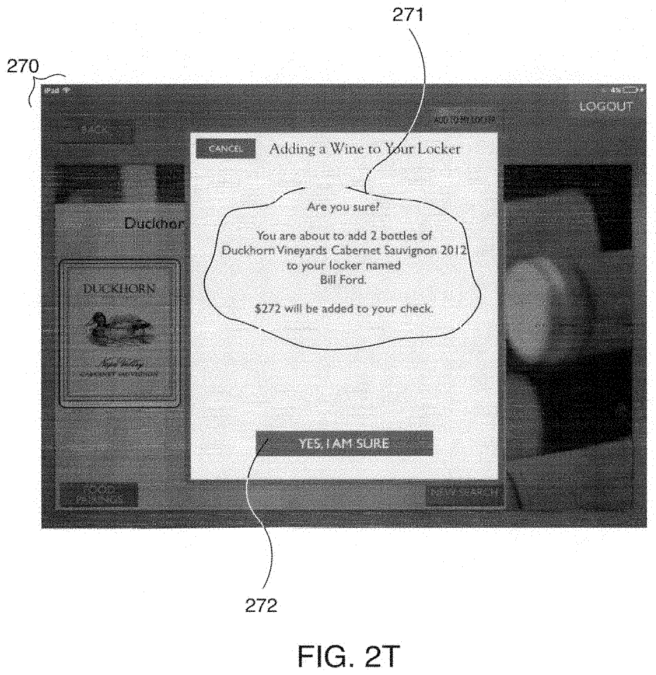

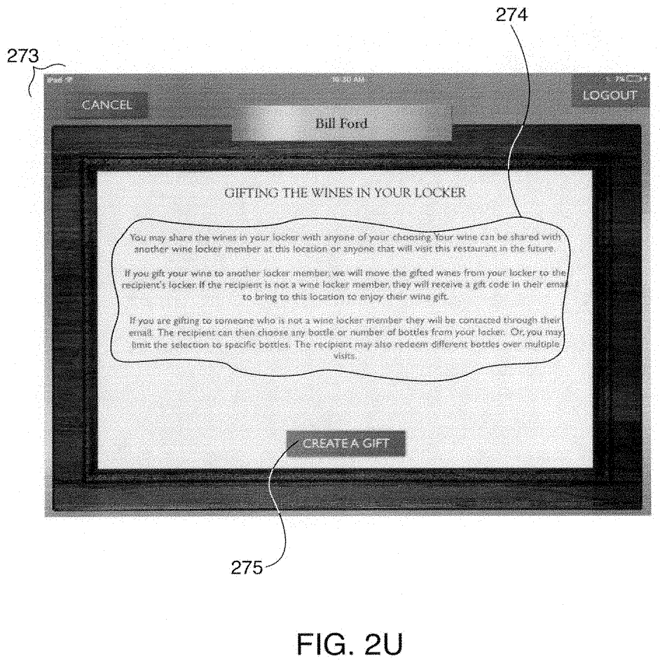

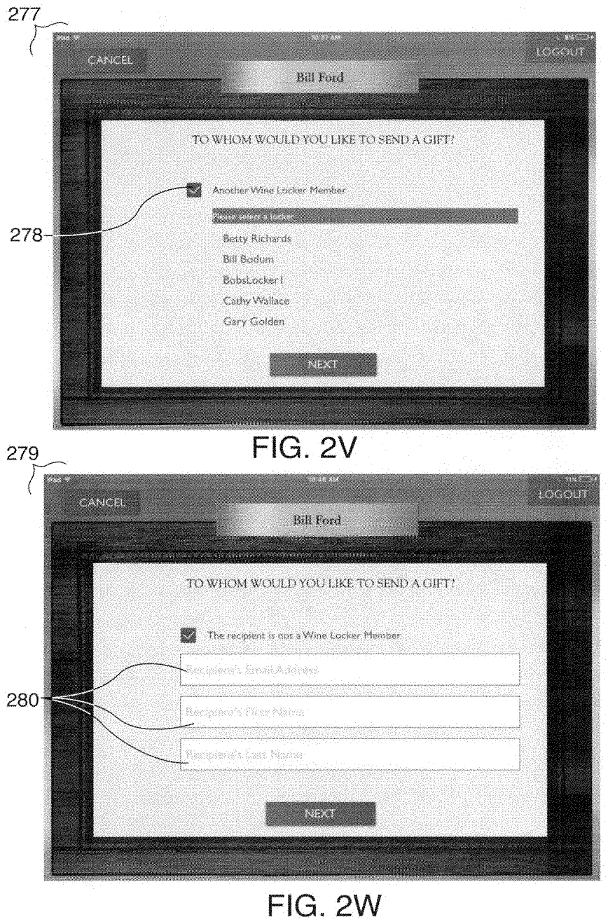

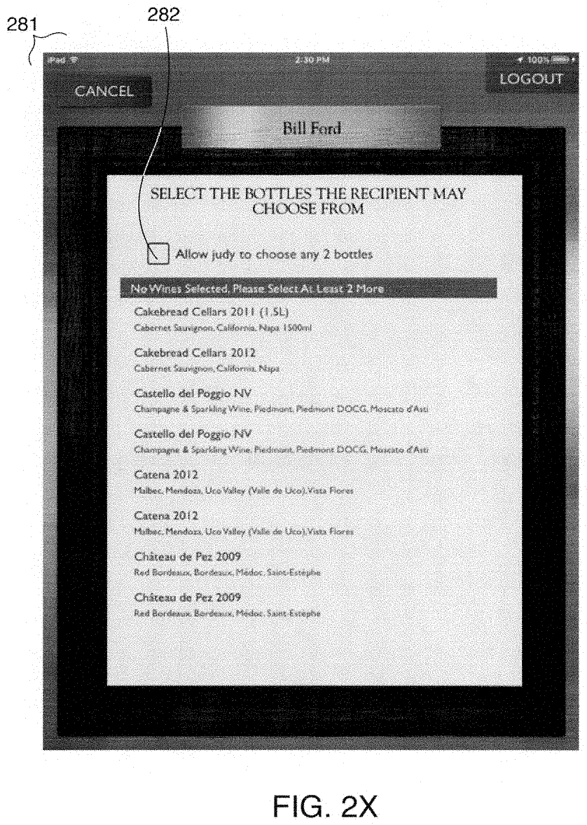

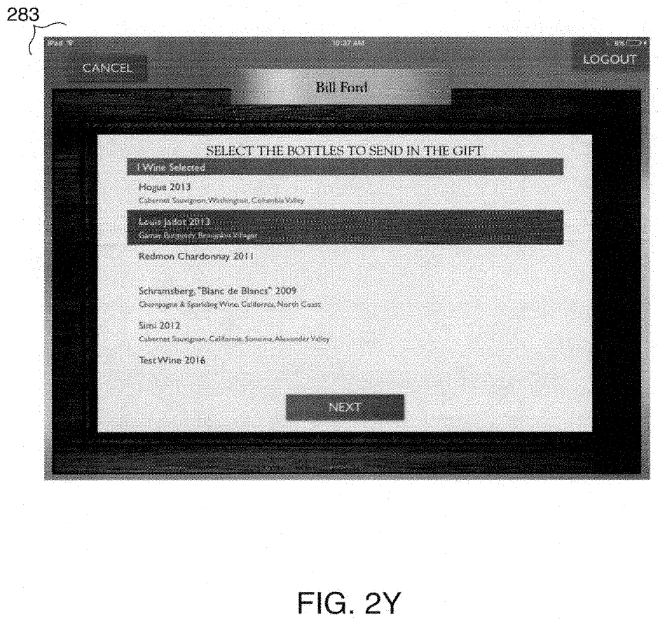

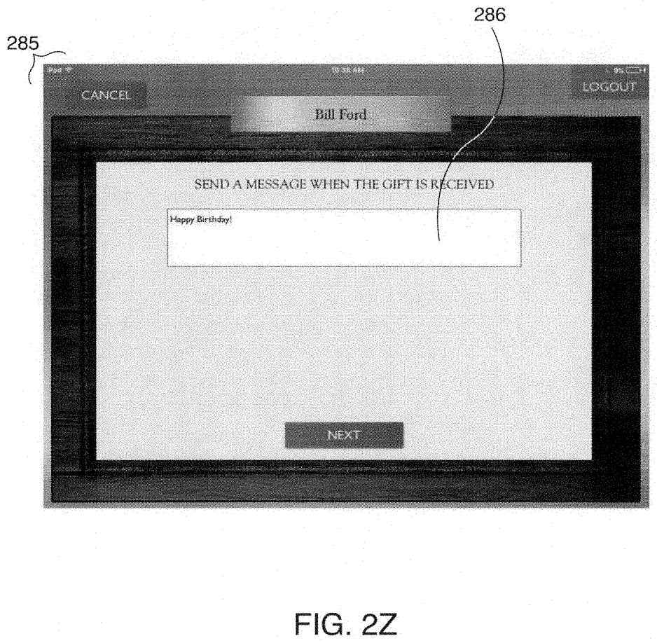

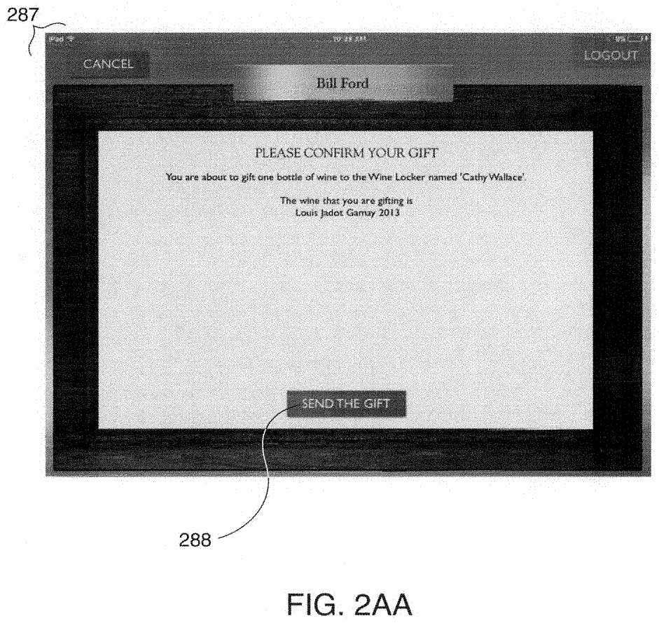

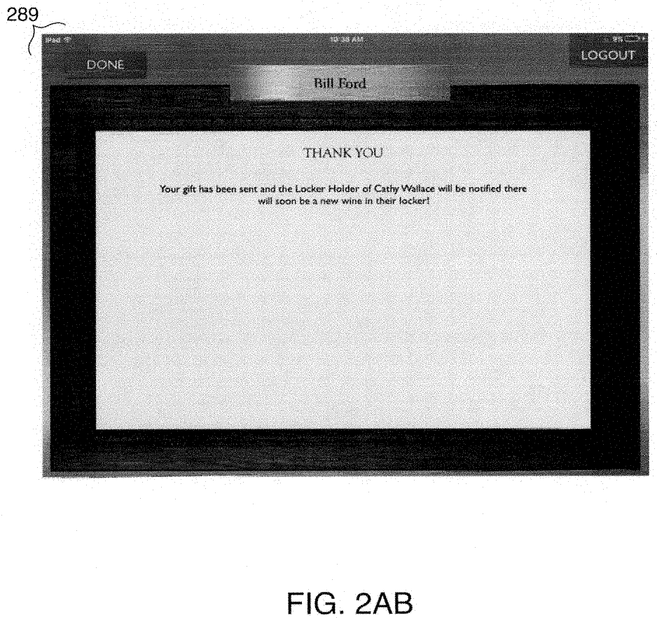

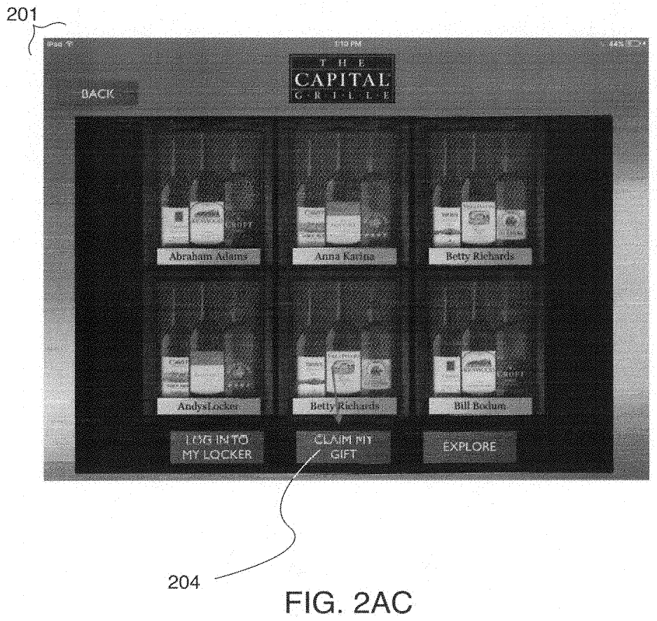

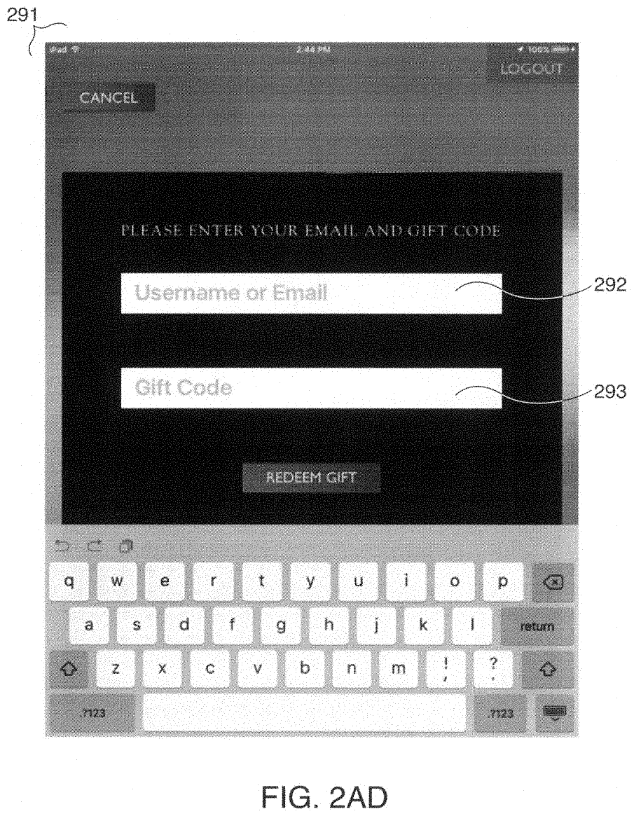

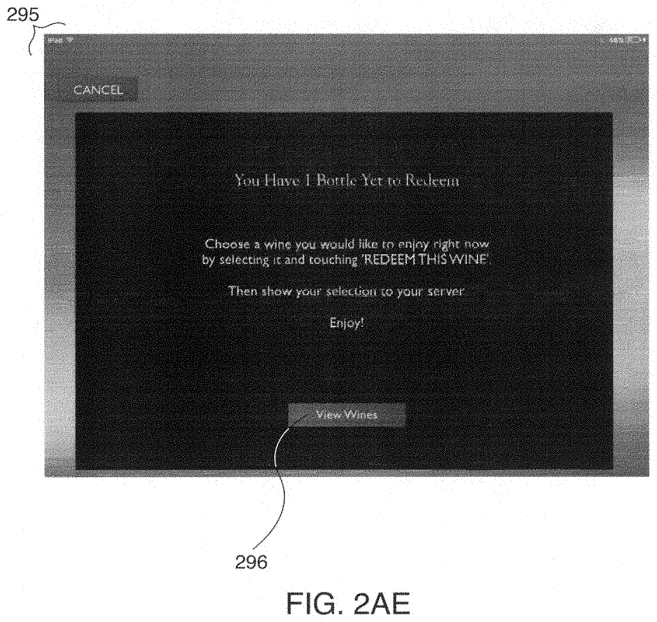

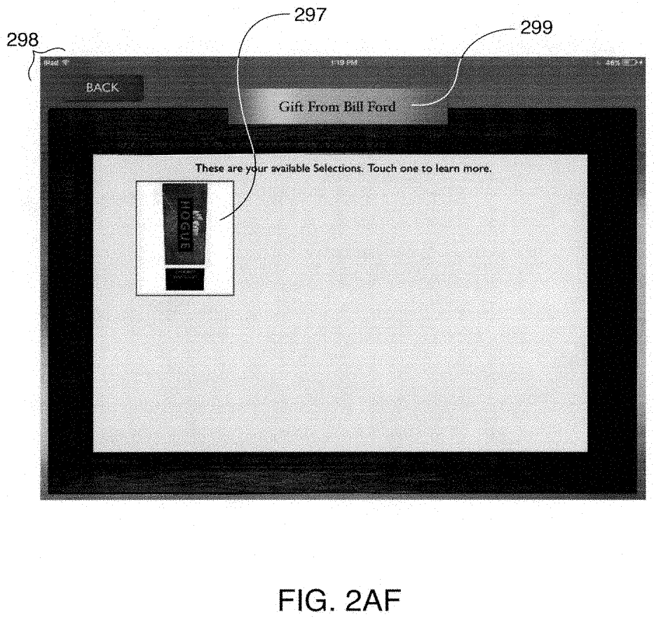

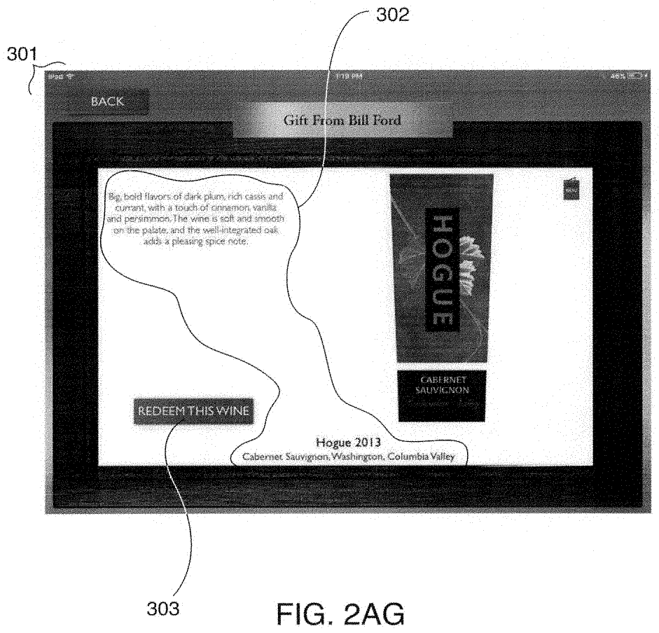

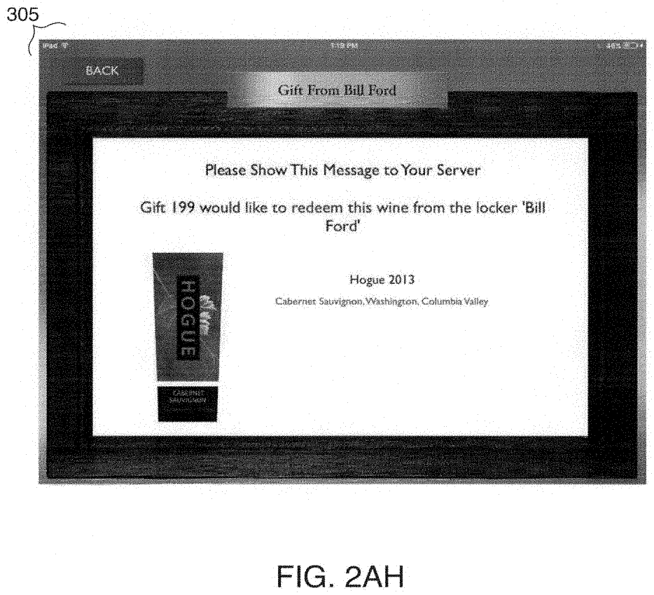

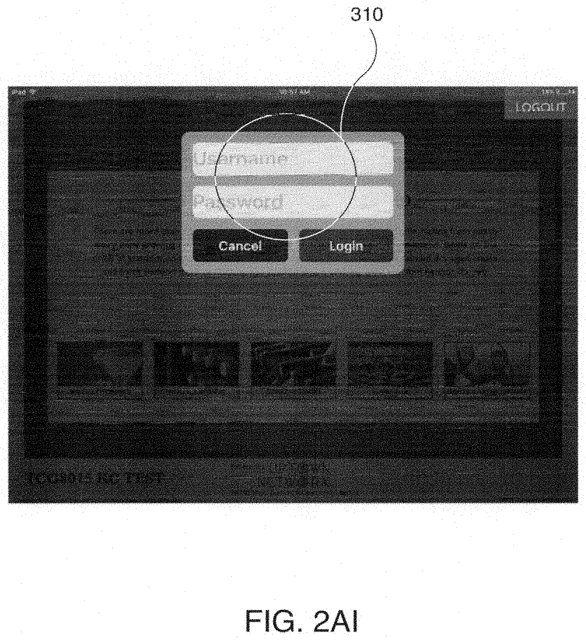

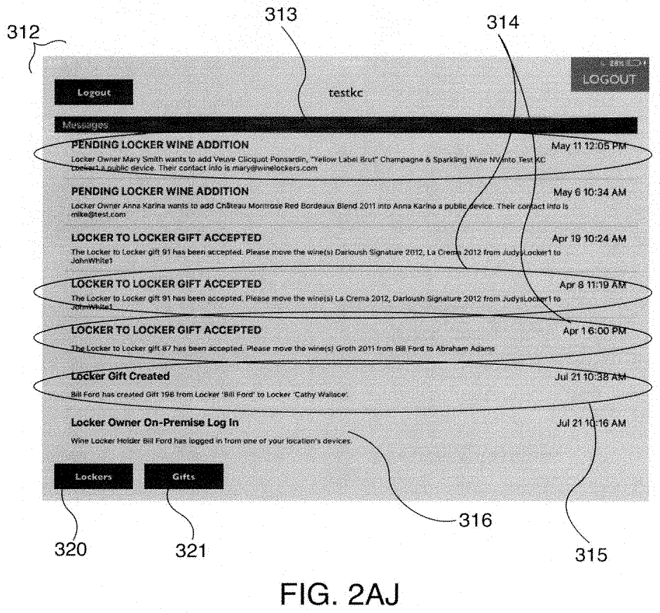

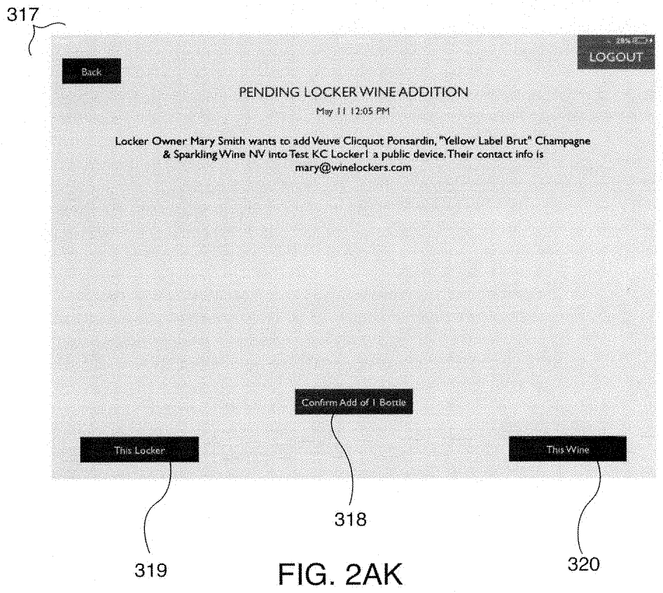

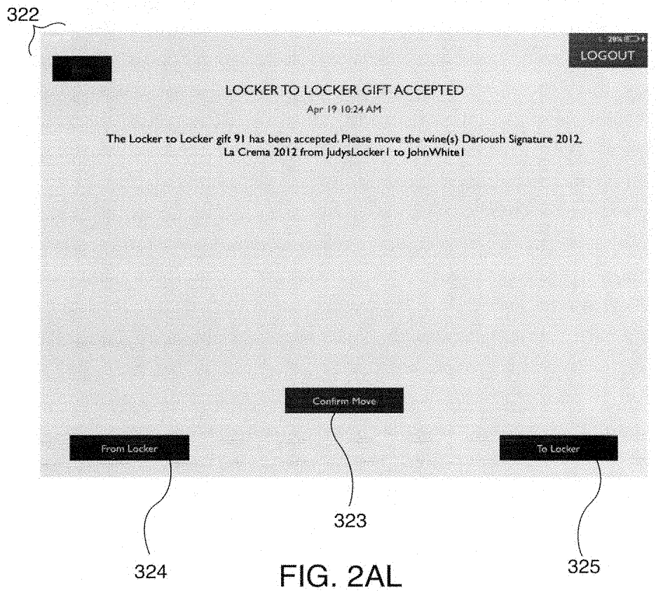

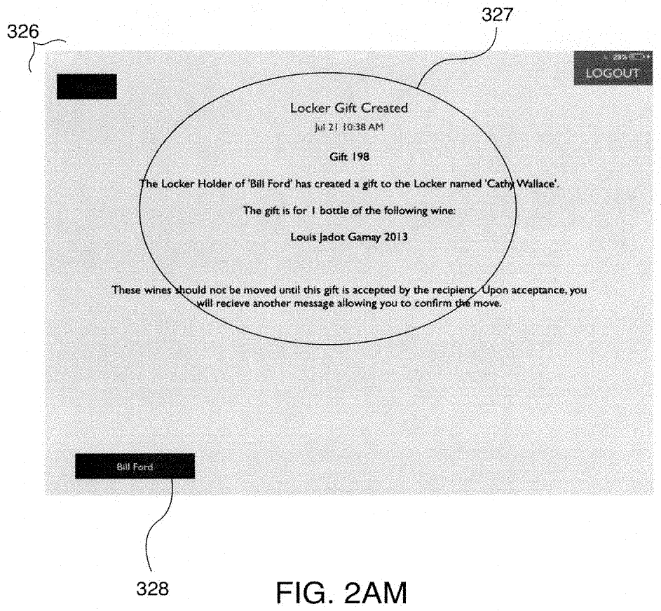

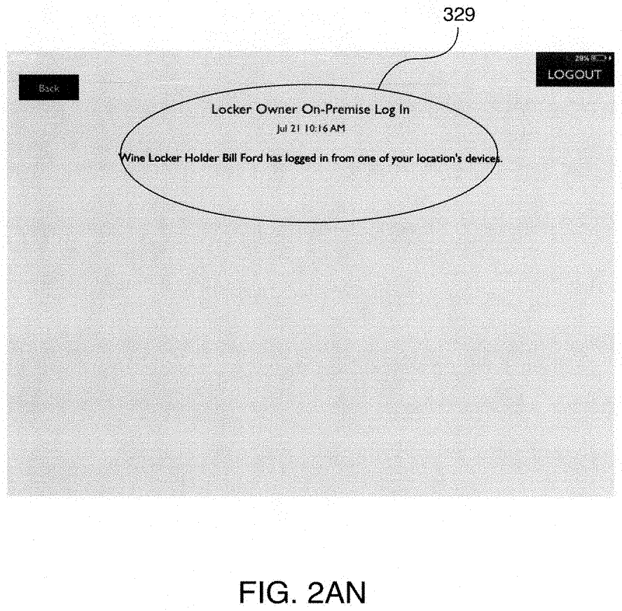

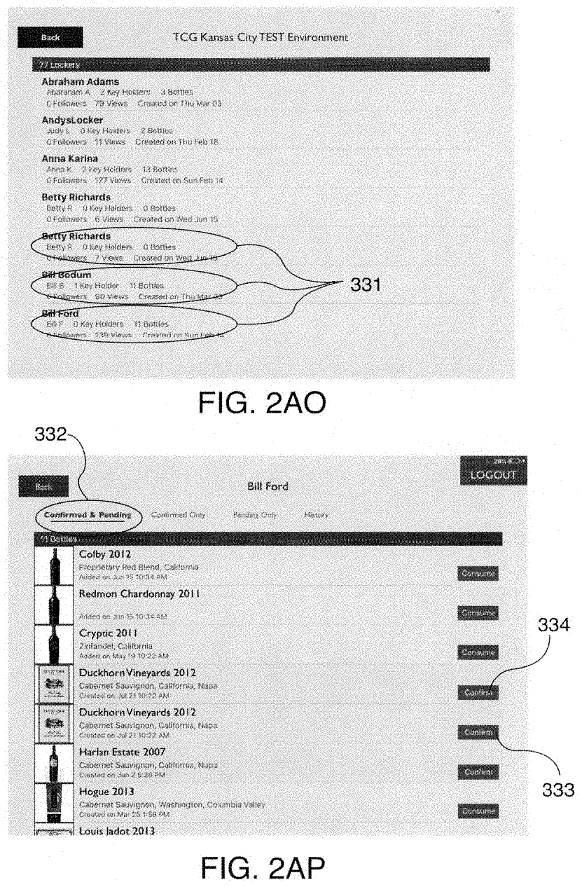

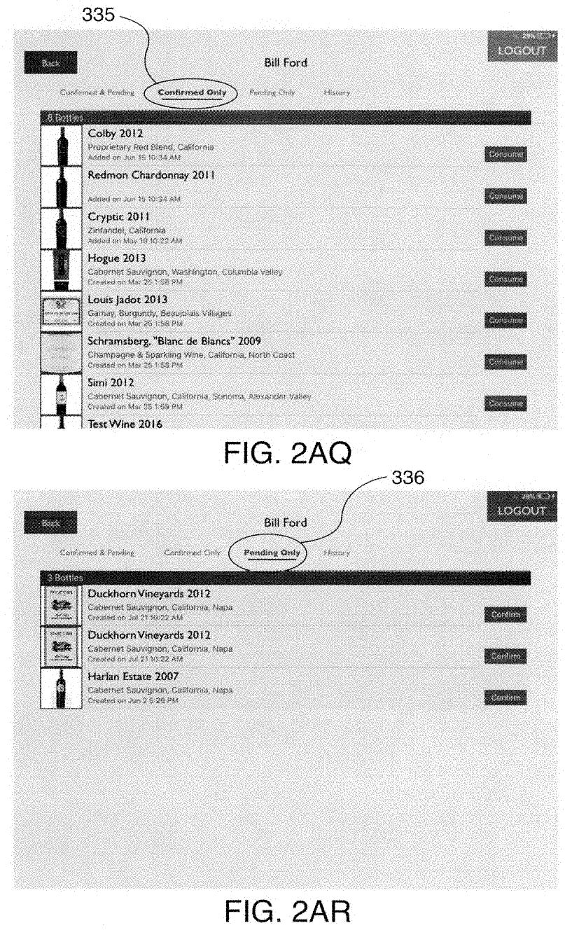

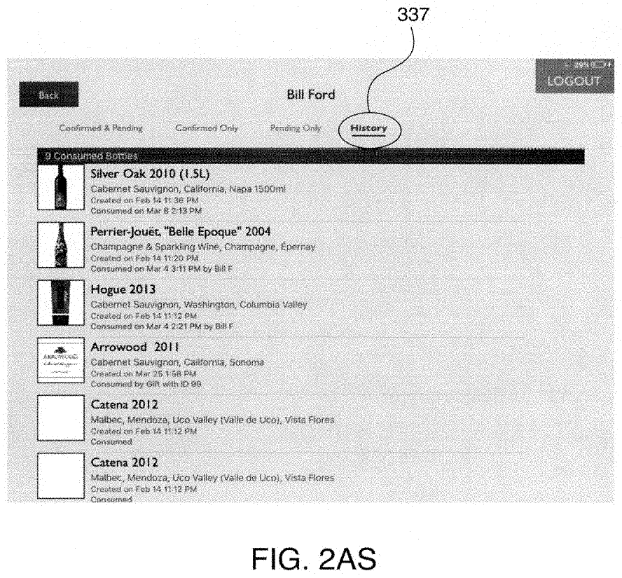

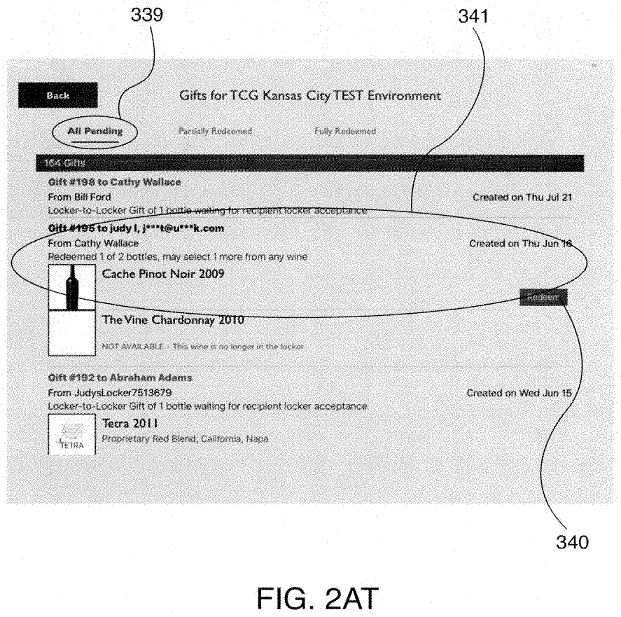

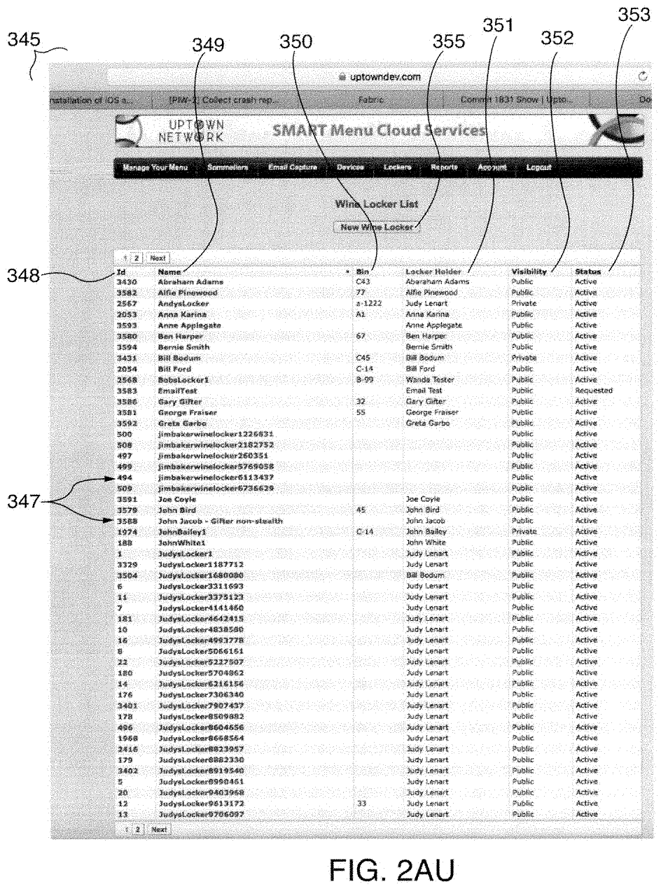

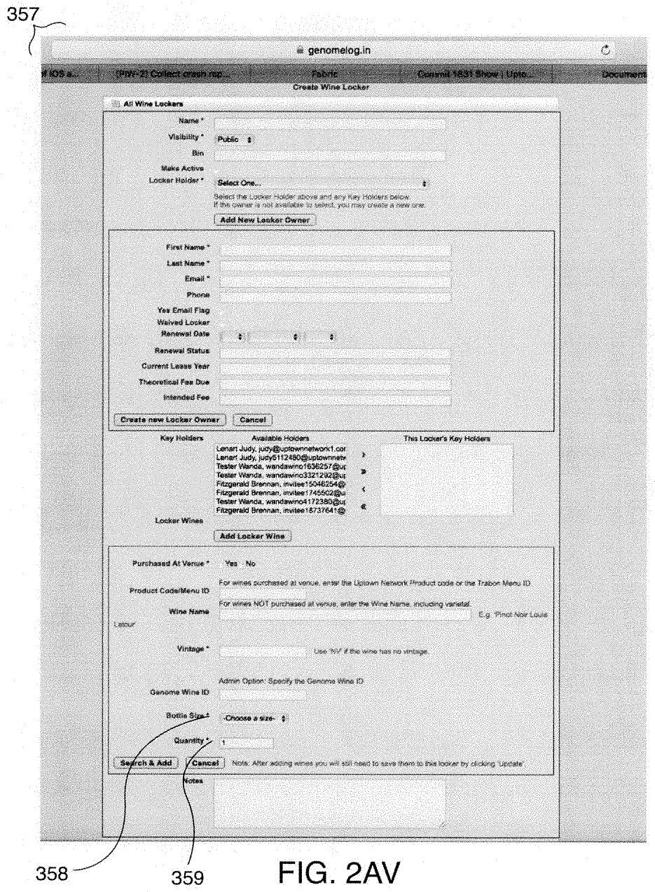

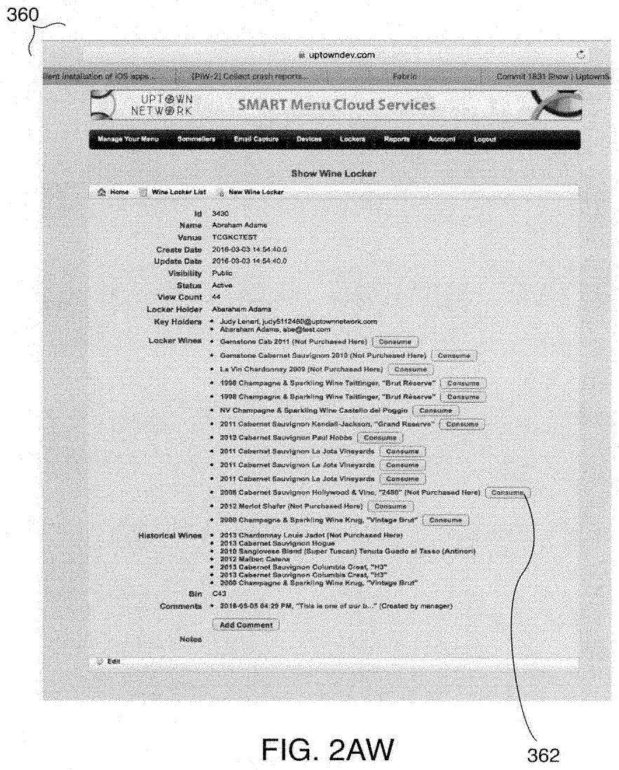

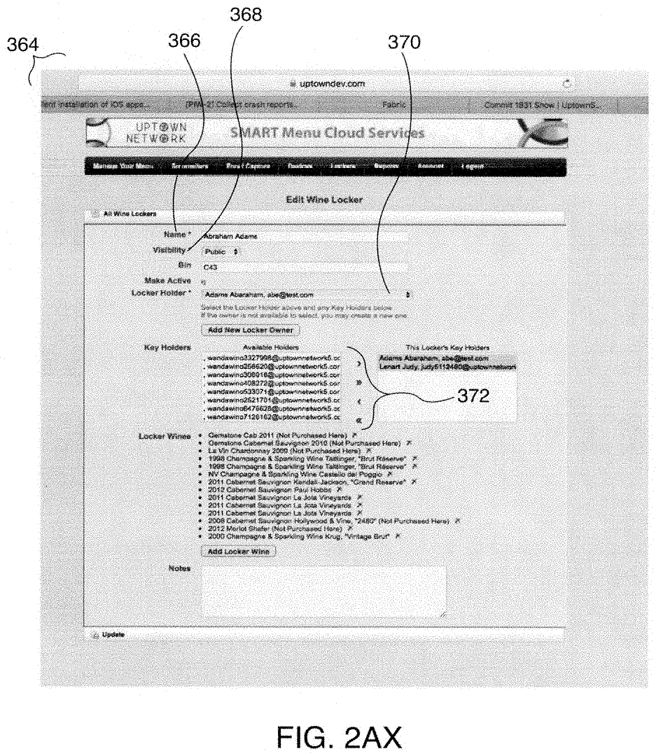

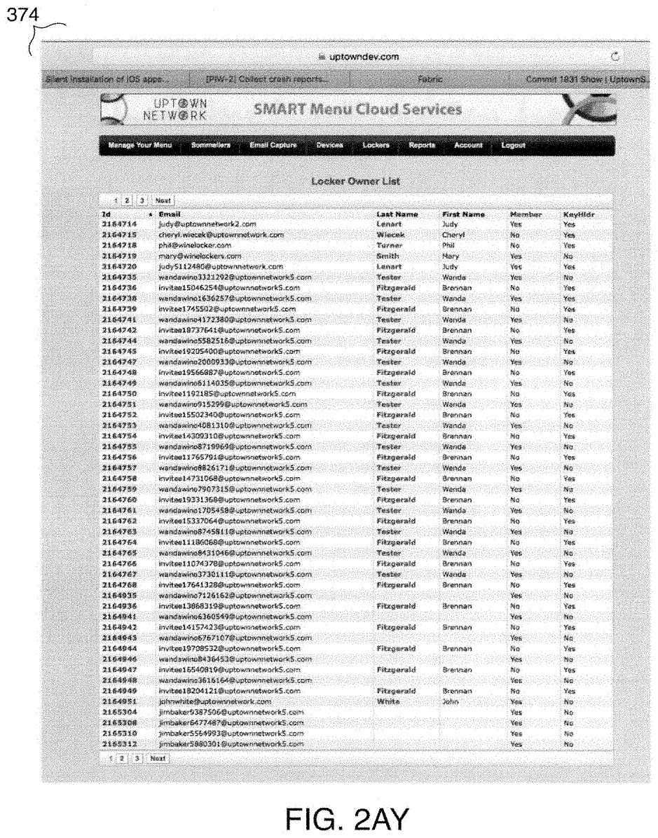

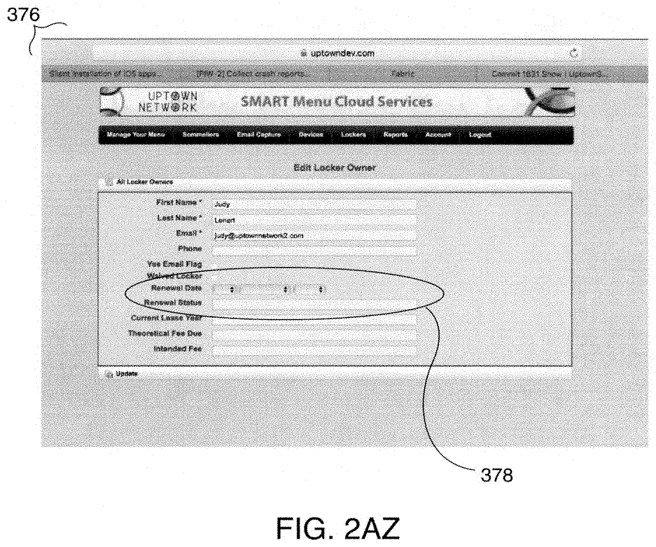

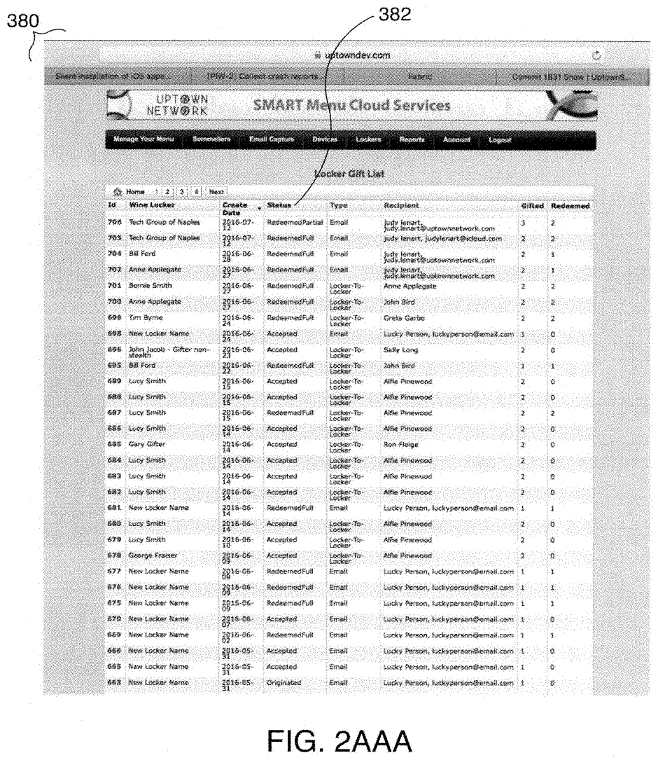

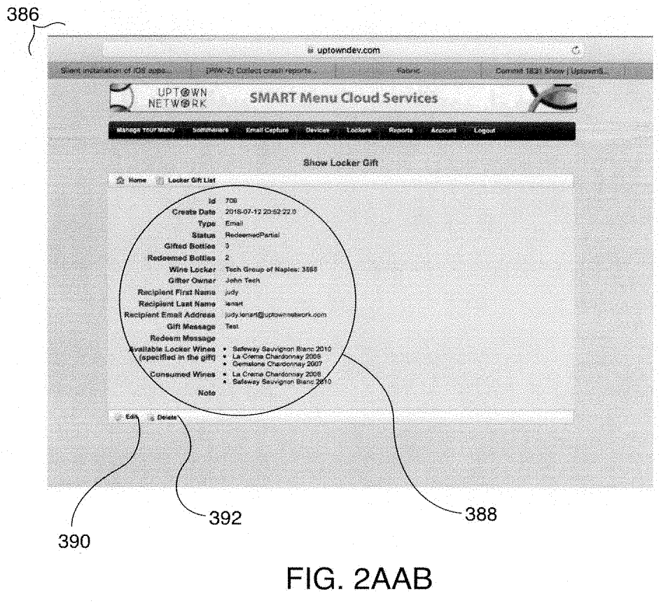

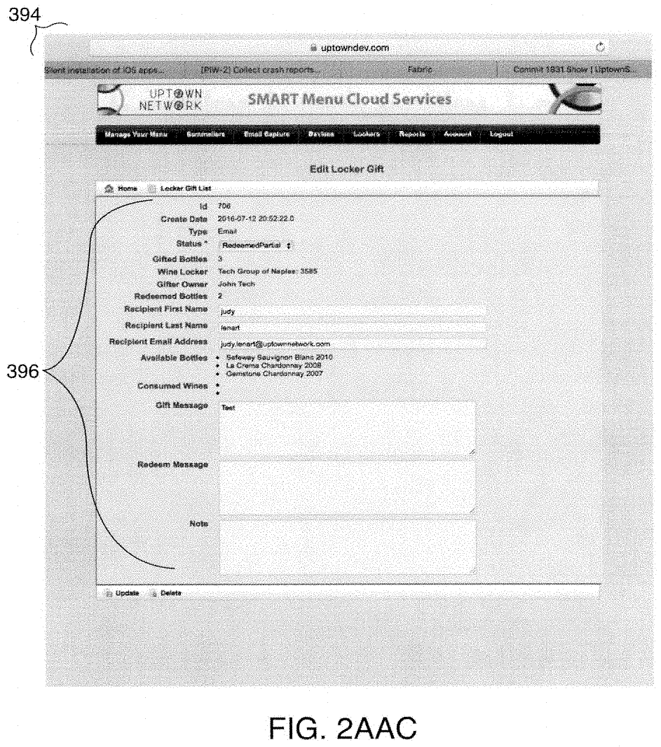

FIGS. 2A and 2B are application level system and process diagrams for the Virtual Wine Locker application. Referring to FIG. 2A, the client application(s) 120 are a series of programmed applications running on a tablet or cell phone and operated by restaurant patrons or restaurant management. In one preferred embodiment, the physical patron devices are larger- sized Apple iPads, approximately 8-13 in. diagonal size—or the size of a typical restaurant menu. Both restaurant patrons and management use the graphical touch screen interface of the devices to access the interactive programming of the applications 120 of the present invention. In one specific embodiment, the VWL client application runs on an iPad as one application with two distinct user functionalities: one for a restaurant customer and one for a restaurant manager. Where necessary, actions that are taken on the customer portion of the application are logged and sent via messages to the manager portion of the application so that appropriate action may be taken by management through the management application as needed.

A VWL Application Programming Interface (API) 130 is written as part of the cloud-based application software and allows for data to be written to and read from the MySQL relational database 170. API services facilitate the recognition of user actions on the client application programs 120 and the transfer of data to and from the VWL databases. These API services applications are both internal and external to cloud 7, i.e. the external applications 120 available at the restaurant and the applications internal to the AWS cloud-based software within application servers 50 of FIG. 1. Amazon Elastic Compute Cloud (EC2) is an IaaS service providing virtual servers controllable by an API, based on the Xen hypervisor.

In one embodiment, relational database 170 is implemented using the AWS relational database service (RDS) which provides scalable database servers with MySQL, Oracle, SQL Server, and PostgreSQL support.

Non-relational database(s) 174 are used in connection with client applications 120 to store non-relational data within cloud 107. In one embodiment, Amazon DynamoDB provides a scalable, low-latency NoSQL online Database Service backed by SSDs.

The administration portion of the VWL application is also accessible through a web browser 110 and as further described below. Finally, business intelligence data is gathered from the client application and stored in a non-dynamic, non-relational data warehouse database 176. Amazon DynamoDB provides a scalable, low-latency, NoSQL online Database Service backed by SSDs.

Business Intelligence data is also accessed using ad-hoc queries performed on an export of the nonSQL data to a data warehouse 176. Amazon Lambda (AWS Lambda) runs code in response to AWS internal or external events such as http requests, transparently providing the resource required. Business intelligence data and reports 175 are created by client applications and accessed for reporting, primarily via the website application.

In sum, the VWL data is created and managed from a central website. This central web site may be associated with and under the control of the offering restaurant itself or a third-party service provider. New VWL's are created with at least one locker owner and unlimited additional key holders. Wines are added to the locker through a search feature that searches a master database of wines, stored in database(s) 170, and “adds” one or more specified bottles and an associated bottle count to the VWL database(s). The search process provides instant detailed data specific to the wine, and that data is displayed on the mobile devices and within the mobile applications at the appropriate times. If a particular wine added to any wine locker is not found, then a new generic wine is created as new database entry. This wine is then manually researched by the restaurant or third-party service provider and the associated data is populated with the database which then becomes available for future reference and display. VWL owner details and gift details can also be managed via the central website.

The overall operation of the VWL will now be described with reference to a series of application screen displays and associated tables within the various plurality of VWL system databases. It should be appreciated that software-based function calls are made from the client applications and/or the web browser software that result in access to VWL API interface 130. These function calls are issued in response to the patron's or manager's operation of the graphical user-interface (GUI) on the client devices. This API then executes against the appropriate database and transfers (i.e. stores or retrieves) the relevant data from various tables. In the VWL, relational database(s) 170 contains a plurality of tables related to the wine data (172-188). In this regard, the titles and schema for the following tables are present in the VWL of the present invention:

TABLE 172
Wine Locker DB table:

| | | | | | |
|---|---|---|---|---|---|
| Field | Type | Null | Key | Default | Extra |

| | | | | |
|---|---|---|---|---|
| id | bigint(20) | NO | PRI | auto_increment |
| version | bigint(20) | NO | | |
| create_date | datetime | NO | | |
| name | varchar(64) | NO | | |
| note | longtext | YES | | |
| status | varchar(255) | NO | | |
| update_date | datetime | NO | | |
| venue_id | bigint(20) | NO | MUL | |
| view_count | int(11) | NO | | |
| visibility | varchar(255) | NO | | |
| primary_owner_id | bigint(20) | YES | MUL | |
| locker_version | int(11) | NO | | |
| bin | varchar(128) | YES | | |
| id | bigint(20) | NO | PRI | auto_increment |
| version | bigint(20) | NO | | |
| create_date | datetime | NO | | |
| name | varchar(64) | NO | | |
| note | longtext | YES | | |
| status | varchar(255) | NO | | |
| update_date | datetime | NO | | |
| venue_id | bigint(20) | NO | MUL | |
| view_count | int(11) | NO | | |
| visibility | varchar(255) | NO | | |
| primary_owner_id | bigint(20) | YES | MUL | |
| locker_version | int(11) | NO | | |
| bin | varchar(128) | YES | | |

TABLE 174
Wine Locker Owner's DB table:

| | | | | | AUTO | | |
|---|---|---|---|---|---|---|---|
| COLUMN | DATA | | NULL- | | INCRE- | COM- | POSI- |
| NAME | TYPE | PK | ABLE | DEFAULT | MENT | PUTED | TION |
| id | BIGINT | YES | NO | | YES | NO | 1 |
| version | BIGINT | NO | NO | | NO | NO | 2 |
| date_ | TIMESTAMP | NO | NO | CURRENT_ | NO | NO | 3 |
| created | | | | TIMESTAMP | | | |
| email | VARCHAR(255) | NO | YES | | NO | NO | 4 |
| | COLLATE | | | | | | |
| | utf8_unicode_ci | | | | | | |
| email_ | VARCHAR(255) | NO | YES | | NO | NO | 5 |
| hash | COLLATE | | | | | | |
| | utf8_unicode_ci | | | | | | |
| full_name | VARCHAR(255) | NO | YES | | NO | NO | 6 |
| | COLLATE | | | | | | |
| | utf8_unicode_ci | | | | | | |
| last_ | TIMESTAMP | NO | NO | CURRENT_ | NO | NO | 7 |
| updated | | | | TIMESTAMP | | | |
| | | | | on update | | | |
| | | | | CURRENT_ | | | |
| | | | | TIMESTAMP | | | |
| nick_ | VARCHAR(255) | NO | YES | | NO | NO | 8 |
| name | COLLATE | | | | | | |
| | utf8_unicode_ci | | | | | | |
| non_ | VARCHAR(255) | NO | YES | | NO | NO | 9 |
| verified_ | COLLATE | | | | | | |
| email | utf8_unicode_ci | | | | | | |
| owner_id | BIGINT | NO | YES | | NO | NO | 10 |
| first_name | VARCHAR(255) | NO | YES | | NO | NO | 11 |
| | COLLATE | | | | | | |
| | utf8_unicode_ci | | | | | | |
| security_ | INT | NO | YES | | NO | NO | 12 |
| level | VARCHAR(32) | NO | YES | | NO | NO | 13 |
| security_ | COLLATE | | | | | | |
| string | utf8_unicode_ci | | | | | | |
| external_ | LONGTEXT | NO | YES | | NO | NO | 14 |
| account_id | COLLATE | | | | | | |
| | utf8_unicode_ci | | | | | | |
| phone | VARCHAR(64) | NO | YES | | NO | NO | 15 |
| | COLLATE | | | | | | |
| | utf8_unicode_ci | | | | | | |
| class | VARCHAR(255) | NO | NO | | NO | NO | 16 |
| | COLLATE | | | | | | |
| | utf8_unicode_ci | | | | | | |
| activity_ | VARCHAR(255) | NO | YES | | NO | NO | 17 |
| report_ | COLLATE | | | | | | |
| frequency | utf8_unicode_ci | | | | | | |
| review_ | VARCHAR(255) | NO | YES | | NO | NO | 18 |
| report_ | COLLATE | | | | | | |
| frequency | utf8_unicode_ci | | | | | | |
| comment_ | VARCHAR(255) | NO | YES | | NO | NO | 19 |
| report_ | COLLATE | | | | | | |
| frequency | utf8_unicode_ci | | | | | | |
| detail_ | VARCHAR(255) | NO | YES | | NO | NO | 20 |
| report_ | COLLATE | | | | | | |
| frequency | utf8_unicode_ci | | | | | | |
| follower_ | VARCHAR(255) | NO | YES | | NO | NO | 21 |
| report_ | COLLATE | | | | | | |
| frequency | utf8_unicode_ci | | | | | | |
| summary_ | VARCHAR(255) | NO | YES | | NO | NO | 22 |
| report_ | COLLATE | | | | | | |
| frequency | utf8_unicode_ci | | | | | | |
| follower_id | BIGINT | NO | YES | | NO | NO | 23 |
| address1 | VARCHAR(255) | NO | YES | | NO | NO | 24 |
| | COLLATE | | | | | | |
| | utf8_unicode_ci | | | | | | |
| address2 | VARCHAR(255) | NO | YES | | NO | NO | 25 |
| | COLLATE | | | | | | |
| | utf8_unicode_ci | | | | | | |
| city | VARCHAR(255) | NO | YES | | NO | NO | 26 |
| | COLLATE | | | | | | |
| | utf8_unicode_ci | | | | | | |
| company | VARCHAR(255) | NO | YES | | NO | NO | 27 |
| | COLLATE | | | | | | |
| | utf8_unicode_ci | | | | | | |
| state | VARCHAR(255) | NO | YES | | NO | NO | 2X |
| | COLLATE | | | | | | |
| | utf8_unicode_ci | | | | | | |
| zip_code | VARCHAR(255) | NO | YES | | NO | NO | 29 |
| | COLLATE | | | | | | |
| | utf8_unicode_ci | | | | | | |
| yes_email_ | BIT | NO | YES | | NO | NO | 30 |
| flag | | | | | | | |
| anniversary | DATETIME | NO | YES | | NO | NO | 31 |
| birthday | DATETIME | NO | YES | | NO | NO | 32 |
| notes | LONGTEXT | NO | YES | | NO | NO | 33 |
| | COLLATE | | | | | | |
| | utf8_unicode_ci | | | | | | |
| current_ | VARCHAR(128) | NO | YES | | NO | NO | 34 |
| lease_year | COLLATE | | | | | | |
| | utf8_unicode_ci | | | | | | |
| intended_ | VARC’HAR(128) | NO | YES | | NO | NO | 35 |
| fee | COLLATE | | | | | | |
| | utf8_unicode_ci | | | | | | |
| renewal_ | DATETIME | NO | YES | | NO | NO | 36 |
| date | | | | | | | |
| renewal_ | VARCHAR(128) | NO | YES | | NO | NO | 37 |
| status | COLLATE | | | | | | |
| | utf8_unicode_ci | | | | | | |
| theoretical_ | VARCHAR(128) | NO | YES | | NO | NO | 38 |
| fee_due | COLLATE | | | | | | |
| | utf8_unicode_ci | | | | | | |
| waived_ | BIT | NO | YES | | NO | NO | 39 |
| locker | VARCHAR(255) | NO | YES | | NO | NO | 40 |
| email_enc | COLLATE | | | | | | |
| | utf8_unicode_ci | | | | | | |
| first_ | VARCHAR(255) | NO | YES | | NO | NO | 41 |
| name_ | COLLATE | | | | | | |
| enc | utf8_unicode_ci | | | | | | |
| last_ | VARCHAR(255) | NO | YES | | NO | NO | 42 |
| name_ | COLLATE | | | | | | |
| enc | utf8_unicode_ci | | | | | | |
| phone_enc | VARCHAR(255) | NO | YES | | NO | NO | 43 |
| | COLLATE | | | | | | |
| | utf8_unicode_ci | | | | | | |

TABLE 176
Locker Wines DB table:

| | | | | | AUTO | | |
|---|---|---|---|---|---|---|---|
| COLUMN | DATA | | NULL- | | INCRE- | COM- | POS- |
| NAME | TYPE | PK | ABLE | DEFAULT | MENT | PUTED | TION |
| id | BIGINT | YES | NO | | YES | NO | 1 |
| version | BIGINT | NO | NO | | NO | NO | 2 |
| add_status | VARCHAR(255) | NO | NO | | NO | NO | 3 |
| | CHARSET latin1 | | | | | | |
| | COLLATE latin1_ | | | | | | |
| | swedish_ci | | | | | | |
| consume_status | VARCHAR(255) | NO | NO | | NO | NO | 4 |
| | CHARSET latin1 | | | | | | |
| | COLLATE latin1_ | | | | | | |
| | swedish_ci | | | | | | |
| consuming_ | BIGINT | NO | YES | | NO | NO | 5 |
| gift_id | | | | | | | |
| consuming_ | BIGINT | NO | YES | | NO | NO | 6 |
| owner_id | | | | | | | |
| create_date | DATETIME | NO | NO | | NO | NO | 7 |
| locker_id | BIGINT | NO | YES | | NO | NO | 8 |
| nickname | VARCHAR(255) | NO | YES | | NO | NO | 9 |
| | CHARSET latin1 | | | | | | |
| | COLLATE latin1_ | | | | | | |
| | swedish_ci | | | | | | |
| note | LONGTEXT | NO | YES | | NO | NO | 10 |
| | CHARSET latin1 | | | | | | |
| | COLLATE latin1_ | | | | | | |
| | swedish_ci | | | | | | |
| originating_gift_id | BIGINT | NO | YES | | NO | NO | 11 |
| originating_ | BIGINT | NO | YES | | NO | NO | 12 |
| owner_id | | | | | | | |
| update_date | DATETIME | NO | NO | | NO | NO | 13 |
| venue_wine_id | BIGINT | NO | YES | | NO | NO | 14 |
| visibility | VARCHAR(255) | NO | NO | | NO | NO | 15 |
| | CHARSET latin1 | | | | | | |
| | COLLATE latin1_ | | | | | | |
| | swedish_ci | | | | | | |
| deleted_from_ | BIGINT | NO | YES | | NO | NO | 16 |
| locker_id | | | | | | | |
| genome_wine_id | BIGINT | NO | YES | | NO | NO | 17 |
| locker_wine_ | INT | NO | NO | | NO | NO | 18 |
| version | | | | | | | |
| purchased_ | BIT | NO | YES | | NO | NO | 19 |
| at_venue | | | | | | | |
| add_date | DATETIME | NO | YES | | NO | NO | 20 |
| bottle_size | INT | NO | YES | | NO | NO | 21 |
| consume_date | DATETIME | NO | YES | | NO | NO | 22 |
| moved_to_ | BIGINT | NO | YES | | NO | NO | 23 |
| locker_wine_id | | | | | | | |
| purchaseplu | VARCHAR(255) | NO | YES | | NO | NO | 24 |
| | CHARSET latin1 | | | | | | |
| | COLLATE latin1_ | | | | | | |
| | swedish_ci | | | | | | |

TABLE 178
Genome Wines DB table:

| | | | | | AUTO | | |
|---|---|---|---|---|---|---|---|
| COLUMN | DATA | | NULL- | | INCRE- | COM- | POSI- |
| NAME | TYPE | PK | ABLE | DEFAULT | MENT | PUTED | TION |
| id | BIGINT | YES | NO | | YES | NO | 1 |
| version | BIGINT | NO | NO | | NO | NO | 2 |
| upc | VARCHAR(128) | NO | YES | | NO | NO | 3 |
| | COLLATE utf8_ | | | | | | |
| | unicode_ci | | | | | | |
| accolades | VARCHAR128) | NO | YES | | NO | NO | 4 |
| | COLLATE utf8_ | | | | | | |
| | unicode_ci | | | | | | |
| alcohol_ | DOUBLE | NO | YES | | NO | NO | 5 |
| content | | | | | | | |
| flavour_id | BIGINT | NO | YES | | NO | NO | 6 |
| is_confirmed | BIT | NO | NO | | NO | NO | 7 |
| modified_ | TIMESTAMP | NO | NO | CURRENT_ | NO | NO | 8 |
| date | | | | TIMESTAMP | | | |
| | | | | on update | | | |
| | | | | CURRENT_ | | | |
| | | | | TIMESTAMP | | | |
| name | MEDIUMTEXT | NO | YES | | NO | NO | 9 |
| origin_id | BIGINT | NO | YES | | NO | NO | 10 |
| original_ | BIGINT | NO | YES | | NO | NO | 11 |
| venue_id | | | | | | | |
| tasting_ | MEDIUMTEXT | NO | YES | | NO | NO | 12 |
| notes | COLLATE utf8_ | | | | | | |
| | unicode_ci | | | | | | |
| varietal_id | BIGINT | NO | YES | | NO | NO | 13 |
| vintage | VARCHAR(128) | NO | YES | | NO | NO | 14 |
| | COLLATE utf8_ | | | | | | |
| | unicode_ci | | | | | | |
| image | VARCHAR(128) | NO | YES | | NO | NO | 15 |
| | COLLATE utf8_ | | | | | | |
| | unicode_ci | | | | | | |
| instance_ | VARCHAR(255) | NO | YES | | NO | NO | 16 |
| state | COLLATE utf8_ | | | | | | |
| | unicode_ci | | | | | | |
| popularity_ | INT | NO | YES | | NO | NO | 17 |
| score | | | | | | | |
| more_ | VARCHAR(255) | NO | YES | | NO | NO | 18 |
| infourl | COLLATE utf8_ | | | | | | |
| | unicode_ci | | | | | | |
| purchaseurl | VARCHAR(255) | NO | YES | | NO | NO | 19 |
| | COLLATE utf8_ | | | | | | |
| | unicode_ci | | | | | | |
| description | VARCHAR(256) | NO | YES | | NO | NO | 20 |
| | COLLATE | | | | | | |
| | utf8_unicode_ci | | | | | | |
| bottle_size | INT | NO | YES | | NO | NO | 21 |
| create_date | TIMESTAMP | NO | YES | CURRENT_ | NO | NO | 22 |
| | | | | TIMESTAMP | | | |

TABLE 180
Venue Wine DB table:

| COLUMN | DATA | | | | | | |
|---|---|---|---|---|---|---|---|
| NAME | TYPE | PK | NULLABLE | DEFAULT | AUTOINCREMENT | COMPUTED | POSITION |
| id | BIGINT | YES | NO | | YES | NO | 1 |
| version | BIGINT | NO | NO | | NO | NO | 2 |
| bin_number | INT | NO | NO | | NO | NO | 3 |
| bottle_price | DOUBLE | NO | NO | | NO | NO | 4 |
| bottle_ sale_ | DOUBLE | NO | YES | | NO | NO | 5 |
| price | | | | | | | |
| btl_size | INT | NO | NO | | NO | NO | 6 |
| db_updates_ | BIGINT | NO | NO | | NO | NO | 7 |
| history_id | | | | | | | |
| genome_wine_id | BIGINT | NO | NO | | NO | NO | 8 |
| glass_price | DOUBLE | NO | YES | | NO | NO | 9 |
| glass_sale_ | DOUBLE | NO | YES | | NO | NO | 10 |
| price | | | | | | | |
| image | VARCHAR(255) | NO | YES | | NO | NO | 11 |
| | COLLATE | | | | | | |
| | utf8_unicode_ci | | | | | | |
| instance_state | VARCHAR(255) | NO | YES | | NO | NO | 12 |
| | COLLATE | | | | | | |
| | utf8_unicode_ci | | | | | | |
| out_of_stock | BIT | NO | NO | | NO | NO | 13 |
| venue_id | BIGINT | NO | NO | | NO | NO | 14 |
| popularity_ | INT | NO | YES | | NO | NO | 15 |
| score | | | | | | | |
| second_line_override | VARCHAR(255) | NO | YES | | NO | NO | 16 |
| | COLLATE | | | | | | |
| | utf8_unicode_ci | | | | | | |
| flavor_override | VARCHAR(255) | NO | YES | | NO | NO | 17 |
| | COLLATE | | | | | | |
| | utf8_unicode_ci | | | | | | |
| varietal_override | VARCHAR(255) | NO | YES | | NO | NO | 18 |
| | COLLATE | | | | | | |
| | utf8_unicode_ci | | | | | | |
| bottle_cost | DOUBLE | NO | YES | | NO | NO | 19 |
| use_bottle_ | BIT | NO | NO | | NO | NO | 20 |
| price_formula | | | | | | | |
| external_id_string | VARCHAR(255) | NO | YES | | NO | NO | 21 |
| | COLLATE | | | | | | |
| | utf8_unicode_ci | | | | | | |
| external_glass_id_string | VARCHAR(255) | NO | YES | | NO | NO | 22 |
| | COLLATE | | | | | | |
| | utf8_unicode_ci | | | | | | |
| external_quartino_id_string | VARCHAR(255) | NO | YES | | NO | NO | 23 |
| | COLLATE | | | | | | |
| | utf8_unicode_ci | | | | | | |
| quartino_price | DOUBLE | NO | YES | | NO | NO | 24 |
| modified_date | TIMESTAMP | NO | NO | CURRENT_ | NO | NO | 25 |
| | | | | TIMESTAMP | | | |
| | | | | on update | | | |
| | | | | CURRENT_ | | | |
| | | | | TIMESTAMP | | | |
| wine_agent | VARCHAR(255) | NO | YES | | NO | NO | 26 |
| code | COLLATE | | | | | | |
| | utf8_unicode_ci | | | | | | |
| wine_agent_price_string | VARCHAR(255) | NO | YES | | NO | NO | 27 |
| | COLLATE | | | | | | |
| | utf8_unicode_ci | | | | | | |
| wine_agent | VARCHAR(255) | NO | YES | | NO | NO | 28 |
| url | COLLATE | | | | | | |
| | utf8_unicode_ci | | | | | | |
| wine_agent_ | INT | NO | YES | | NO | NO | 29 |
| on_hand | | | | | | | |
| id_string | VARCHAR(128) | NO | YES | | NO | NO | 30 |
| | COLLATE | | | | | | |
| | utf8_unicode_ci | | | | | | |
| accolades_ | VARCHAR(255) | NO | YES | | NO | NO | 31 |
| override | COLLATE | | | | | | |
| | utf8_unicode_ci | | | | | | |
| tasting_notes_override | VARCHAR(255) | NO | YES | | NO | NO | 32 |
| | COLLATE | | | | | | |
| | utf8_unicode_ci | | | | | | |
| dtc_states | VARCHAR(255) | NO | YES | | NO | NO | 33 |
| | COLLATE | | | | | | |
| | utf8_unicode_ci | | | | | | |
| has_venue_image | BIT | NO | YES | | NO | NO | 34 |
| isdtconly | BIT | NO | YES | | NO | NO | 35 |
| create_date | TIMESTAMP | NO | NO | CURRENT_ | NO | NO | 36 |
| | | | | TIMESTAMP | | | |
| active_for_ | BIT | NO | NO | | NO | NO | 37 |
| inventory | | | | | | | |
| external_product_id | VARCHAR(255) | NO | YES | | NO | NO | 38 |
| | COLLATE | | | | | | |
| | utf8_unicode_ci | | | | | | |
| inventory_ product_code | VARCHAR(255) | NO | YES | | NO | NO | 39 |
| | COLLATE | | | | | | |
| | utf8_unicode_ci | | | | | | |
| name_for_inventory | VARCHAR(255) | NO | YES | | NO | NO | 40 |
| | COLLATE | | | | | | |
| | utf8_unicode_ci | | | | | | |
| packaging | VARCHAR(255) | NO | YES | | NO | NO | 41 |
| | COLLATE | | | | | | |
| | utf8_unicode_ci | | | | | | |
| darden_inventory_count | DOUBLE | NO | NO | | NO | NO | 42 |
| inventory_ | BIGINT | NO | YES | | NO | NO | 43 |
| version | | | | | | | |

TABLE 182
Locker Gifts DB table:

| COLUMN | DATA | | | | | | |
|---|---|---|---|---|---|---|---|
| NAME | TYPE | PK | NULLABLE | DEFAULT | AUTOINCREMENT | COMPUTED | POSITION |
| id | BIGINT | YES | NO | | YES | NO | 1 |
| version | BIGINT | NO | NO | | NO | NO | 2 |
| create_date | DATETIME | NO | NO | | NO | NO | 3 |
| gift_code_ | LONGTEXT | NO | YES | | NO | NO | 4 |
| hash | CHARSET latin1 | | | | | | |
| | COLLATE | | | | | | |
| | latin1_swedish_ci | | | | | | |
| gift_message | VARCHAR(255) | NO | YES | | NO | NO | 5 |
| | CHARSET latin1 | | | | | | |
| | COLLATE | | | | | | |
| | latin1_swedish_ci | | | | | | |
| gifted_bottle_count | INT | NO | NO | | NO | NO | 6 |
| gifter_owner_id | BIGINT | NO | NO | | NO | NO | 7 |
| locker_id | BIGINT | NO | NO | | NO | NO | 8 |
| note | LONGTEXT | NO | YES | | NO | NO | 9 |
| | CHARSET latin1 | | | | | | |
| | COLLATE | | | | | | |
| | latin1_swedish_ci | | | | | | |
| recipient_email_address | VARCHAR(255) | NO | YES | | NO | NO | 10 |
| | CHARSET latin1 | | | | | | |
| | COLLATE | | | | | | |
| | latin1_swedish_ci | | | | | | |
| recipient_first_name | VARCHAR(64) | NO | YES | | NO | NO | 11 |
| | CHARSET latin1 | | | | | | |
| | COLLATE | | | | | | |
| | latin1_swedish_ci | | | | | | |
| recipient_last_name | VARCHAR(64) | NO | YES | | NO | NO | 12 |
| | CHARSET latin1 | | | | | | |
| | COLLATE | | | | | | |
| | latin1_swedish_ci | | | | | | |
| recipient _owner_id | BIGINT | NO | YES | | NO | NO | 13 |
| redeem_message | VARCHAR(255) | NO | YES | | NO | NO | 14 |
| | CHARSET latin1 | | | | | | |
| | COLLATE | | | | | | |
| | latin1_swedish_ci | | | | | | |
| redeemed_ | INT | NO | NO | | NO | NO | 15 |
| bottle_count | | | | | | | |
| status | VARCHAR(255) | NO | NO | | NO | NO | 16 |
| | CHARSET latin1 | | | | | | |
| | COLLATE | | | | | | |
| | latin1_swedish_ci | | | | | | |
| update_date | DATETIME | NO | NO | | NO | NO | 17 |
| recipient_locker_id | BIGINT | NO | YES | | NO | NO | 18 |
| recipient_email_ | VARCHAR(255) | NO | YES | | NO | NO | 19 |
| address_enc | CHARSET latin1 | | | | | | |
| | COLLATE | | | | | | |
| | latin1_swedish_ci | | | | | | |
| recipient_first_ | VARCHAR(255) | NO | YES | | NO | NO | 20 |
| name_enc | CHARSET latin1 | | | | | | |
| | COLLATE | | | | | | |
| | latin1_swedish_ci | | | | | | |
| recipient_last_ | VARCHAR(255) | NO | YES | | NO | NO | 21 |
| name_enc | CHARSET latin1 | | | | | | |
| | COLLATE | | | | | | |
| | latin1_swedish_ci | | | | | | |

TABLE 184
Comments DB table:

| COLUMN | DATA | | | | | | |
|---|---|---|---|---|---|---|---|
| NAME | TYPE | PK | NULLABLE | DEFAULT | AUTOINCREMENT | COMPUTED | POSITION |
| id | BIGINT | YES | NO | | YES | NO | 1 |
| version | BIGINT | NO | NO | | NO | NO | 2 |
| comment | VARCHAR(255) | NO | NO | | NO | NO | 3 |
| | CHARSET latin1 | | | | | | |
| | COLLATE | | | | | | |
| | latin1_swedish_ci | | | | | | |
| create_date | DATETIME | NO | NO | | NO | NO | 4 |
| locker_id | BIGINT | NO | YES | | NO | NO | 5 |
| locker_owner_id | BIGINT | NO | NO | | NO | NO | 6 |
| locker_wine_id | BIGINT | NO | YES | | NO | NO | 7 |
| note | LONGTEXT | NO | YES | | NO | NO | 8 |
| | CHARSET latin1 | | | | | | |
| | COLLATE | | | | | | |
| | latin1_swedish_ci | | | | | | |
| status | VARCHAR(255) | NO | NO | | NO | NO | 9 |
| | CHARSET latin1 | | | | | | |
| | COLLATE | | | | | | |
| | latin1_swedish_ci | | | | | | |
| update_date | TIMESTAMP | NO | YES | CURRENT_ | NO | NO | 10 |
| | | | | TIMESTAMP | | | |
| | | | | on update | | | |
| | | | | CURRENT_ | | | |
| | | | | TIMESTAMP | | | |
| is_manager_ | BIT | NO | YES | | NO | NO | 11 |
| comment | | | | | | | |

TABLE 186
Followers DB table:

| COLUMN | DATA | | | | | | |
|---|---|---|---|---|---|---|---|
| NAME | TYPE | PK | NULLABLE | DEFAULT | AUTOINCREMENT | COMPUTED | POSITION |
| id | BIGINT | YES | NO | | YES | NO | 1 |
| version | BIGINT | NO | NO | | NO | NO | 2 |
| approve_date | DATETIME | NO | NO | | NO | NO | 3 |
| email_address | VARCHAR(255) | NO | YES | | NO | NO | 4 |
| | CHARSET latin1 | | | | | | |
| | COLLATE | | | | | | |
| | latin1_swedish_ci | | | | | | |
| first_name | VARCHAR(64) | NO | YES | | NO | NO | 5 |
| | CHARSET latin1 | | | | | | |
| | COLLATE | | | | | | |
| | latin1_swedish_ci | | | | | | |
| last_name | VARCHAR(64) | NO | YES | | NO | NO | 6 |
| | CHARSET latin1 | | | | | | |
| | COLLATE | | | | | | |
| | latin1_swedish_ci | | | | | | |
| note | LONGTEXT | NO | YES | | NO | NO | 7 |
| | CHARSET latin1 | | | | | | |
| | COLLATE | | | | | | |
| | latin1_swedish_ci | | | | | | |
| request _date | DATETIME | NO | NO | | NO | NO | 8 |
| status | VARCHAR(255) | NO | NO | | NO | NO | 9 |
| | CHARSET latin1 | | | | | | |
| | COLLATE | | | | | | |
| | latin1_swedish_ci | | | | | | |
| update_date | DATETIME | NO | NO | | NO | NO | 10 |
| email_address_enc | VARCHAR(255) | NO | YES | | NO | NO | 11 |
| | CHARSET latin1 | | | | | | |
| | COLLATE | | | | | | |
| | latin1_swedish_ci | | | | | | |
| first_name_enc | VARCHAR(255) | NO | YES | | NO | NO | 12 |
| | CHARSET latin1 | | | | | | |
| | COLLATE | | | | | | |
| | latin1_swedish_ci | | | | | | |
| last_name_ | VARCHAR(255) | NO | YES | | NO | NO | 13 |
| enc | CHARSET latin1 | | | | | | |
| | COLLATE | | | | | | |
| | latin1_swedish_ci | | | | | | |

TABLE 188
Messages DB table:

| COLUMN | DATA | | | | | | |
|---|---|---|---|---|---|---|---|
| NAME | TYPE | PK | NULLABLE | DEFAULT | AUTOINCREMENT | COMPUTED | POSITION |
| id | BIGINT | YES | NO | | YES | NO | 1 |
| version | BIGINT | NO | NO | | NO | NO | 2 |
| active_date | DATETIME | NO | YES | | NO | NO | 3 |
| author_id | BIGINT | NO | YES | | NO | NO | 4 |
| create_date | DATETIME | NO | NO | | NO | NO | 5 |
| from_string | VARCHAR(255) | NO | YES | | NO | NO | 6 |
| | CHARSET latin1 | | | | | | |
| | COLLATE | | | | | | |
| | latin1_swedish_ci | | | | | | |
| message | LONGTEXT | NO | NO | | NO | NO | 7 |
| | CHARSET latin1 | | | | | | |
| | COLLATE | | | | | | |
| | latin1_swedish_ci | | | | | | |
| message_type | VARCHAR(255) | NO | NO | | NO | NO | 8 |
| | CHARSET latin1 | | | | | | |
| | COLLATE | | | | | | |
| | latin1_swedish_ci | | | | | | |
| recipient_type | VARCHAR(255) | NO | NO | | NO | NO | 9 |
| | CHARSET latin1 | | | | | | |
| | COLLATE | | | | | | |
| | latin1_swedish_ci | | | | | | |
| title | VARCHAR(255) | NO | YES | | NO | NO | 10 |
| | CHARSET latin1 | | | | | | |
| | COLLATE | | | | | | |
| | latin1_swedish_ci | | | | | | |
| update_date | DATETIME | NO | YES | | NO | NO | 11 |
| data_string | LONGTEXT | NO | YES | | NO | NO | 12 |
| | CHARSET latin1 | | | | | | |
| | COLLATE | | | | | | |
| | latin1_swedish_ci | | | | | | |
| message_ | VARCHAR(255) | NO | YES | | NO | NO | 13 |
| subtype | CHARSET latin1 | | | | | | |
| | COLLATE | | | | | | |
| | latin1_swedish_ci | | | | | | |
| confirm_ | BIGINT | NO | YES | | NO | NO | 14 |
| message _id | | | | | | | |

Client Application—VWL Mobile Application.

The VWL application 122 allows the restaurant customers a glimpse into the world of individual, privately held wine lockers stored on the restaurant's behalf. It allows owners of a virtual wine locker the ability to show off their wine collection and share their wine knowledge in an interactive and entertaining manner. Lockers may have a public or private value set as the default for the locker. Lockers that are set to be viewed publicly can be viewed and commented on by other patrons. Further, lockers can be “followed” such that anyone can sign up with an email address to get updates on the activity of a certain wine locker.

FIG. 2B illustrates one particularly preferred method flow according to the present invention. Although numerous processes are described win this application, the method of FIG. 2B is illustrative. The process starts at 190 and at step 192 the API transmits a wine bottle sales price to the mobile device. At step 194, the mobile device receives the bottle sale price at the VWL application. At step 196 the mobile device transmits a purchase message to the API along with VWL owner-related data. At step 197, the wine locker associated with the previously transmitted owner related data is updated to include the wine bottle sent by the purchase message. The process stops at step 198. While this method is specific to the data involved in the transaction as described, it is representative of the overall message flows taking place within the system of FIG. 2A.

FIGS. 2C-2H show the overall VWL screen available to patrons when seated at the restaurant.

FIG. 2C: Locker gallery screen 201. Relevant data tables are: Table 172, Table 174, Table 176, Table 178, Table 180. The locker gallery screen 201 shows all lockers 202 at a particular restaurant or venue but will only display the contents of those lockers with a visibility setting of “Public.” Functional movement from this screen allows locker access 203 an ability to claim a gift 204 and otherwise generally explore the venue's wine listings 205.

FIG. 2D: Wine locker screen 207. Relevant data tables are: Table 172, Table 174, Table 176, Table 178, Table 180. The contents 208 of a particular, public wine locker are displayed when the patron touches that wine locker (Bill Ford in the example of FIG. 2D). Individual bottles of wine stored in that locker are displayed either as a bottle 208 or a label 209. Highlighted screen hyperlink 210 indicates that the wines within the locker are being viewed in the wine locker screen. Where the full locker contents extend beyond the wine locker screen 207, the graphical display may be scrolled by swiping the GUI up/down or right/left depending on the system designer's preference.

FIG. 2E: The wine details screen. Relevant data tables are: Table 172, Table 176, Table 178. By touching any particular wine on the wine locker screen 207, an image 213 of the wine bottle or label is displayed along with wine details 214 including tasting notes on each wine in the locker. The wine name, vintage region or vineyard are optionally displayed as part of the wine details screen as well. A menu button 215 will bring the patron to menu screen for the restaurant as described later.

FIG. 2F: The wine comments screen 217. Relevant data tables are: Table 172, Table 184. By touching the comments hyperlink 218, all of the comments 219 made by various persons on that particular wine are displayed. As this is Bill Ford's wine locker, his comments are displayed. Further, comments from others will be displayed if Mr. Ford's VWL has a public setting.

FIG. 2G: The follow screen 221. Relevant data table is Table 186. By touching the follow hyperlink 222, patrons of the restaurant can sign up to “follow” any public locker by entering their email address into an appropriate field 223 on the follow screen and hitting the “follow locker” button 224. “Following” patrons will then begin receiving emails regarding the activity in the followed locker such as when wines are consumed, added or changes to the locker are made.

FIG. 2H: The history screen 225. Relevant data tables are: Table 172, Table 176, Table 178, Table 180. This screen shows the history of the wine locker, in the form of wine bottle or labels 226. In one particular embodiment, all wines that have been consumed by the VWL owner, Bill Ford, are available for viewing so long as his VWL is designated as “public.”

FIGS. 2I-2AB show the overall VWL screens available to a patron who is accessing their own wine locker when seated at the restaurant.

FIG. 2I: The login screen 228. Relevant data table is Table 174. VWL members can log into their wine locker for a personalized experience by entering into relevant screen fields their username 229 and personal identification number (PIN) 230.

FIG. 2J: The locker selection screen 232. Relevant data tables are: Table 172, Table 174. Members with multiple lockers at different locations of a chain restaurant may choose which locker to view when they log in. Locker selection screen 232 shows Bill Ford's locker at the present venue 237 as well as his locker at the NY venue 234 of the restaurant franchise in which he is seated as a patron. Logout button 235 is available in the upper right corner of the personal locker screens in FIGS. 2I-2AB for a patron to log out of his or her personal locker.

FIG. 2K: The personal locker contents screen 237. Relevant data tables are: Table 172, Table 176, Table 178. As with the publicly viewable lockers, private VWL contents are viewable as a logged in member in the form of bottles 208 or labels 209. Screen hyperlink 210 indicate that the wines within the private locker are being viewed in the personal locker contents in the authorized logged in view 237. Finally, gift button 238 is made available so that a private locker owner can gift a bottle of wine from the locker. This gifting functionality is only available to the locker owner in the private locker view but not to others who have been granted locker access (key holders) as described below.

FIG. 2L: The authorized locker home screen 240. Relevant data tables are: Table 172, Table 174, Table 176, Table 178, Table 180, Table 182, Table 184, Table 186. The home screen for a VWL authorized member gives overall statistics 241 of his or her private locker at a glance. Such statistics include but are not limited to the number of bottles in the locker, the number of bottles consumed and present in the locker history, the keyholders for the locker, the number of followers (if it's a designated public locker), the number of active gifts granted from and to the locker and the number and status of the gifts of redeemed from the locker. Partially consumed bottles may also be indicated although not shown in this screen of FIG. 2L. Functional buttons 242 (gifts) 243 (keyholders) and 244 (settings) are provided to add additional functionality for the private VWL owner as described below.

FIG. 2M: The gifts screen 245. Relevant data table is Table 182. The gifts screen accessible by accessing the gifts button 242 of FIG. 2L lists all of the gifts sent from the displayed private locker including gift details and status. Gifts status 246 is are shown in line-item form and includes a gift number, gift recipient, the number of bottles gifted and redeemed, the substance of the gift (specific wines vs. any wine) and the date of the gift. Gifts may be a VWL private wine locker to private wine locker transfer or they may be to non-members for redemption during that non-member patron's next visit to that restaurant venue. In one particular embodiment of the present invention, although not shown in detail in this figure, an inventory management system may be coupled to the gifting function (and later-described purchase function) so as to ensure the proper removal, placement, and storage of the actual gifted wine bottles. The same is true of wine purchased by a wine locker member as described later.

FIG. 2N: The keyholders screen 248. Relevant data table is Table 174. The keyholders screen, accessible by the keyholder's functional button 243 of FIG. 2L, allows the private VWL member the ability to designate access to his or her private VWL. Additional keyholders may be added by populating name and email information into relevant screen fields 249 which sends an email inviting them to be a keyholder. In one particular embodiment, invited and accepted keyholders can add, comment on, and consume wine from the locker, even if it has a “private” designation, but they do not have privileges to gift wine from the locker or invite others to be keyholders.

FIG. 2O: The settings screen 251. Relevant data table is Table 172. Here the VWL member can set the “public”/“private” nature of the locker with selection button 252 so as to grant others the privileges described herein.

FIG. 2P: The comments screen 254. Relevant data table is Table 172. (Table 184). As with the comments hyperlink on the generally available publicly displayed VWL pages, comments can be viewed by the VWL member through the same hyperlink. Additional comments can be added by the VWL member with add comment button 256 and removed if desired with button 255 at any time.

FIG. 2Q: As with the general view of wines within publicly available lockers (FIG. 2H), this FIG. shows private wine locker history screen 257 and the wines consumed by the VWL member. History may be viewed by the member at any time. Relevant data tables are: Table 172, Table 176, Table 178.

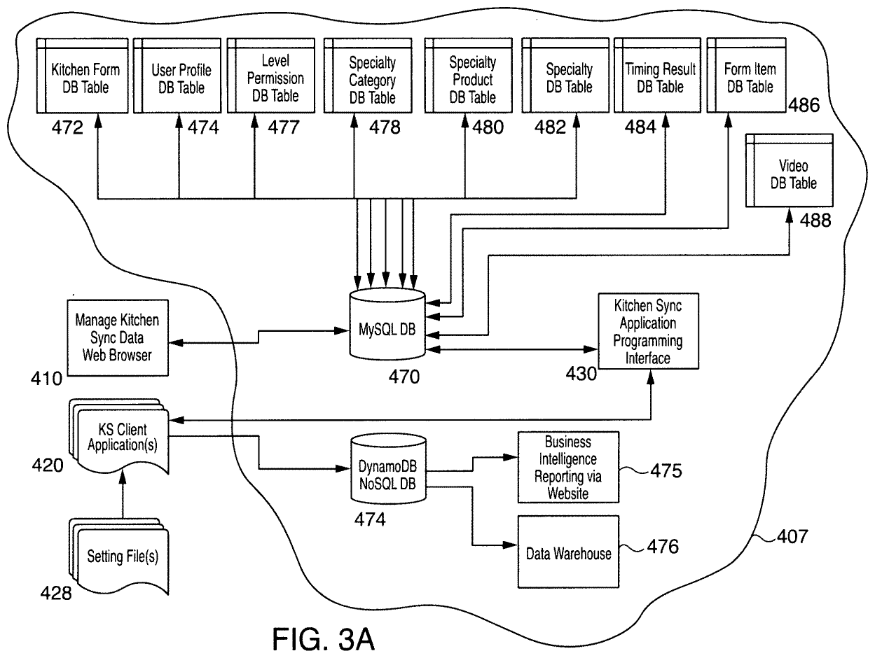

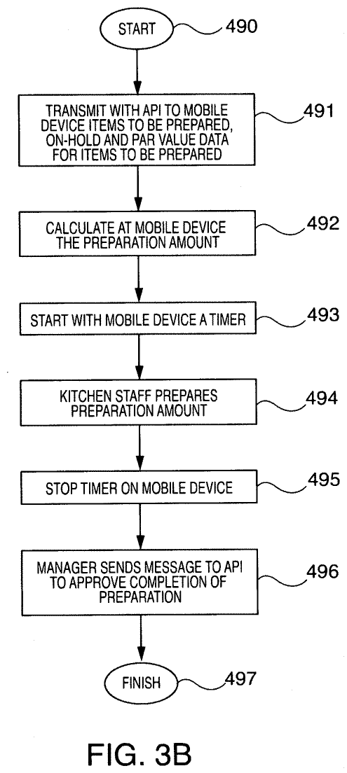

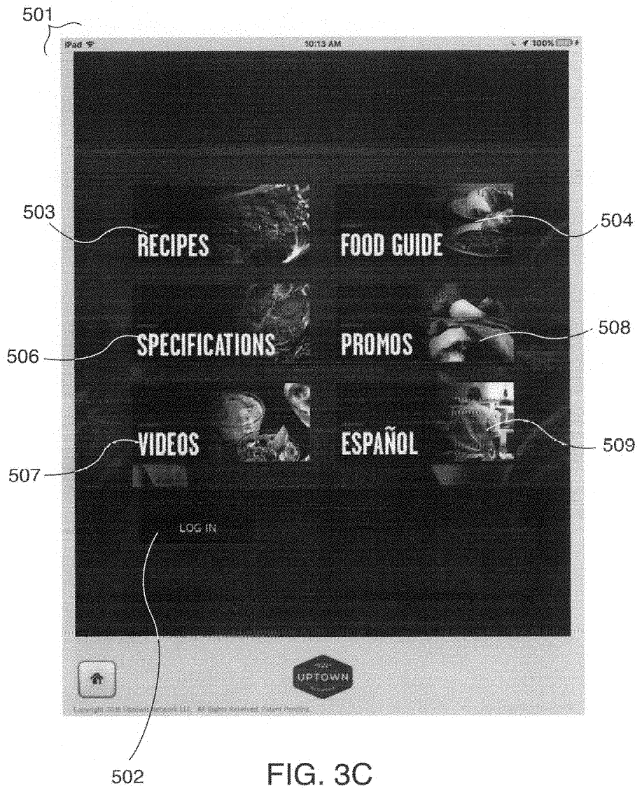

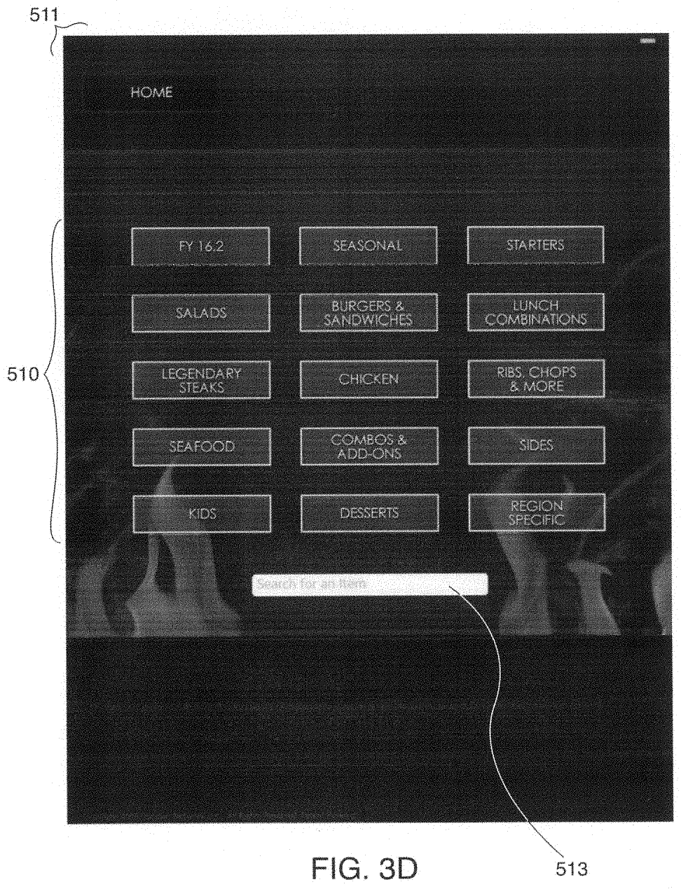

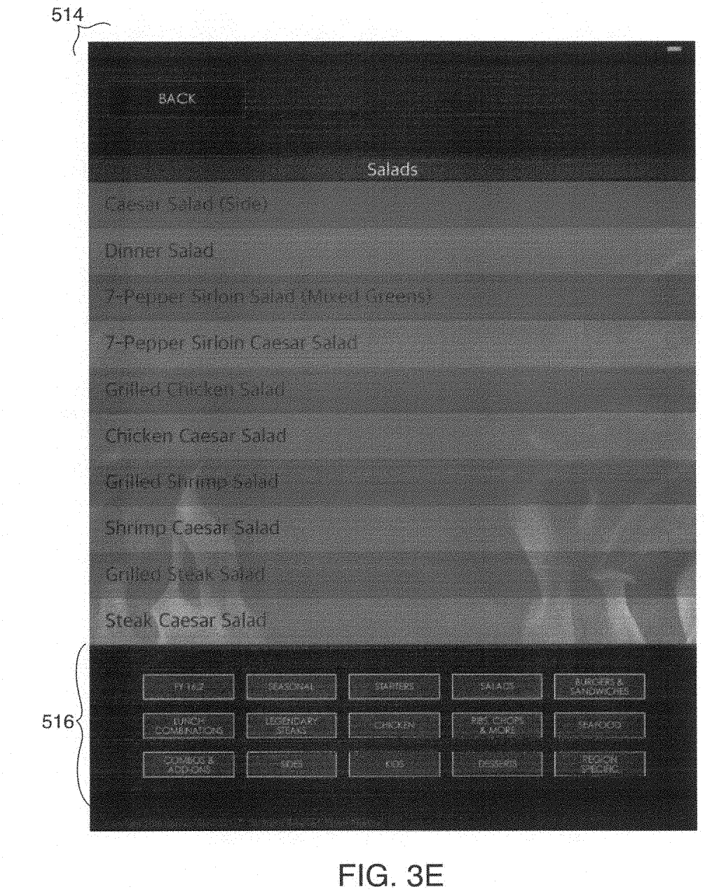

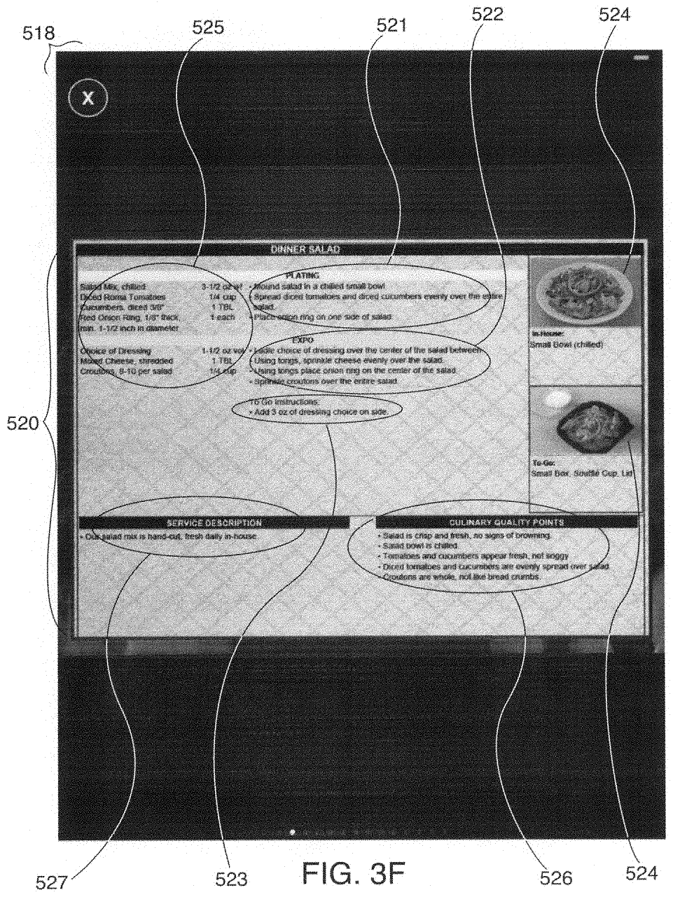

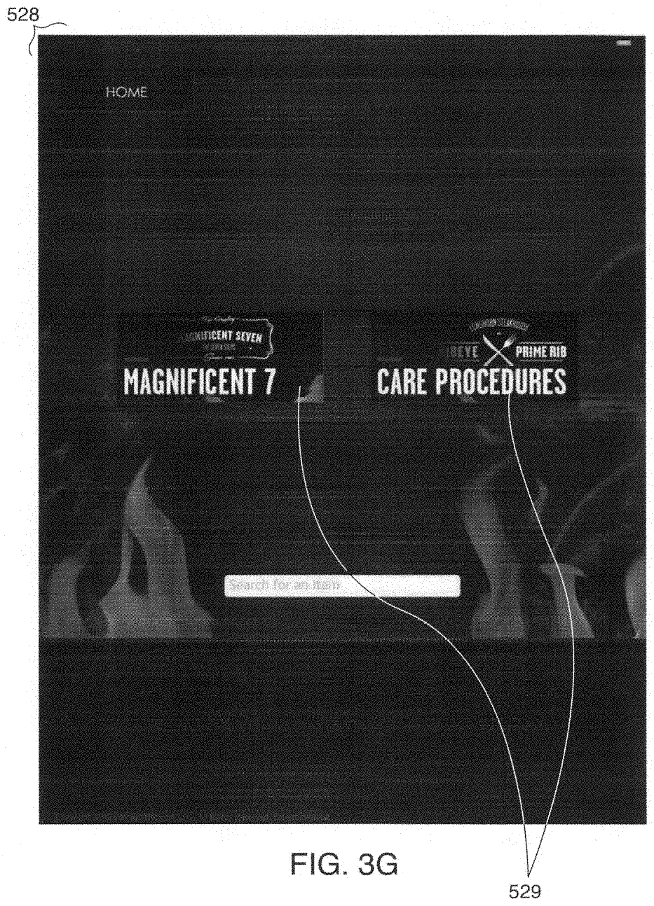

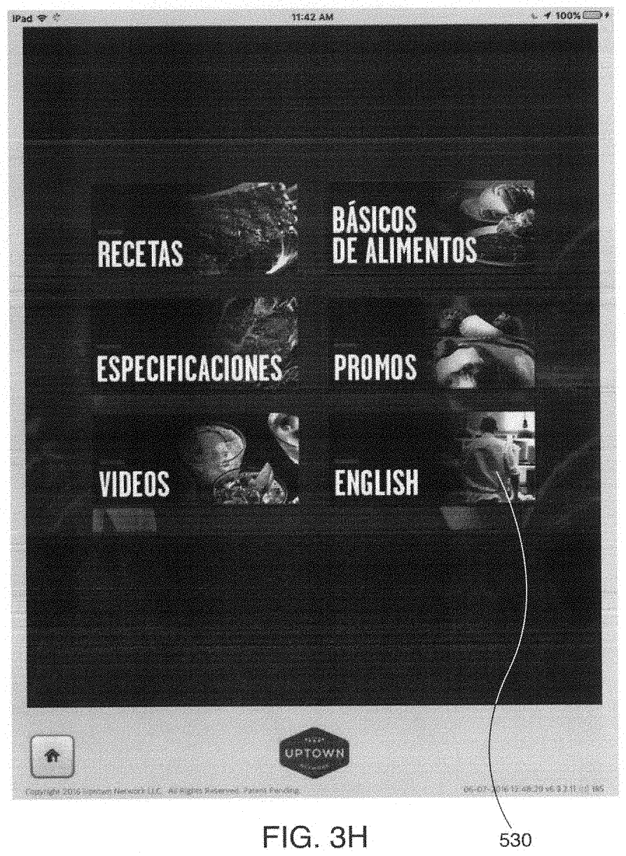

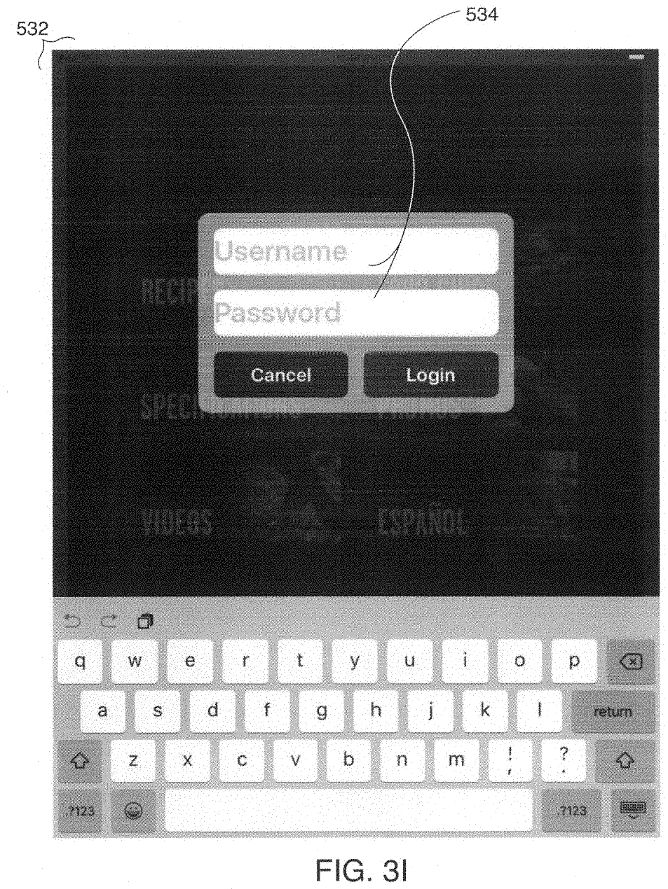

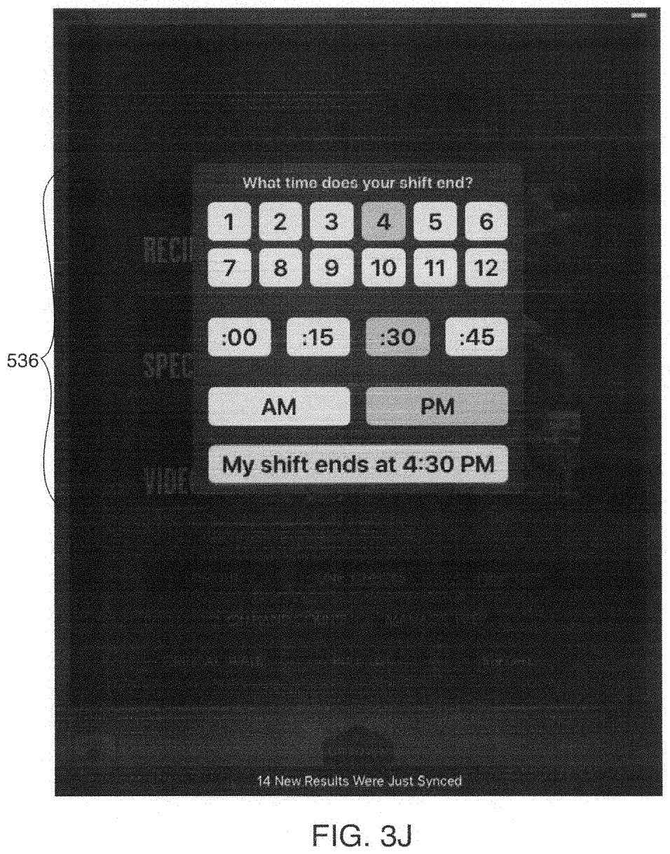

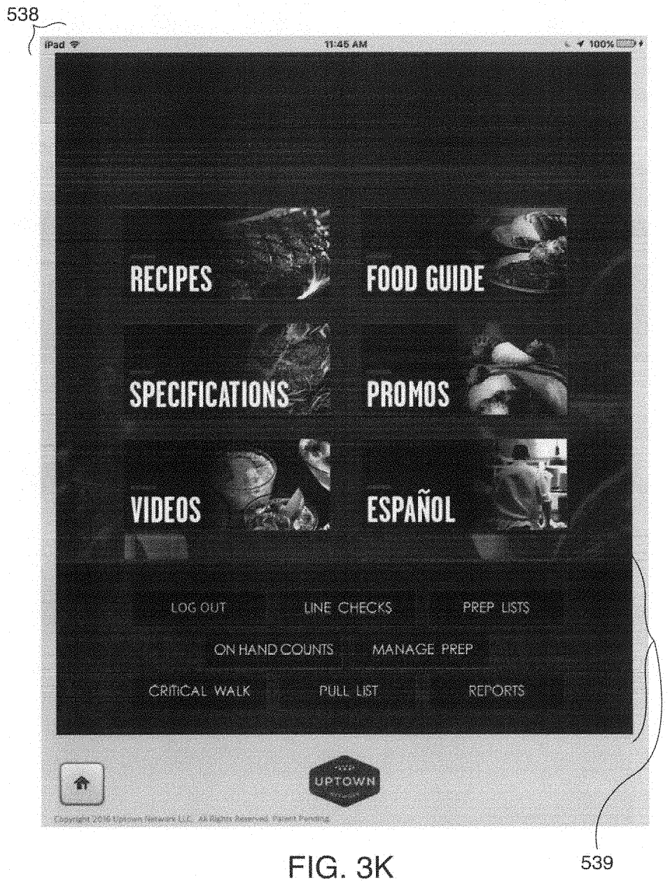

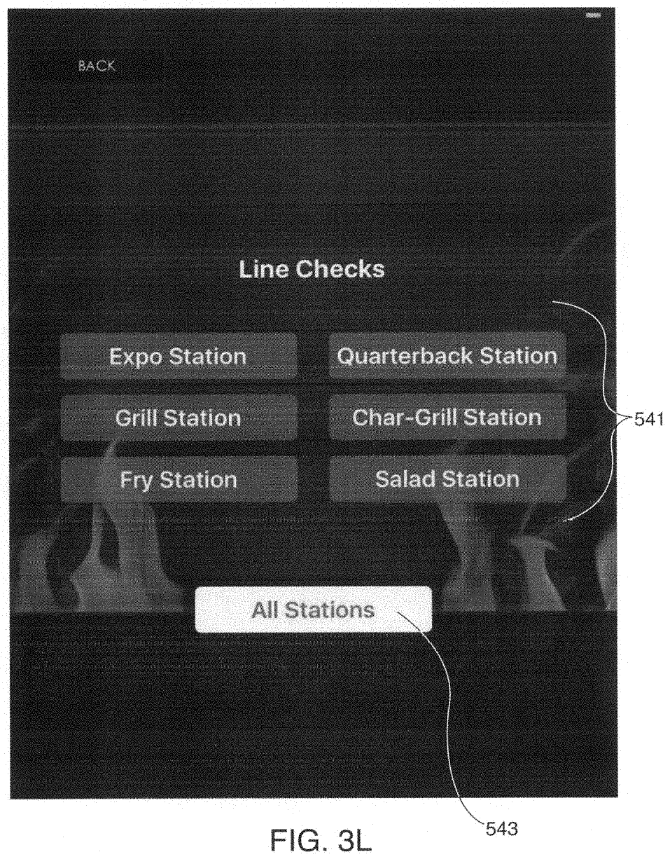

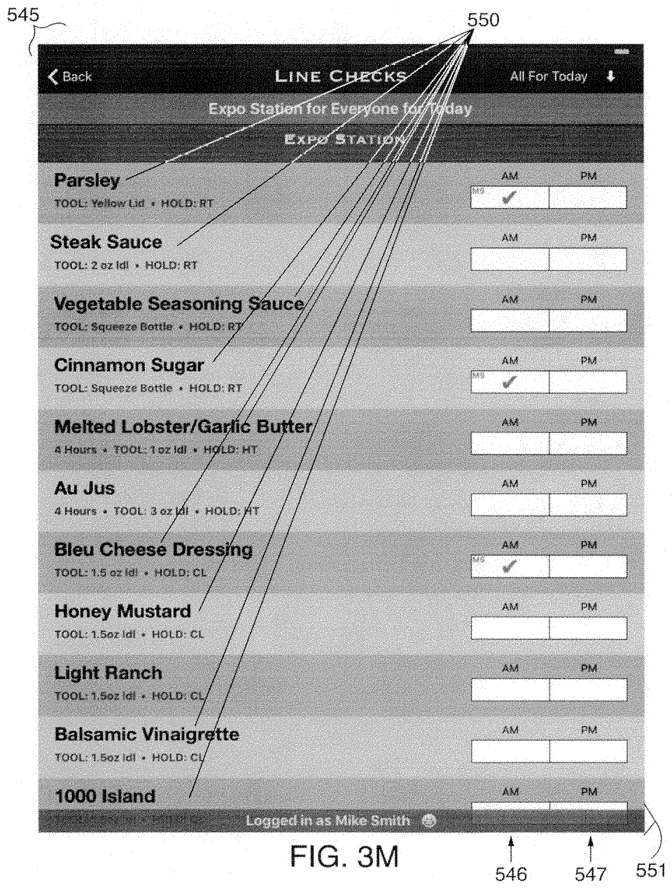

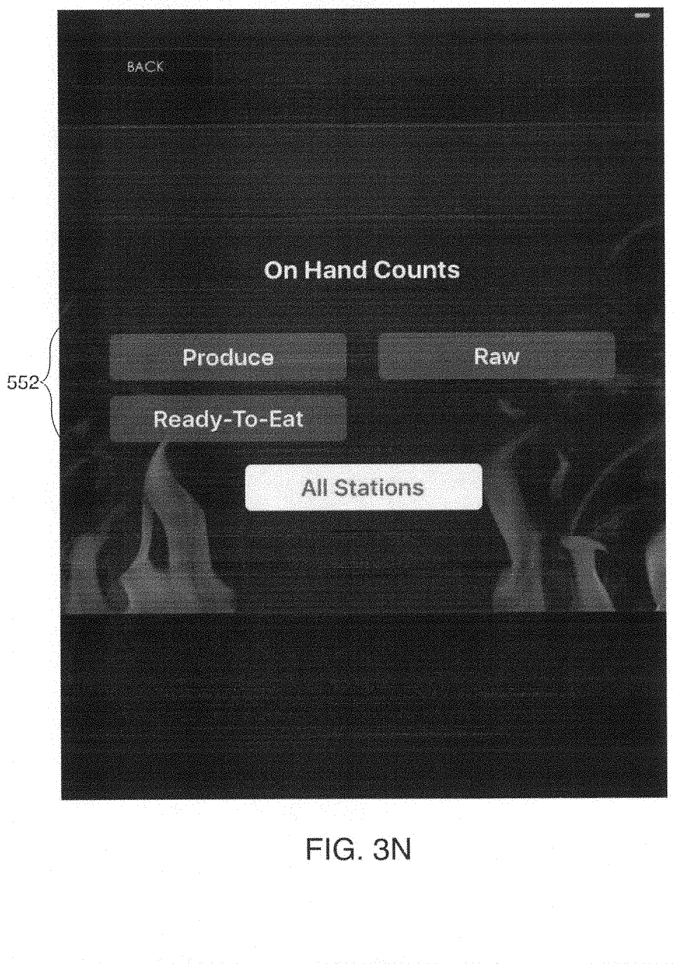

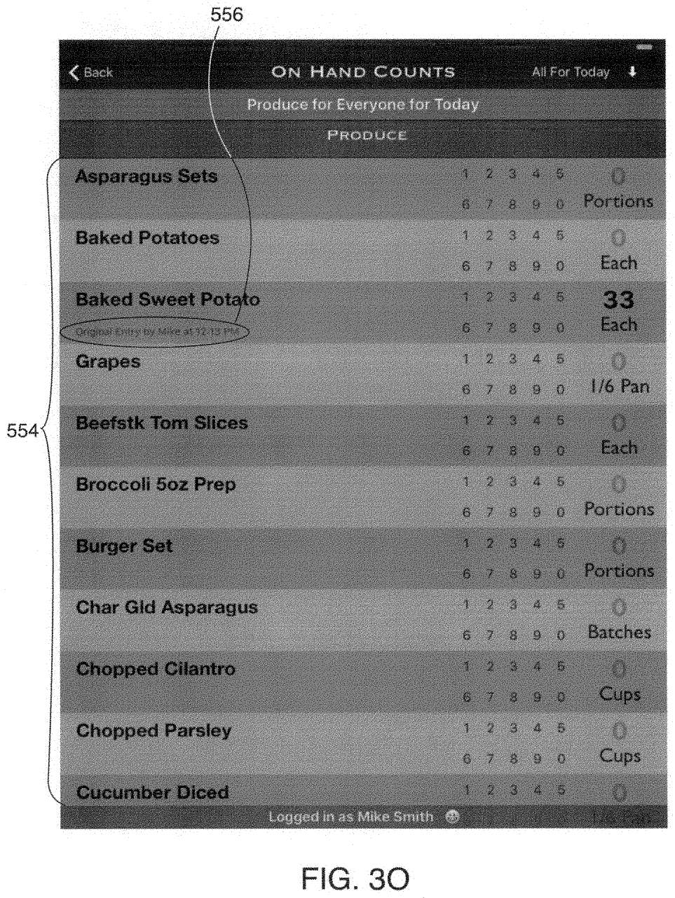

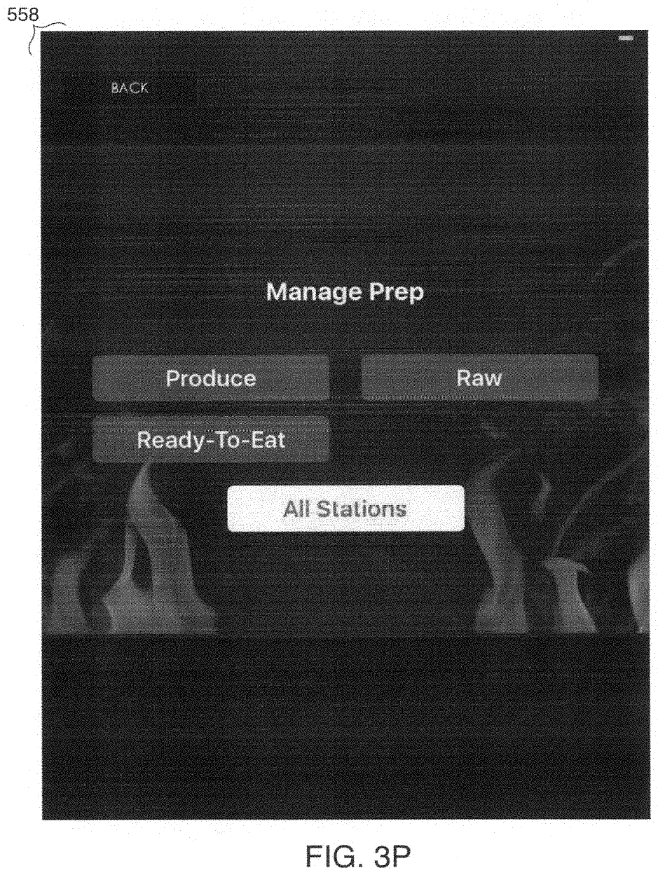

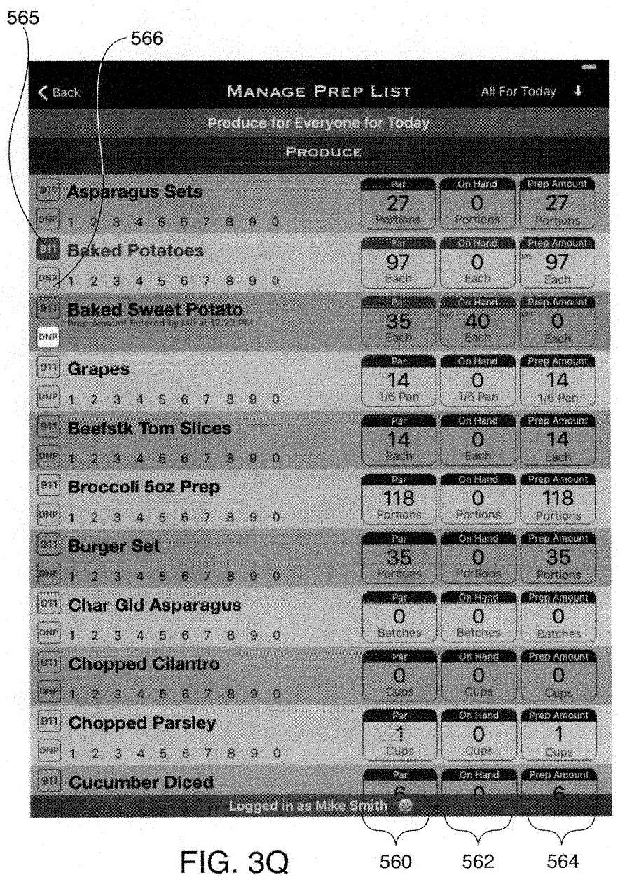

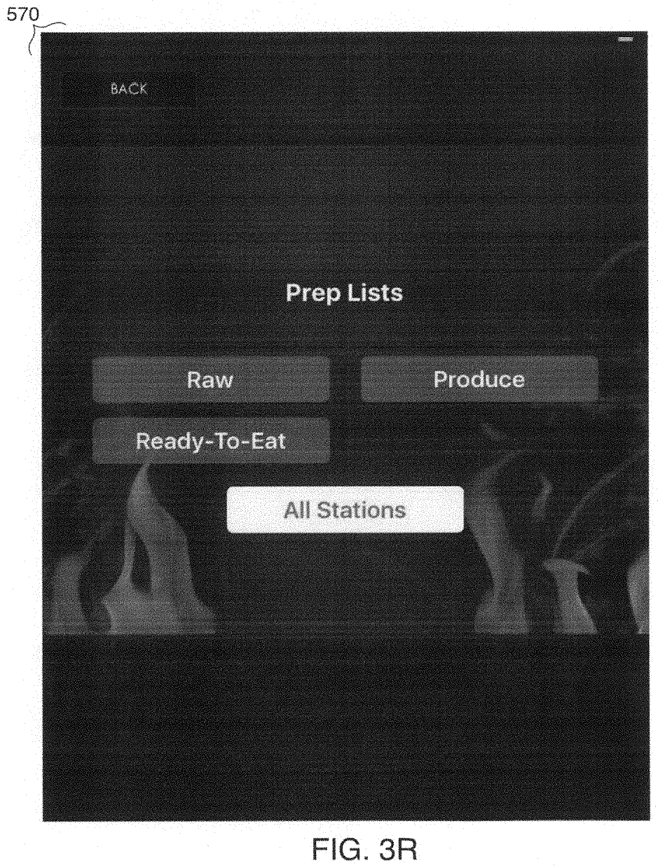

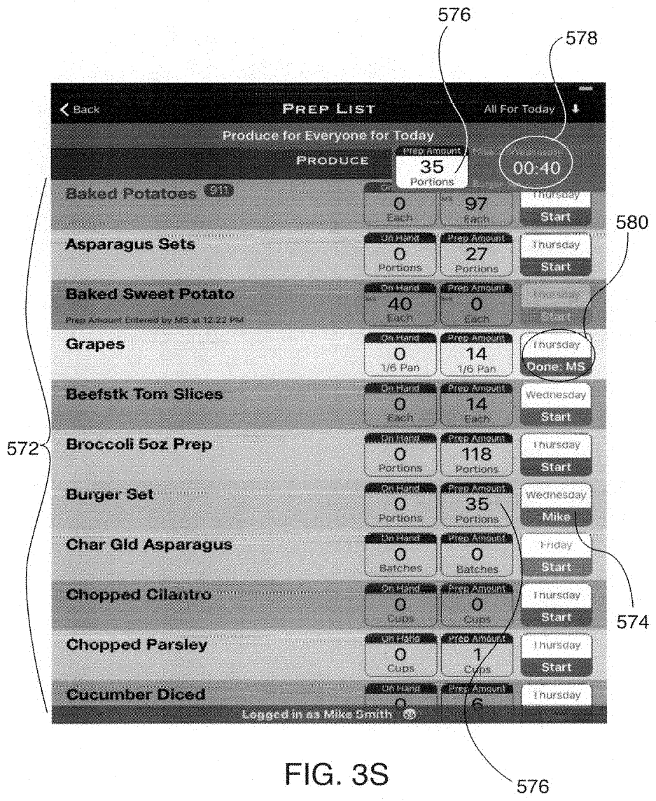

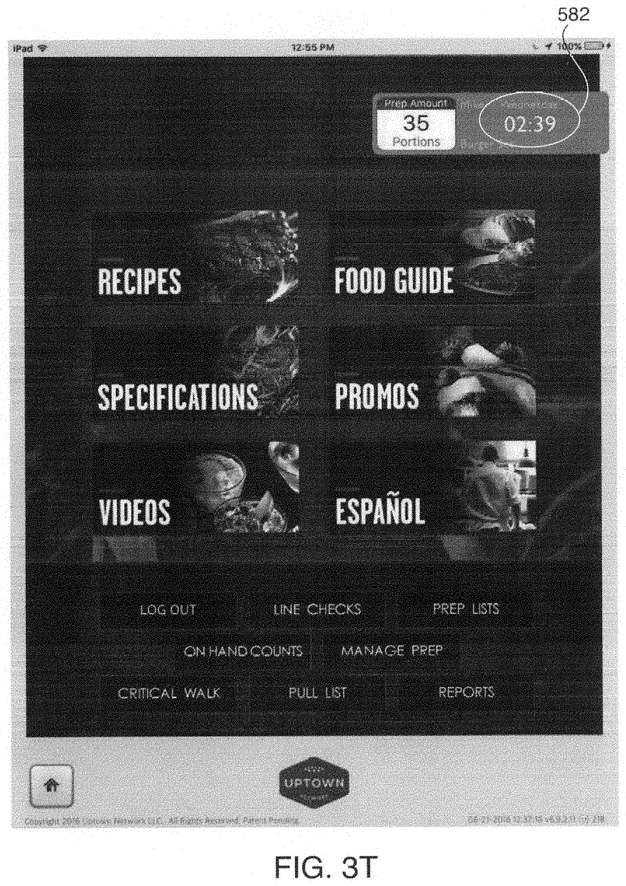

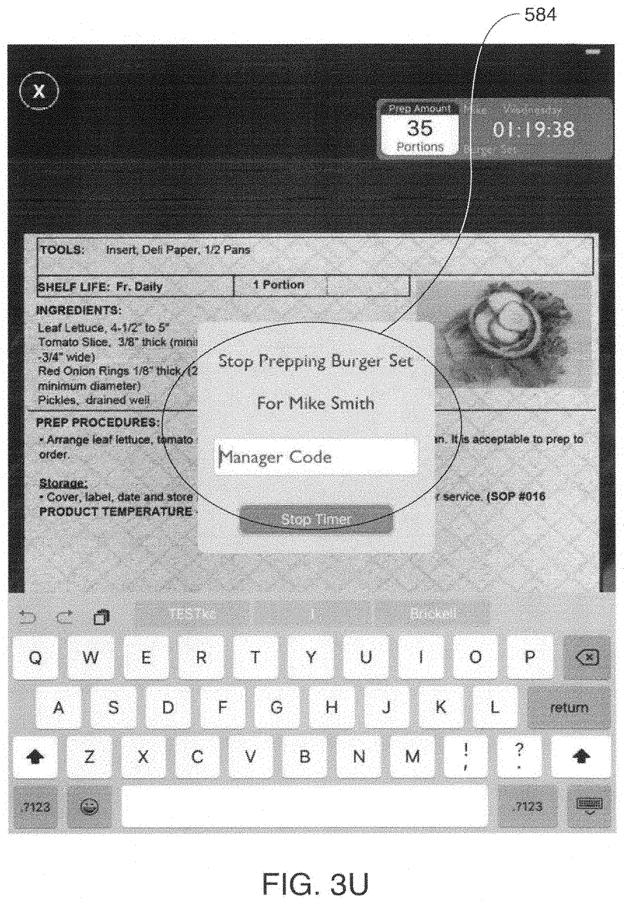

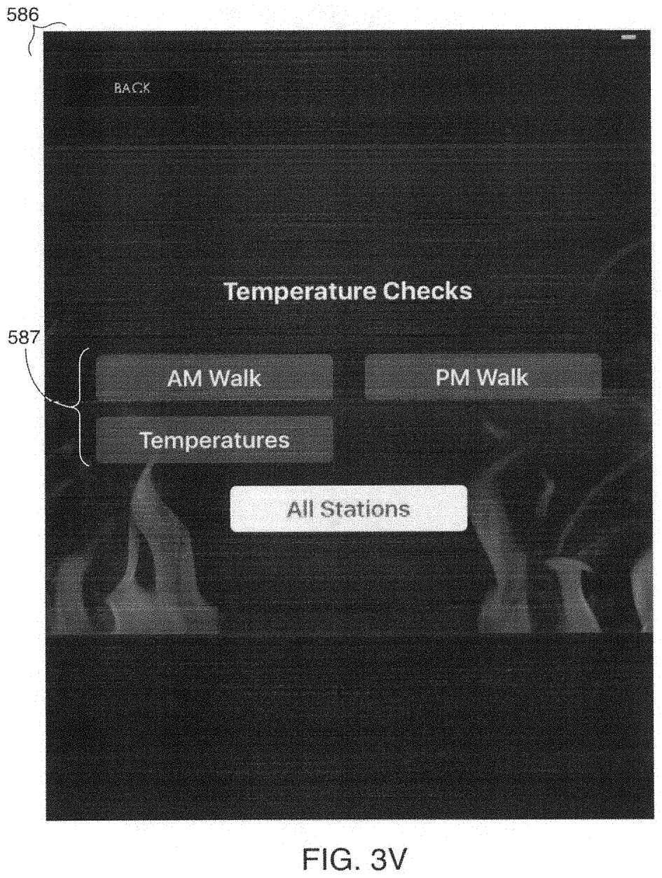

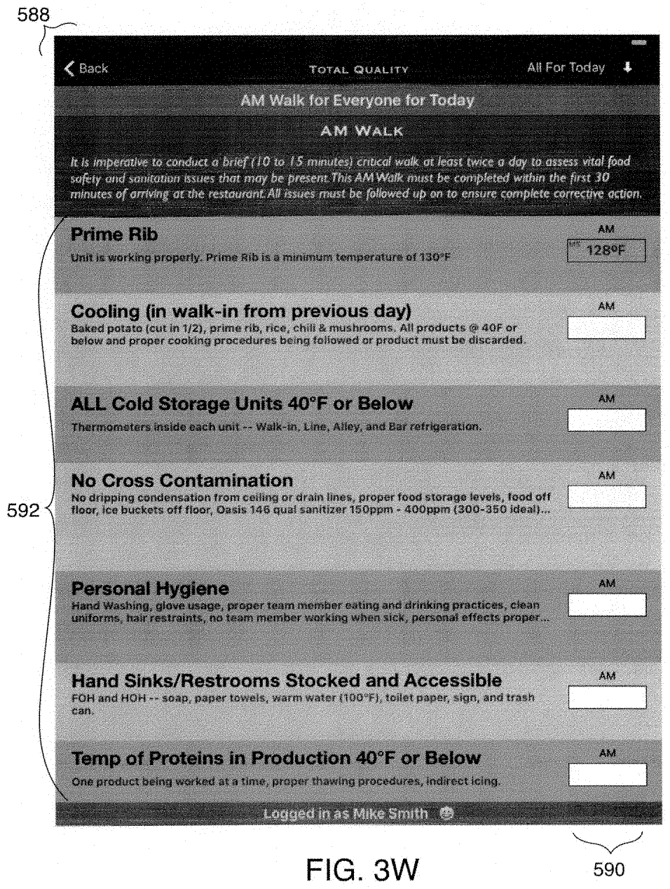

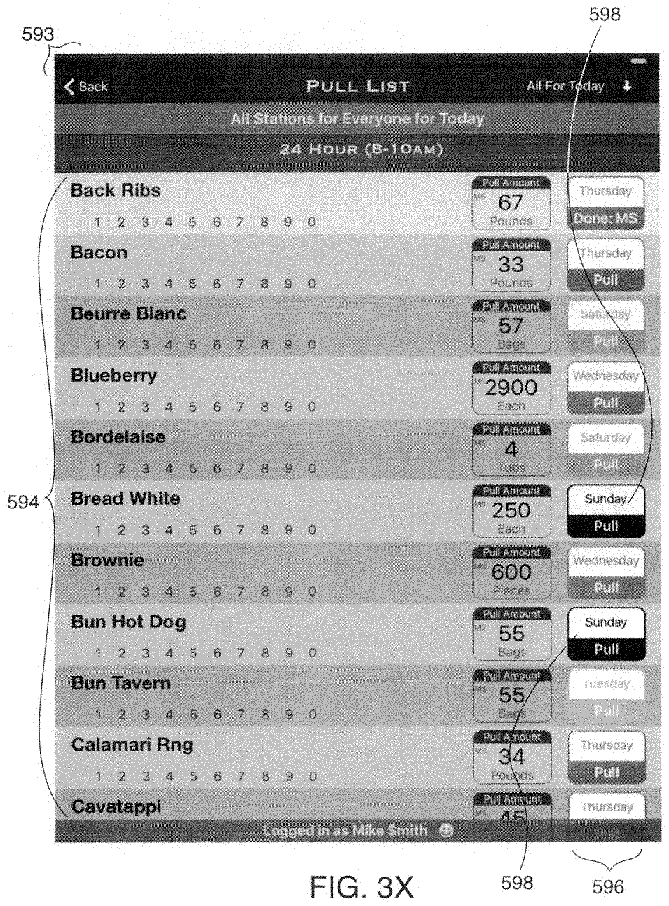

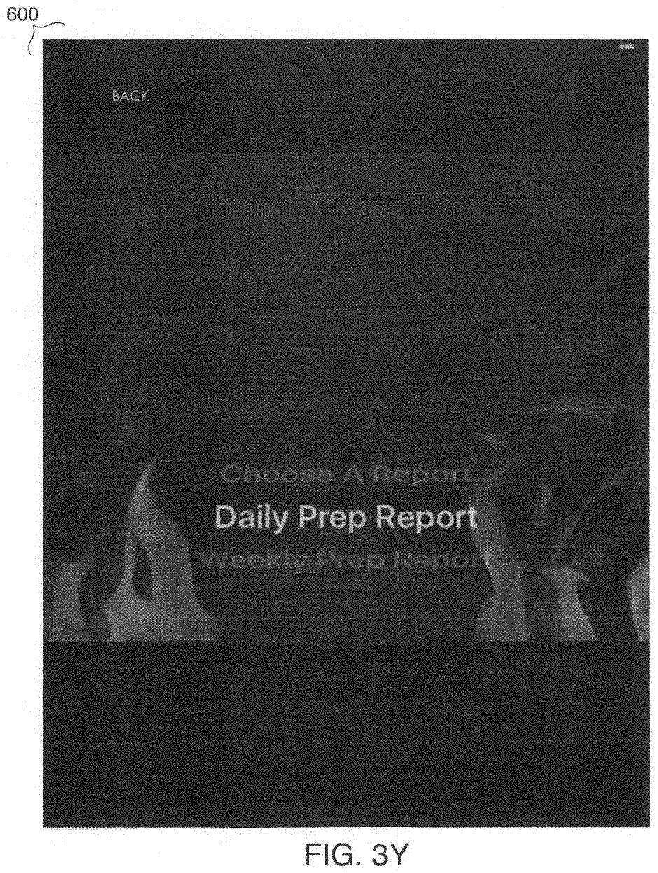

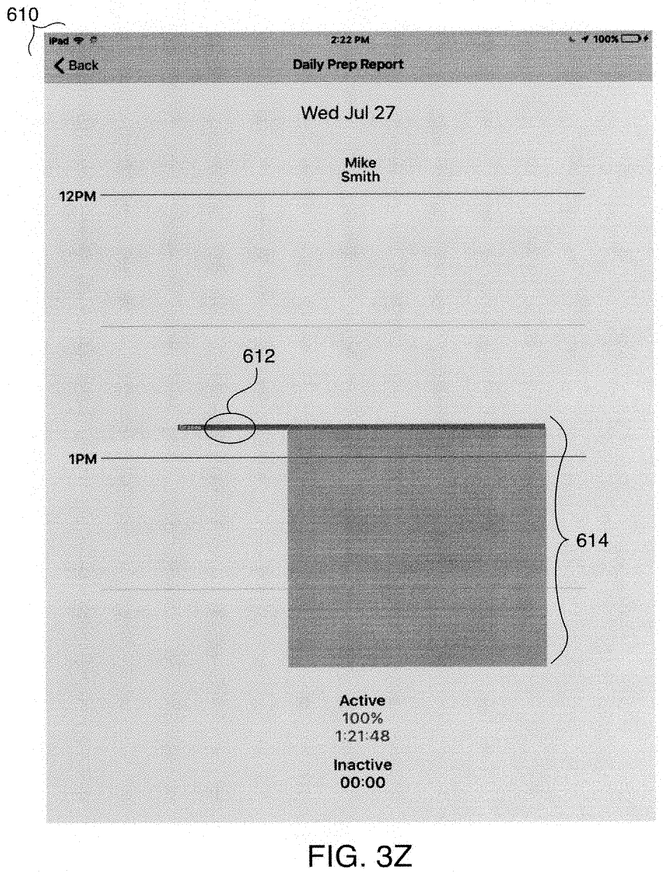

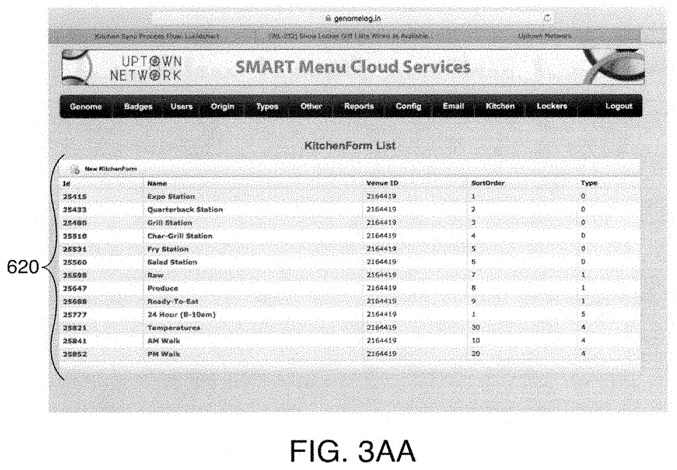

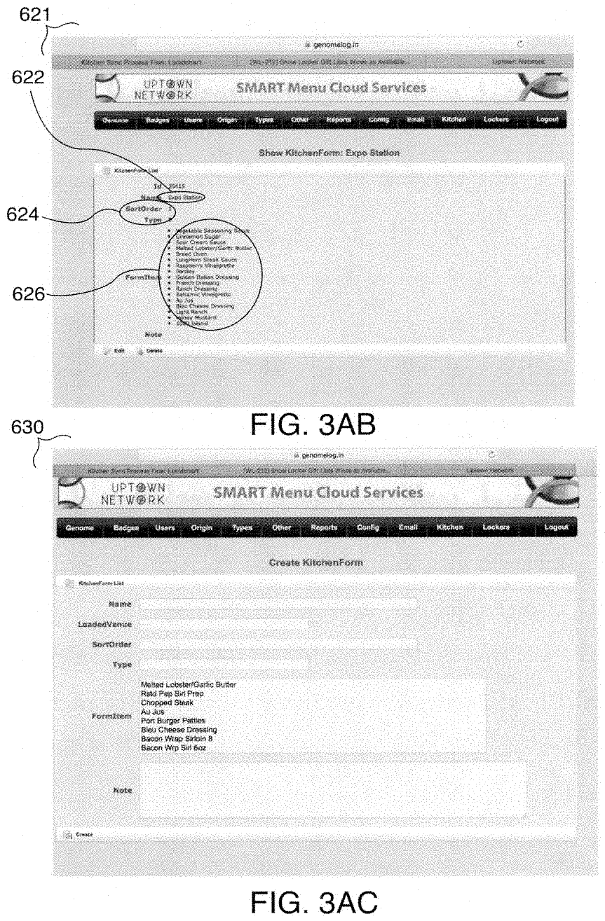

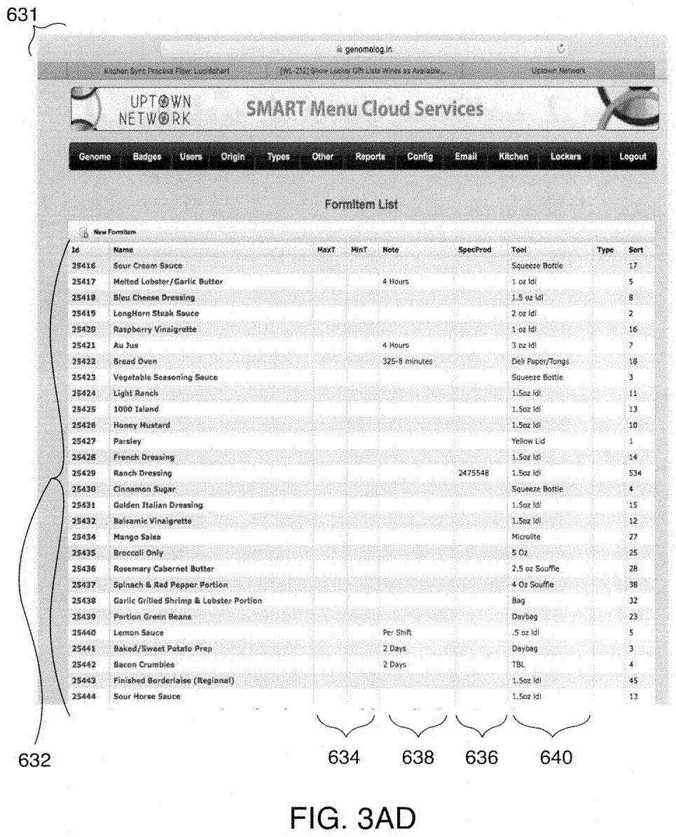

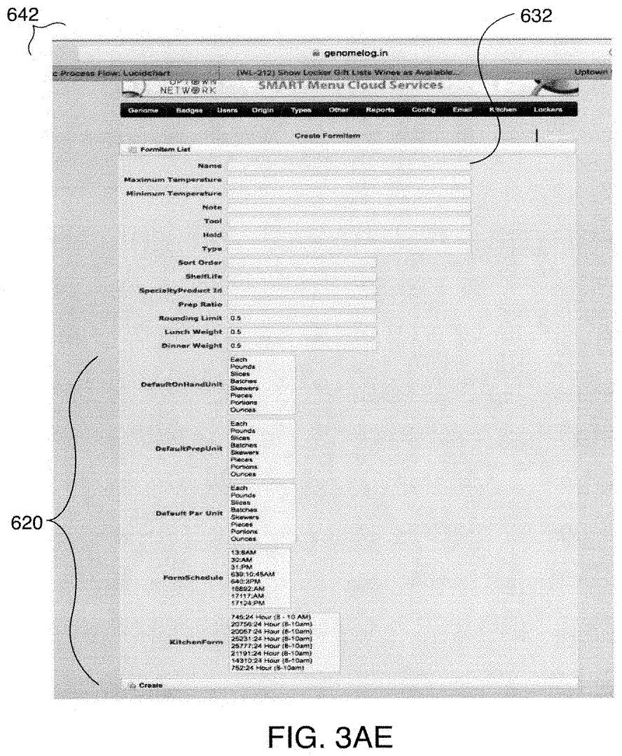

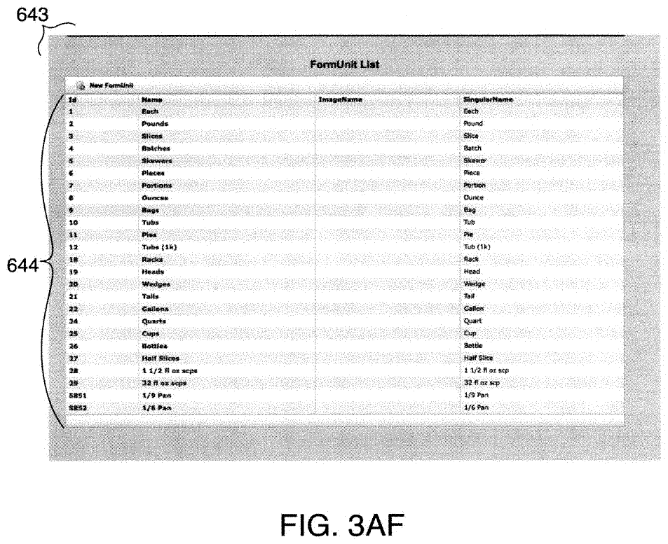

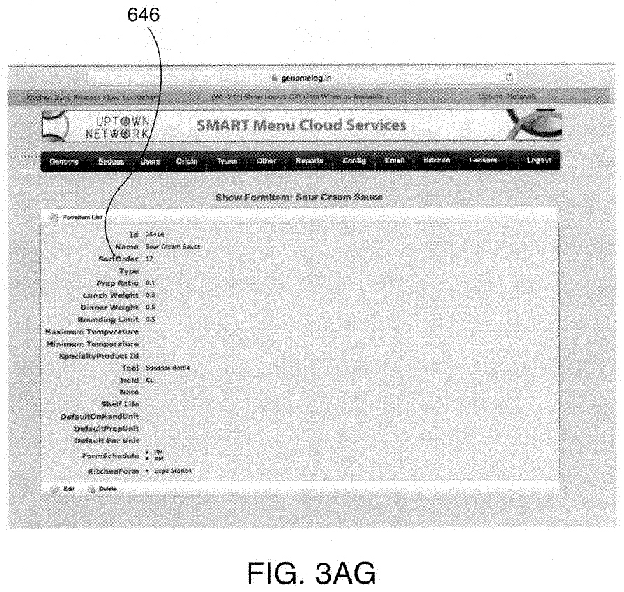

FIG. 2R: The VWL wine ordering screen 259. Relevant data tables are: Table 172, Table 176, Table 178, Table 180. Navigation to any wine in the restaurant wine list or with the wine locker displays the details of that wine 260 including but not limited to the name, vineyard, vintage, bin number tasting notes description, prices, bottle label and size and provides a button for the logged in user to add a wine to his locker. Locker addition button 261 enables that wine bottle to be added to the member's VWL. Suggested food pairings button 262 takes the viewer to the restaurant menu for selecting complementary food orders from the digital menu application. This is similar to the private viewing option menu function performed by menu button 215 of FIG. 3. Tasting notes may be emailed to the VWL member with button 263, and new searches for wine may be performed by with button 264.

FIGS. 2S and 2T provide for ordering the wine from within a member's VWL. The number of bottle are selected from within menu 267 on bottle number selection screen 266. The selection of “Add N bottle(s) button 268 continues with the ordering function and wine purchase provides confirmation screen 270. The wine purchase details and a total price for the purchase is displayed in menu area 271 along with a confirmation button 272. Once confirmed by the locker member, a message is sent to the restaurant manager to request that the bottle be physically confirmed and added to the locker. Relevant data tables for these functions are Table 172, Table 178, Table 176, Table 188.

The gifting of wine from a member's VWL is provided for as described with respect to FIGS. 2U-2AC. Relevant data tables are: Table 174, Table 176, Table 182, Table 188.

As provided in FIG. 2K, the personal locker contents screen 237 displays gift button 238 which provides the VWL member with the ability to gift wine from his locker by selecting that gift button at the top right portion of the screen. FIG. 2U shows gifting wines instructional page 273 which displays information 274 for the locker member on how to gift to other locker members or to non-members using an email address. For wine locker members, the gift will result in a locker-to-locker transfer. As previously mentioned, this may take the form of both physical verification and movement of the wine depending on the inventory system integration options built into the system. With respect to non-member gifts, the non-member can redeem their gift with a gift code and their email address the next time they dine in the restaurant. Final verification of the gift is completed by hitting the “create a gift” button 275.

One of two gift recipient screens 277 of FIG. 2V or 281 of FIG. 2X are used to select the recipient depending on whether the recipient is member or not. Selection of a member is a locker-to-locker transaction using the present invention. Selection of a member by selecting VWL member box 278 results in specific bottle selection screen 281 of FIG. 2X. Within that display either a number of bottles may be selected with number selection box 282 and/or specific identification of the specific bottles within the locker may be selected from the gifting member's VWL. If the gift recipient is a non-member recipient identification screen 279 of FIG. 2W is displayed for identification of the recipient wherein the recipient's information including name and email are input into the relevant data fields 280. FIG. 2Y and non-member gift selection screen 283 provides for the selection of the wine when gifting to a non-member.

Following the selection of the specific wines, i.e. selecting “Next” box in either of FIGS. 2V or 2Y, takes the gifting member to screen 285 FIG. 2Z. Personalized message 286 may be created by the gifting member and confirmation of the gift provided at screen 287 of FIG. 2AA. Sending of the gift is completed with button 288. Confirmation screen 289 of FIG. 2AB provides confirmation of the gift.

The receipt of a wine by a VWL non-member's is provided for as described with respect in FIGS. 2AC-2AH. Relevant data tables are: Table 178, Table 182, Table 188.

As provided in FIG. 2AC a locker screen is provided similar to FIG. 2C in which the publicly designated personal locker contents screen 201 displays gift button 204 which provides the VWL member with the ability to gift wine from his locker by selecting that gift button at the bottom portion of the screen. FIG. 2AD shows gift code entry screen 291 including data entry areas 292 and 293 for entering the recipient's email address and gift code respectively. The non-member recipient receives the gift code, by email, when the gifting member selectes the “send the gift” box 288 of confirmation screen 287 FIG. 2AA. As shown in FIG. 2AE, gift details page 295 is provided showing the details of the gift such as the number of bottles, and, a view wines button 296 to reveal the gift. FIG. 2AF shows the gift display screen 298 and the gifted wine 297 including an identification banner 299 showing who the gift was from. Clicking on the gifted wine 297 reveals gift display screen 301 of FIG. 2AG containing a picture of the wine bottle or label and details of the gifted wine, including but not limited to the name, vintage, vineyard, tasting notes and wine description in area 302. By selecting the “redeem this wine” button, 303, gift redemption screen 305 of FIG. 2AH is displayed identifying the gift by gift number, gifting member and visual identification of the gift. A message is sent to the restaurant manager indicating that the gift wishes to be redeemed and for approval of the same. to the screen that provides the gifting wines instructional page 273 which displays information 274 for the locker member on how to gift to other locker members or to non-members using an email address. For wine locker members, the gift will result in a locker-to-locker transfer. As previously mentioned, this may take the form of both physical verification and movement of the wine depending on the inventory system integration options built into the system. With respect to non-member gifts, the non-member can redeem their gift with a gift code and their email address the next time they dine in the restaurant. Final verification of the gift is completed by hitting the “create a gift” button 275.

Virtual Wine Locker (VWL) Client Application—Manager Application

Similar to the patron application, manager-accessibility and functionality is designed for and incorporated with in the table-side mobile devices for portability and ease of use from anywhere within the restaurant. Specific actions by wine locker members kick off messages that are then displayed within the manager applications and manager display sections of the client-side manager applications. Messages can be informational only or they may require specific action on the part of the restaurant. The manager applications also perform various management functions related to the lockers and locker gifts. Relevant data tables are primarily as described before with respect to the patron applications and are identified by the data schema within the table data provided infra.

Access to the manager application and functions is performed through a special authorization page and a hidden login application area 310 as shown in FIG. 2AI. The manager login application area is typically hidden and available only with a specific pinch and swipe action available from certain mobile device screens. Upon successful login, the manager lands on the manager messages page 312 and can view all the wine locker activity for his managed restaurant at a glance. FIG. 2AJ shows the messages displayed for specific activities, e.g. locker wine additions 313, locker gifts accepted 314 or awaiting acceptance and approval 315, and a list of people logged in 316 are displayed on this page. Some of the displayed data is summary information, some of the displayed data is for taking specific actions. A full listing of lockers is available with the lockers button 320 and the gifts button 321.

FIG. 2AK shows the result of clicking on pending locker wine addition 313, FIG. AJ, to reveal full pending locker wine additions page 317. Locker additions can be confirmed by the manager using confirm additions button 318. Information regarding the specific locker from which the gift is made is available by touching button 319 and information regarding the specific wine gift is made is available by touching button 320. In one particularly preferred embodiment of the present application, the manager has to approve wine locker additions since no point of sale payment functions are included in this application. Once payment is provided and the manager approves the locker addition, the purchased provided in connection with FIG. 2T, the wine shows up in locker. Again, since no inventory system is included with the present invention, physical lockers must be physically re-populated and or “lockered” wines may be separated from the general wine inventory.

FIG. 2AL provides the screen display 322 following a clicking on a locker-to-locker gift message 314 in FIG. 2AL. From this screen, the manager is provided with the ability to confirm that the bottle has been moved from the gift-giver to the recipient locker through confirm move button 323. From locker button 324 and to locker button 325 brings up views of the two lockers respectively as provided at FIG. 2D or FIG. 2K.

FIG. 2AM provides informational screen 326 and messages 327 that contain details about newly created gifts as identified and provided by clicking through region 315 of FIG. AJ. Clicking on the patron box 328 permits the manager to view the gifting patron's information.

FIG. 2AN provides informational messages 329 that contain details about new patrons that are logged into the system as identified and provided by clicking through region 316 of FIG. AJ.

FIG. 2AO provides a listing of the Virtual Wine Lockers 331 on a per locker owner basis with at a glance details are displayed from the “Lockers” button 320 on the Manager's main screen. FIG. 2AJ

FIG. 2AP provides locker details for all confirmed and pending wines or wines the have been requested for addition but not yet approved by the restaurant manager—link 332—available for each locker. Conformations of wine transfers following manger approval are made with confirm button 333 and newly added wines may be marked as consumed—button 334—as they are provided to the member during a dining experience. A member's locker wines may also be independently viewed as grouped by confirmed only (FIG. AQ-335) or pending only (FIG. 2AR-336). After consumption, wine will show up on a manager's view of the member history within the manager client application (FIG. 2AS—337).

FIG. 2AT provides locker details for all pending gifts 339 and 341 accessible from the “Gifts” button 321 of manager's messages page 312 FIG. 2AT. Virtual Wine Lockers can be viewed in detail. Gifts to email recipients can be marked as Redeemed using button 340 after which they will then be maintained in the member's gift history page. Gifts to other Virtual Wine Lockers can be marked as “Moved” as distinguished from “Redeemed.”

Virtual Wine Locker (VWL) Management—Web Application.

VWL Data is created and managed from the restaurant or third-party service provider website portal, and in particular the management only interface. New VWLs are created with at least one locker owner and unlimited additional key holders. Wines are added to the locker through a search feature that searches a master database of wines and “adds” a specified bottle count to the VWL. The search process provides instant detailed data specific to the wine that will later display on the client applications. If a wine is not found within the master database, a new generic wine is created. This wine is then manually researched by the sommeliers at the restaurant or using the third-party provider, added to the master database, and made for future searches. Most all VWL member details and gift details can also be managed via the Website as they can through the previously described manager-based client applications.

FIG. 2AU displays the VWL list screen 345 and shows a list of wine lockers 347 at a particular restaurant and pertinent attributes for each locker such as ID 348, name 349, bin 350, locker holder 351, visibility 352 and status 353. New VWL are created when button 355 is accessed by the user. Relevant data tables are: Table 172, Table 174.

FIG. 2AV displays the create VWL Screen 357. New lockers are created and added to the system from this screen when logged in as an Admin User into the web application at the restaurant. New locker owner data can be entered and then saved and assigned as the primary owner or as a keyholder to the new locker. The application allows inventory to be added to the locker by first searching the master database for wines that are already populated through research cataloging. Bottle size 358 and quantity 359 are entered as specific to this wine for this locker. If a wine is searched and not found in the master database, a generic wine is created until the wine can be manually researched and added to the master database. Relevant data tables are: Table 172, Table 174, Table 176, Table 178, Table 180.

FIG. 2AW displays the show wine locker screen 360 which includes the details for a specific locker when selected from wine locker list 345 (FIG. 2AT). Wines can be marked as “Confirmed” or “Consumed” 362 from this screen just as in the managers client application. Confirmed Wines have been physically added to the locker at the restaurant and Consumed wines are then listed in the Historical Wines Inventory as they are no longer physically in the locker. Relevant data tables are: Table 172, Table 174, Table 176.

FIG. 2AX displays the edit wine locker screen 364 which allows for management of an existing virtual wine locker. Attributes such as name 366, visibility 368, etc. can be modified. Owners 370 and keyholders 372 can be added and removed. Wine inventory can also be added/deleted. Relevant data tables are: Table 172, Table 174, Table 176, Table 178, Table 180, Table 182.

FIG. 2AY displays the locker owner list screen 374 and lists all active locker owners while allowing for the selection of any locker owner record in order to examine or edit the details for each owner. Relevant data table is Table 174.

FIG. 2AZ displays the edit locker owner screen 376 which provides update capability for the details of any given locker owner. Relevant data table is Table 174. Restaurants may optionally charge a fee to hold a locker at that restaurant and such renewal data may be stored in this table 378.

FIG. 2AAA displays the locker gift list screen 380 which lists highlighted details for all gifts defined for a particular location including the status of the gift redemptions 382. Originated gifts are gifted but yet redeemed. Accepted are locker-to-locker gifts that have been transferred. Redeemed are non-member gifts that have been cashed in and consumed. The relevant data tables are: Table 172, Table 174.

FIG. 2AAB displays the show locker gift screen 386 containing detailed information 388 about an individual VWL gift. This screen provides the ability to Edit 390 or Delete 392 a gift. The relevant data tables are: Table 172, Table 182.

FIG. 2AAC displays the edit locker gift screen 394 which provides the ability to update attributes 396 of a given VWL gift. The relevant data tables are: Table 172, Table 182.

Restaurant Management Kitchen Preparation Application.

The overall application level system and process for the kitchen preparation (KS) application is graphically presented in FIGS. 3A and 3B. It should be noted that the overall apparatus and processes for the kitchen preparation application may be applied to other similar restaurant processed such as a Bar Sync application. Many of the required restaurant tasks are the same or sufficiently similar that they utilize the same database schema and tables. The dynamic content management ability of the restaurant management software allows for the system to be configured such that many different applications can be created from the same software.

The Administration portion of the application is accessed through a web browser. kitchen preparation data is created and managed from the restaurant or third-party provider website. The food categories and food items and their attributes is managed by restaurant personnel and/or the third-party service provider.

FIGS. 3A and 3B are application level system and process diagrams for the Kitchen Sync (KS) application. Referring to FIG. 3A, the client application(s) 420 are a series of programmed applications running on a tablet or cell phone and operated by restaurant personnel, kitchen staff or restaurant management. In one preferred embodiment, the physical patron devices are larger-sized Apple iPads, approximately 8-13 in. diagonal size—or the size of a typical restaurant menu. Data to and from the web browser application and the KS client application is stored in multiple tables in a relational database 470 hosted in the cloud 407. The KS application programming interface allows for data to be written to and read from the relational database. This API services both internal and external client applications.

Both restaurant employees and management use the graphical touch screen interface of the devices to access the interactive programming of the applications 420 of the present invention. In one specific embodiment, the KS client application runs on an iPad as one application with two distinct user functionalities: one for kitchen staff and one for a restaurant manager. Where necessary, actions that are taken on the kitchen staff portion of the application are logged and sent via messages to the manager portion of the application so that appropriate action may be taken by management through the management application as needed.

A KS Application Programming Interface (API) 430 is written as part of the cloud-based application software and allows for data to be written to and read from the MySQL relational database 470. Amazon API Gateway is a service for publishing, maintaining, and securing web service APIs. API services facilitate the recognition of user actions on the client application programs 420 and the transfer of data to and from the KS databases. This API services applications that are both internal and external to cloud 407, i.e. the external applications 420 available at the restaurant and the applications internal to the AWS cloud-based software. Amazon Elastic Compute Cloud (EC2) is an IaaS service providing virtual servers controllable by an API, based on the Xen hypervisor.

In one embodiment, relational database 470 is implemented using the AWS relational database service (RDS) which provides scalable database servers with MySQL, Oracle, SQL Server, and PostgreSQL support.

Non-relational database(s) 474 are used in connection with client applications 420 to store non-relational data within cloud 407. In one embodiment Amazon DynamoDB provides a scalable, low-latency NoSQL online Database Service backed by SSDs.

The Administration portion of the KS application is also accessible through a web browser 410 and as further described below. Finally, business intelligence data is gathered from the client application and stored in a non-dynamic non-relational data warehouse 476. Amazon Redshift provides petabyte-scale data warehousing with column-based storage and multi-node compute.

Business Intelligence data is also accessed using ad-hoc queries performed on an export of the non-SQL data to a data warehouse 476. Amazon Lambda (AWS Lambda) runs code in response to AWS internal or external events such as http requests, transparently providing the resource required. Business intelligence data and reports 475 are created by client applications and accessed for reporting, primarily via the website application.

In sum, the KS data is created and managed from a central website. This central web site may be associated with and under the control of the offering restaurant itself or a third-party service provider. New KS data and processes are created with at least one process owner and an unlimited number of attending employees. Kitchen preparation processes are added to the KS database(s) through a search feature that searches a master database of processes, stored in database(s) 470, and records the performance one or more specified processes and an associated responsible employee information to the KS database(s). The search process provides instant detailed data specific to each process, and that data is displayed on the mobile devices and within the mobile applications at the appropriate times. If a particular process is not completed, then alarms are created as new database entry and appropriate messaging to management occurs. These processes are then manually checked by the restaurant management or third-party service provider and the associated data is populated with the database which then becomes available for future reference and display. KS process owner details can also be managed via the central web site.

The overall operation of the KS application will now be described with reference to a series of application screen displays and associated tables within the various plurality of KS system databases. It should be appreciated that software-based function calls are made from the client applications and/or the web browser software that result in access to KS API interface 430. These function calls are issued in response to the patron's or manager's operation of the graphical user-interface (GUI) on the client devices. This API then executes against the appropriate database and transfers (i.e. stores or retrieves) the relevant data from various tables. In the KS relational database(s) 470 contains a plurality of tables related to the kitchen prep data (472-488). In this regard, the titles and schema for the following tables are present in the KS application of the present invention.

XML settings file 428 allow for custom configuration of the application for different restaurant system clients. Buttons, screens, and display options are dynamically configured and can be shared across restaurant venues or may be individually set for each venue. These settings reside in cloud 407 and can be updated and re-loaded by the KS application at any time.

TABLE 472
Kitchen Form DB table:

| COLUMN_ | DATA_ | | | | | | | |
|---|---|---|---|---|---|---|---|---|
| NAME | TYPE | PK | NULLABLE | DEFAULT | AUTOINCREMENT | COMPUTED | REMARKS | POSITION |
| id | BIGINT | NO | YES | | YES | NO | | 1 |
| name | VARCH | NO | NO | | NO | NO | | 2 |
| | AR(255) | | | | | | | |
| sort_order | INT | NO | NO | | NO | NO | | 3 |
| type | INT | NO | YES | | NO | NO | | 4 |
| venue_id | BIGINT | NO | NO | | NO | NO | | 5 |
| station_type | INT | NO | YES | | NO | NO | | 6 |
| note | VARCH | NO | YES | | NO | NO | | 7 |
| | AR(528) | | | | | | | |

TABLE 474
User Profile DB table:

| COLUMN_ | | | | | | | | |
|---|---|---|---|---|---|---|---|---|
| NAME | DATA_TYPE | PK | NULLABLE | DEFAULT | AUTOINCREMENT | COMPUTED | REMARKS | POSITION |
| id | BIGINT | YES | NO | | YES | NO | | 1 |
| version | BIGINT | NO | NO | | NO | NO | | 2 |
| date_created | TIMESTAMP | NO | NO | CURRENT_ | NO | NO | | 3 |
| | | | | TIMESTAMP | | | | |
| email | VARCHAR(255) | NO | YES | | NO | NO | | 4 |
| | COLLATE | | | | | | | |
| | utf8_unicode_ci | | | | | | | |
| email_hash | VARCHAR(255) | NO | YES | | NO | NO | | 5 |
| | COLLATE | | | | | | | |
| | utf8_unicode_ci | | | | | | | |
| full_name | VARCHAR(255) | NO | YES | | NO | NO | | 6 |
| | COLLATE | | | | | | | |
| | utf8_unicode_ci | | | | | | | |
| last_updated | TIMESTAMP | NO | NO | CURRENT_ | NO | NO | | 7 |
| | | | | TIMESTAMP | | | | |
| | | | | on update | | | | |
| | | | | CURRENT_ | | | | |
| | | | | TIMESTAMP | | | | |
| nick_name | VARCHAR(255) | NO | YES | | NO | NO | | 8 |
| | COLLATE | | | | | | | |
| | utf8_unicode_ci | | | | | | | |
| non_verified_ | VARCHAR(255) | NO | YES | | NO | NO | | 9 |
| email | COLLATE | | | | | | | |
| | utf8_unicode_ci | | | | | | | |
| owner_id | BIGINT | NO | YES | | NO | NO | | 10 |
| first_name | VARCHAR(255) | NO | YES | | NO | NO | | 11 |
| | COLLATE | | | | | | | |
| | utf8_unicode_ci | | | | | | | |
| security_level | INT | NO | YES | | NO | NO | | 12 |
| security_string | VARCHAR(255) | NO | YES | | NO | NO | | 13 |
| | COLLATE | | | | | | | |
| | utf8_unicode_ci | | | | | | | |
| external_ | LONGTEXT | NO | YES | | NO | NO | | 14 |
| account_id | COLLATE | | | | | | | |
| | utf8_unicode_ci | | | | | | | |
| phone | VARCHAR(64) | NO | YES | | NO | NO | | 15 |
| | COLLATE | | | | | | | |
| | utf8_unicode_ci | | | | | | | |
| class | VARCHAR(255) | NO | NO | | NO | NO | | 16 |
| | COLLATE | | | | | | | |
| | utf8_unicode_ci | | | | | | | |
| activity_ | VARCHAR(255) | NO | YES | | NO | NO | | 17 |
| report_frequency | COLLATE | | | | | | | |
| | utf8_unicode_ci | | | | | | | |
| review_ | VARCHAR(255) | NO | YES | | NO | NO | | 18 |
| report_frequency | COLLATE | | | | | | | |
| | utf8_unicode_ci | | | | | | | |
| comment_ | VARCHAR(255) | NO | YES | | NO | NO | | 19 |
| report_frequency | COLLATE | | | | | | | |
| | utf8_unicode_ci | | | | | | | |
| detail_ | VARCHAR(255) | NO | YES | | NO | NO | | 20 |
| report_frequency | COLLATE | | | | | | | |
| | utf8_unicode_ci | | | | | | | |
| follower_ | VARCHAR(255) | NO | YES | | NO | NO | | 21 |
| report_frequency | COLLATE | | | | | | | |
| | utf8_unicode_ci | | | | | | | |
| summary_ | VARCHAR(255) | NO | YES | | NO | NO | | 22 |
| report_frequency | COLLATE | | | | | | | |
| | utf8_unicode_ci | | | | | | | |
| follower_id | BIGINT | NO | YES | | NO | NO | | 23 |
| address1 | VARCHAR(255) | NO | YES | | NO | NO | | 24 |
| | COLLATE | | | | | | | |
| | utf8_unicode_ci | | | | | | | |
| address2 | VARCHAR(255) | NO | YES | | NO | NO | | 25 |
| | COLLATE | | | | | | | |
| | utf8_unicode_ci | | | | | | | |
| city | VARCHAR(255) | NO | YES | | NO | NO | | 26 |
| | COLLATE | | | | | | | |
| | utf8_unicode_ci | | | | | | | |
| company | VARCHAR(255) | NO | YES | | NO | NO | | 27 |
| | COLLATE | | | | | | | |
| | utf8_unicode_ci | | | | | | | |
| state | VARCHAR(255) | NO | YES | | NO | NO | | 28 |
| | COLLATE | | | | | | | |
| | utf8_unicode_ci | | | | | | | |
| zip_code | VARCHAR(255) | NO | YES | | NO | NO | | 29 |
| | COLLATE | | | | | | | |
| | utf8_unicode_ci | | | | | | | |
| yes_email_flag | BIT | NO | YES | | NO | NO | | 30 |
| anniversary | DATETIME | NO | YES | | NO | NO | | 31 |
| birthday | DATETIME | NO | YES | | NO | NO | | 32 |
| notes | LONGTEXT | NO | YES | | NO | NO | | 33 |
| | COLLATE | | | | | | | |
| | utf8_unicode_ci | | | | | | | |
| current_lease_ | VARCHAR(128) | NO | YES | | NO | NO | | 34 |
| year | COLLATE | | | | | | | |
| | utf8_unicode_ci | | | | | | | |
| intended_fee | VARCHAR(128) | NO | YES | | NO | NO | | 35 |
| | COLLATE | | | | | | | |
| | utf8_unicode_ci | | | | | | | |
| renewal_date | DATETIME | NO | YES | | NO | NO | | 36 |
| renewal_status | VARCHAR(128) | NO | YES | | NO | NO | | 37 |
| | COLLATE | | | | | | | |
| | utf8_unicode_ci | | | | | | | |
| theoretical_ | VARCHAR(128) | NO | YES | | NO | NO | | 38 |
| fee_due | COLLATE | | | | | | | |
| | utf8_unicode_ci | | | | | | | |
| waived_locker | BIT | NO | YES | | NO | NO | | 39 |
| email_enc | VARCHAR(255) | NO | YES | | NO | NO | | 40 |
| | COLLATE | | | | | | | |
| | utf8_unicode_ci | | | | | | | |
| phone_enc | VARCHAR(255) | NO | YES | | NO | NO | | 41 |
| | COLLATE | | | | | | | |
| | utf8_unicode_ci | | | | | | | |
| last_name_enc | VARCHAR(255) | NO | YES | | NO | NO | | 42 |
| | COLLATE | | | | | | | |
| | utf8_unicode_ci | | | | | | | |
| phone_enc | VARCHAR(255) | NO | YES | | NO | NO | | 43 |
| | COLLATE | | | | | | | |
| | utf8_unicode_ci | | | | | | | |

TABLE 477
Level Permission DB table:

| COLUMN_ | | | | | | | | |
|---|---|---|---|---|---|---|---|---|
| NAME | DATA_TYPE | PK | NULLABLE | DEFAULT | AUTOINCREMENT | COMPUTED | REMARKS | POSITION |
| level_permission_ | BIGINT | NO | YES | | NO | NO | | 1 |
| id | | | | | | | | |
| first_string | VARCHAR(255) | NO | YES | | NO | NO | | 2 |
| | COLLATE | | | | | | | |
| | utf8_unicode_ci | | | | | | | |

TABLE 478
Specialty Category DB table:

| COLUMN_ | | | | | | | | |
|---|---|---|---|---|---|---|---|---|
| NAME | DATA_TYPE | PK | NULLABLE | DEFAULT | AUTOINCREMENT | COMPUTED | REMARKS | POSITION |
| id | BIGINT | YES | NO | | YES | NO | | 1 |
| version | BIGINT | NO | NO | | NO | NO | | 2 |
| bd_updates_ | BIGINT | NO | NO | | NO | NO | | 3 |
| history_id | | | | | | | | |
| image | VARCHAR(128) | NO | NO | | NO | NO | | 4 |
| | COLLATE | | | | | | | |
| | utf8_unicode_ci | | | | | | | |
| instance_state | VARCHAR(255) | NO | YES | | NO | NO | | 5 |
| | COLLATE | | | | | | | |
| | utf8_unicode_ci | | | | | | | |
| name | VARCHAR(255) | NO | NO | | NO | NO | | 6 |
| | COLLATE | | | | | | | |
| | utf8_unicode_ci | | | | | | | |
| sort_order | INT | NO | NO | | NO | NO | | 7 |
| specialty_id | BIGINT | NO | YES | | NO | NO | | 8 |
| venue_id | BIGINT | NO | NO | | NO | NO | | 9 |
| modified_date | TIMESTAMP | NO | NO | CURRENT_ | NO | NO | | 10 |
| | | | | TIMESTAMP | | | | |
| | | | | on update | | | | |
| | | | | CURRENT_ | | | | |
| | | | | TIMESTAMP | | | | |
| parent_specialty_ | BIGINT | NO | YES | | NO | NO | | 11 |
| category_id | | | | | | | | |
| name_spanish | VARCHAR(255) | NO | YES | | NO | NO | | 12 |
| | COLLATE | | | | | | | |
| | utf8_unicode_ci | | | | | | | |
| id_string | VARCHAR(128) | NO | YES | | NO | NO | | 13 |
| | COLLATE | | | | | | | |
| | utf8_unicode_ci | | | | | | | |
| create_date | TIMESTAMP | NO | NO | CURRENT_ | NO | NO | | 14 |
| | | | | TIMESTAMP | | | | |

TABLE 480
Specialty Product DB table:

| COLUMN_ | | | | | | | | |
|---|---|---|---|---|---|---|---|---|
| NAME | TDATA_YPE | PK | NULLABLE | DEFAULT | AUTOINCREMENT | COMPUTED | REMARKS | POSITION |
| id | BIGINT | YES | NO | | YES | NO | | 1 |
| version | BIGINT | NO | NO | | NO | NO | | 2 |
| bd_updates_ | BIGINT | NO | NO | | NO | NO | | 3 |
| history_id | | | | | | | | |
| description | MEDIUMTEXT | NO | NO | | NO | NO | | 4 |
| | COLLATE | | | | | | | |
| | utf8_unicode_ci | | | | | | | |
| image | VARCHAR(128) | NO | NO | | NO | NO | | 5 |
| | COLLATE | | | | | | | |
| | utf8_unicode_ci | | | | | | | |
| instance_state | VARCHAR(255) | NO | YES | | NO | NO | | 6 |
| | COLLATE | | | | | | | |
| | utf8_unicode_ci | | | | | | | |
| name | VARCHAR(255) | NO | NO | | NO | NO | | 7 |
| | COLLATE | | | | | | | |
| | utf8_unicode_ci | | | | | | | |
| price | DOUBLE | NO | NO | | NO | NO | | 8 |
| sort_order | INT | NO | NO | | NO | NO | | 9 |
| specialty_ | BIGINT | NO | YES | | NO | NO | | 10 |
| category_id | | | | | | | | |
| venue_id | BIGINT | NO | NO | | NO | NO | | 11 |
| out_of_stock | BIT | NO | NO | | NO | NO | | 12 |
| prices_string | VARCHAR(128) | NO | YES | | NO | NO | | 13 |
| | COLLATE | | | | | | | |
| | utf8_unicode_ci | | | | | | | |
| modified_date | TIMESTAMP | NO | NO | CURRENT_ | NO | NO | | 14 |
| | | | | TIMESTAMP | | | | |
| | | | | on update | | | | |
| | | | | CURRENT_ | | | | |
| | | | | TIMESTAMP | | | | |
| description_spanish | LONGTEXT | NO | YES | | NO | NO | | 15 |
| | COLLATE | | | | | | | |
| | utf8_unicode_ci | | | | | | | |
| has_spanish_ | BIT | NO | NO | | NO | NO | | 16 |
| image | | | | | | | | |
| name_spanish | VARCHAR(255) | NO | YES | | NO | NO | | 17 |
| | COLLATE | | | | | | | |
| | utf8_unicode_ci | | | | | | | |
| id_string | VARCHAR(128) | NO | YES | | NO | NO | | 18 |
| | COLLATE | | | | | | | |
| | utf8_unicode_ci | | | | | | | |
| create_date | TIMESTAMP | NO | NO | CURRENT_ | NO | NO | | 19 |
| | | | | TIMESTAMP | | | | |

TABLE 482
Specialty DB table:

| COLUMN_ | | | | | | | | |
|---|---|---|---|---|---|---|---|---|
| NAME | DATA_TYPE | PK | NULLABLE | DEFAULT | AUTOINCREMENT | COMPUTED | REMARKS | POSITION |
| id | BIGINT | YES | NO | | YES | NO | | 1 |
| version | BIGINT | NO | NO | | NO | NO | | 2 |
| bd_updates_ | BIGINT | NO | NO | | NO | NO | | 3 |
| history_id | | | | | | | | |
| image | VARCHAR(128) | NO | NO | | NO | NO | | 4 |
| | COLLATE | | | | | | | |
| | utf8_unicode_ci | | | | | | | |
| instance_state | VARCHAR(255) | NO | YES | | NO | NO | | 5 |
| | COLLATE | | | | | | | |
| | utf8_unicode_ci | | | | | | | |
| name | VARCHAR(255) | NO | NO | | NO | NO | | 6 |
| | COLLATE | | | | | | | |
| | utf8_unicode_ci | | | | | | | |
| sort_order | INT | NO | NO | | NO | NO | | 7 |
| venue_id | BIGINT | NO | NO | | NO | NO | | 8 |
| modified_date | TIMESTAMP | NO | NO | CURRENT_ | NO | NO | | 9 |
| | | | | TIMESTAMP | | | | |
| | | | | on update | | | | |
| | | | | CURRENT_ | | | | |
| | | | | TIMESTAMP | | | | |
| name_spanish | VARCHAR(255) | NO | YES | | NO | NO | | 10 |
| | COLLATE | | | | | | | |
| | utf8_unicode_ci | | | | | | | |
| id_string | VARCHAR(128) | NO | YES | | NO | NO | | 11 |
| | COLLATE | | | | | | | |
| | utf8_unicode_ci | | | | | | | |
| create_date | TIMESTAMP | NO | NO | CURRENT_ | NO | NO | | 12 |
| | | | | TIMESTAMP | | | | |

TABLE 484
Timing Result DB table:

| COLUMN_ | | | | | | | | |
|---|---|---|---|---|---|---|---|---|
| NAME | DATA_TYPE | PK | NULLABLE | DEFAULT | AUTOINCREMENT | COMPUTED | REMARKS | POSITION |
| id | BIGINT | YES | NO | | YES | NO | | 1 |
| version | BIGINT | NO | NO | | NO | NO | | 2 |
| end_date | DATETIME | NO | NO | | NO | NO | | 3 |
| specialty_product_ | BIGINT | NO | NO | | NO | NO | | 4 |
| id | | | | | | | | |
| start_date | DATETIME | NO | NO | | NO | NO | | 5 |
| user_id | BIGINT | NO | NO | | NO | NO | | 6 |
| venue_id | BIGINT | NO | NO | | NO | NO | | 7 |

TABLE 486
Form Item DB table:

| COLUMN_ | DATA_ | | | | | | | |
|---|---|---|---|---|---|---|---|---|
| NAME | TYPE | PK | NULLABLE | DEFAULT | AUTOINCREMENT | COMPUTED | REMARKS | POSITION |
| id | BIGINT | YES | NO | | YES | NO | | 1 |
| default_on_ | BIGINT | NO | YES | | NO | NO | | 2 |
| hand_unit_id | | | | | | | | |
| default_prep_ | BIGINT | NO | YES | | NO | NO | | 3 |
| unit_id | | | | | | | | |
| max_temperature | FLOAT | NO | YES | | NO | NO | | 4 |
| mini_temperature | FLOAT | NO | YES | | NO | NO | | 5 |
| name | VARCH | NO | NO | | NO | NO | | 6 |
| | AR(255) | | | | | | | |
| note | VARCH | NO | YES | | NO | NO | | 7 |
| | AR(255) | | | | | | | |
| shelf_life | INT | NO | YES | | NO | NO | | 8 |
| sort_order | INT | NO | YES | | NO | NO | | 9 |
| specialty_product_ | INT | NO | YES | | NO | NO | | 10 |
| id | | | | | | | | |
| tool | VARCH | NO | YES | | NO | NO | | 11 |
| | AR(128) | | | | | | | |
| type | INT | NO | YES | | NO | NO | | 12 |
| venue_id | BIGINT | NO | NO | | NO | NO | | 13 |
| hold | VARCH | NO | YES | | NO | NO | | 14 |
| | AR(128) | | | | | | | |
| result_type | INT | NO | YES | | NO | NO | | 15 |
| prep_time_ | INT | NO | YES | | NO | NO | | 16 |
| average | | | | | | | | |
| dinner_weight | FLOAT | NO | YES | | NO | NO | | 17 |
| lunch_weight | FLOAT | NO | YES | | NO | NO | | 18 |
| prep_ratio | FLOAT | NO | YES | | NO | NO | | 19 |
| rounding_limit | FLOAT | NO | YES | | NO | NO | | 20 |
| default_par_ | BIGINT | NO | YES | | NO | NO | | 21 |
| unit_id | | | | | | | | |

TABLE 488
Video DB table:

| COLUMN_ | | | | | | | | |
|---|---|---|---|---|---|---|---|---|
| NAME | DATA_TYPE | PK | NULLABLE | DEFAULT | AUTOINCREMENT | COMPUTED | REMARKS | POSITION |
| id | BIGINT | YES | NO | | YES | NO | | 1 |
| version | BIGINT | NO | NO | | NO | NO | | 2 |
| backside_string | VARCHAR(128) | NO | YES | | NO | NO | | 3 |
| | COLLATE | | | | | | | |
| | utf8_unicode_ci | | | | | | | |
| downloadurl | VARCHAR(128) | NO | YES | | NO | NO | | 4 |
| | COLLATE | | | | | | | |
| | utf8_unicode_ci | | | | | | | |
| food_id | BIGINT | NO | YES | | NO | NO | | 5 |
| genome_wine_ | BIGINT | NO | YES | | NO | NO | | 6 |
| id | | | | | | | | |
| image_name | VARCHAR(128) | NO | YES | | NO | NO | | 7 |
| | COLLATE | | | | | | | |
| | utf8_unicode_ci | | | | | | | |
| instance_state | VARCHAR(255) | NO | YES | | NO | NO | | 8 |
| | COLLATE | | | | | | | |
| | utf8_unicode_ci | | | | | | | |
| modified_date | DATETIME | NO | YES | | NO | NO | | 9 |
| person_id | BIGINT | NO | YES | | NO | NO | | 10 |
| streamurl | VARCHAR(128) | NO | YES | | NO | NO | | 11 |
| | COLLATE | | | | | | | |
| | utf8_unicode_ci | | | | | | | |
| title | VARCHAR(128) | NO | YES | | NO | NO | | 12 |
| | COLLATE | | | | | | | |
| | utf8_unicode_ci | | | | | | | |
| venue_id | BIGINT | NO | YES | | NO | NO | | 13 |
| code | INT | NO | YES | | NO | NO | | 14 |
| genome_wine_ | INT | NO | YES | | NO | NO | | 15 |
| external_id | | | | | | | | |
| specialty1e | INT | NO | YES | | NO | NO | | 16 |
| external_id | | | | | | | | |
| specialty2e | INT | NO | YES | | NO | NO | | 17 |
| external_id | | | | | | | | |
| specialty3e | INT | NO | YES | | NO | NO | | 18 |
| external_id | | | | | | | | |

Kitchen Preparation—Client Application for Kitchen Staff and Managers

FIG. 3B illustrates one particularly preferred method flow according to the present invention. Although numerous processes are described win this application, the method of FIG. 3B is illustrative. The process starts at 490 and at step 491 the API transmits a list of items to be prepared in the restaurant kitchen along with a par value and on-hand data for those items. At step 492, the mobile device calculates a preparation amount based on the on-hand and par data received. At step 493, a timer is started by the mobile device, and at step 494 the kitchen staff member prepares the preparation amount. He or she then stops the timer on the mobile device at 495. At step 496, a kitchen manager sends a message to the API to approve of the preparation completion and the process finishes at step 497. This method is specific to the data involved in the transaction as described but is representative of the overall message flows taking place within the system of FIG. 3A.

FIG. 3C displays the main screen 501 of the KS application which offers limited functionality without a login. Since the KS application is used by restaurant employees and managers, login screens accessible through login button 502 are preferred to provide these personnel with application and data access, similar to that provided in FIG. 2I in connection with the VWL application and FIG. 31 supra. Included within the KS application are accessible programs and data related to recipes 503, food guides 504 pertaining to standards for how food should be presented, specifications 506 or quality specifications for various foods, promotions 508 and videos 507. All KS applications are accessible from the main screen 501 through the touch-screen interface. An ability to run the application in Spanish 509 is also available from this screen. Home screen buttons are configurable from the settings file 420 and can be used to represent any information needed. Relevant data table is Table 478.

FIG. 3D displays the categories 510 for the recipes button 503 of FIG. 3C. Any button on the main 501 resulted in a categories screen 511 being displayed when a home screen button is selected. Search capabilities exist across all recipes when search word or phrase are entered into the search box field 513. Relevant data table is Table 472.

FIG. 3E: shows an exemplary display 514 of all available items listed for a particular category once a category button 510 is selected on categories display 511. This FIG. is an example of items listed for the “Salads” button. All other categories available from categories display 511 are dropped to a reduced-size graphic display 516 listed at the bottom of the screen for easy navigation and switching between categories. Relevant data tables are: Table 472, Table 486.

FIG. 3F displays the menu item display 518 resulting from the selection of an item from the list in FIG. 3E. FIG. 3F shows the recipe details 520 for the dinner salad selected item. Relevant recipe data includes plating data 521, exposition data 522, to go instructions 523, exemplary presentation pictures 524, ingredients 525, culinary quality points 526 and service description 527. Relevant data table is Table 480.

It should be noted that the process steps shown in FIGS. 3D-3F are also repeated for the main screen selections Food Guide, Specifications, and Promotions.

FIG. 3G: video display screen 528 displays videos 529 that may be selected for viewing which are accessible and searchable from the Videos button 507 on the main screen. The videos may include training videos and the like for providing work-related instructions to employees. Relevant data table is Table 488.

FIG. 3H displays the Spanish version of the KS application. Selecting Spanish button 509 results in all labels, and content being displayed in Spanish. Selecting the English button 530 toggles the KS application back again to English. Relevant data table is Table 478.

FIG. 31 displays the login screen 532 which results from selecting the login button 502 of FIG. 3C. This display screen permits the kitchen staff member or manager to enter their username and password in the relevant fields 534 for logging into the KS application. Typically, there are two levels of authentication provided: one for managers and one for kitchen staff. Relevant data tables are: Table 474, Table 476.

FIG. 3J displays user time entry area 536 in which kitchen staff are required to entire the time that their shift ends. This is used to evaluate performance metrics as described below and to provide shift-end alerts for the kitchen staff. Confirmation on the darkened button at the bottom completes the login time entry process. Relevant data tables are: Table 474, Table 476.

FIG. 3K displays the fully activated login main menu 538. Logged-in personnel still have access to the same main menu functions as in FIG. 3C and further have a menu bar 539 at the screen bottom from which all personnel can manage and track backroom work that they accomplish. Relevant data tables are: Table 474, Table 476, Table 478.

FIG. 3L, accessible from the bottom menu bar 539, displays a number buttons 541 associated with a series of line check displays. Each line checks display page pertains to a different restaurant station that requires periodic checking. Each line category can be viewed one at a time or the “All Stations” button 543 can be selected to list all of the stations in one long list. Relevant data table is 472.

FIG. 3M displays one-line check screen 545 associated with the Expo station within the kitchen. As displayed, a line check is scheduled for this station for between at least an AM 546 and PM 547 check period for each of the different stations 550 on that line. This display is configurable by restaurant. Examples of things to check are whether the proper tools are present and in which sizes, whether they are to be hot, cold or room temperature (RT) etc. Each of the line checklists has all of the items listed for the particular category along with an AM and PM checkbox. The kitchen staff personnel touches each box to signify that he has checked the item, the checkmark goes from red to green as data is saved on the server and the workers initials are saved in the top left-hand corner for traceability. The person (Mike Smith) logged into a mobile client device is shown at the bottom bar area 551. Relevant data table is: Table 478.

FIG. 3N displays on-hand counts for cooking ingredients as selected from the on hands button in menu 539. Categories for each station 552 or all stations are displayed when selecting the On Hand button. Relevant data table is: Table 472.

Every item in kitchen has a par value which is an estimated amount of the item that needs to be on hand for any given day and/or shift. Most items last for a limited number of days and then they are discarded. Par value is estimated by the system of the present invention and if the on-hand count is lower than that needed for a particular day then additional preparation is needed.

FIG. 3O displays the produce on-hand count for this particular restaurant. Items for each on-hand produce category 554 are listed and portions are set by tapping the numbers field to the right of each item in sequence. The amount is saved to the right and the staff member's name is entered below the item for traceability. Note that different units of measure may be appropriate for different food categories and items. Baked Sweet Potato are shown as being checked 556 by Mike S at 12:13PM. Kitchen Staff and Managers have permissions to set/alter on-hand counts. Relevant data table is Table 486.

FIG. 3P displays the manage prep categories as provided by the button in menu bar 539. Different types of pre-prepared foods are required to ready the restaurant for a shift and they are managed from this screen 558. Relevant data table is: Table 472.

FIG. 3Q displays the produce mange prep list where par values 560 are used to store each item and compare that item count against the on-hand count 562 to determine the amount of each item that needs to be prepped for the day 564. The par value is a value calculated by the system of the present invention based on historical data generated by the restaurant and stored in data warehouse 476 and MySQL DB 470 and from which valuable kitchen prep business intelligence reports are generated at 475. Although the par values are ideally automatically pre-filled, they can be edited and overridden by anyone with the proper privileges. Further, items can be set to “emergency 911” (button 565) status so that staff members prep those items first and possibly procure more if the on-hand amounts fall below zero. Items can also receive a “DNP” or Do Not Prep status for any reason (button 566). Relevant data table is: Table 486.

FIG. 3R displays the prep list category screen 570 which functions very similarly to the line checks screen. Relevant data table is Table 472. FIG. 3S displays the result of selecting a pre-list button and shows a list of tasks 572 for staff to begin their prep work. FIG. 3S displays the list of tasks related to the produce preparation. To work on any item, the staff member simply selects the “Start” button 574 to the right of each item. Mike has started the burger set prep item for which 35 portions are needed 576 (two display locations) and regarding which a timer is kicked off that times that task (upper right timer running 40 seconds on the Burger Set task 578). Tasks are marked complete once staff members receive a manager sign-off as shown in the completed grapes task 580 which was done on Thursday by MS and marked as such. Relevant data tables are: Table 484, Table 486.

FIG. 3T, displays a manager logged into the KS application where the manager can see all of the prep tasks currently running for their team, notably that MS is 2:39 into his burger set prep task 582 for which 35 portions are required. Relevant data tables are: Table 474, Table 476, Table 478, Table 484.

FIG. 3U displays a double-tapped timer window 584 showing the cessation of prepping authorization which stops the prep timer once the prepping completion is verified and the manager code is entered. Relevant data tables are: Table 476, Table 484.

FIG. 3V displays the critical walk selectable from menu bar 539 and opens the temperature check display 586 portion of the KS application. Here a kitchen staff member logs the task of checking temperatures on refrigerators for food safety purposes at various times of the day 587. Relevant data table is at table 472.

FIG. 3W displays the data entry display 588 from tapping button 587 and permits health and safety data 590 (e.g. temperature and cleanliness condition) to be input to the system of the present invention and recorded for each of the health and safety categories 592. The AM walk tracks and ensures that all health, safety and cleanliness checks have been completed by the staff. Each checked item is traceable to the person signing off on the work. Relevant data table is at table 486.

FIG. 3X displays the pull data screen 593 selectable from menu bar 539. The pull list represents food items that require pre-preparation such as thawing and the pull list items 594 is configured with specific amounts and units (pounds, bags, tubs etc.) for each item by selecting the numbers needed below for each one and the day on which they should be pulled 596. Sunday items to be pulled 598 are highlighted in the display of FIG. 3X as shown. When the pull button to the right is tapped, the item is marked “Done” and kitchen staff initials are added for traceability. Relevant data table is at Table 480.

FIG. 3Y displays the report preparation and selection screen 600 from which managers can access daily and weekly productivity reports as well as a history report for both individual members and the entire staff. Relevant data table is at Table 472, Table 474, Table 476, Table 478, Table 480, Table 482, Table 484, Table 486, Table 488.

FIG. 3Z displays an individual staff member report for Mike Smith 610 where beginning work times are displayed by longer lines 612 and the amount of time worked on any one task 614 is displayed. Since Mr. Smith has only performed one task without any breaks between sequential tasks, the work efficiency is shown as 100% active and 0% inactive. Over the course of one shift and the working relationship of any given employee, different reports and efficiency metrics can be established and recorded to optimize the work staff's capabilities and the overall restaurant efficiency. Relevant data tables are: Table 472, Table 474, Table 476, Table 478, Table 480, Table 482, Table 484, Table 486, Table 488.

Kitchen preparation—Web Browser Application for Kitchen Managers

Just as with the VWL application, the KS application data can be managed from a web browser that accesses the cloud 407 and through the proprietary web site of the restaurant or third-party service provider.

FIG. 3AA displays a list of kitchen forms 620 which are accessible through a manager's login. Each kitchen form functions as a category for kitchen food items. From this screen one can add or edit a new kitchen forms. The entire KS application is configurable to a particular restaurant's preferred use.

FIG. 3AB displays the kitchen form for the Expo Station where that form can be edited to change name 622, type 624 or the list of items to manage on the form 626.

FIG. 3AC displays the create kitchen form screen 630 where new kitchen forms can be added and configured.

FIG. 3AD displays the form item list screen 631 where items 632 can be edited or created from forms. Maximum and minimum temperatures 634 as well as other safety information 636 and notes 638 can be input for each item to ensure its proper storage and preparation. The tools 640 needed for the line checks can be configured. Id numbers and sort codes can be used to categorize the items.

FIG. 3AE displays the create form item sheet 642 in which individual items 632 are configured to be associated with a kitchen form. The create form item screen allows the manager to create form/food items which then can be associated to a kitchen form.

FIG. 3AF displays the form unit list 644 which is set up and managed from this page 643 and from which any form item can be assigned to a form unit 644 on the form item screens.

FIG. 3AG displays the result of clicking on a form item 646 from the list of FIG. 3AD and shows the details for the that form item along with the ability for editing and deleting.

Third Party Service Provider Business Method.

It should be appreciated that the overall systems, apparatus, and methods of the above-described invention also benefit from (actually almost require) a high-level management function to operate properly. While the restaurant could conceivably manage all of the data entry and form creation and population involved with the present invention, this is not typically within their present operating paradigms and business models. As previously mentioned, many restaurants work from a paper-based model simply because the efforts required to code software, arranging IT structure etc. are too time consuming and not critical to the core restaurant business. This is, of course, changing in today's computer-driven information technology environment. Restaurants must modernize to remain competitive. Therefore, the present invention provides the ideal opportunity for third party service providers to step in and relieve restaurants of this burden so as to provide value-added subscription services that enhance the dining experience at the restaurant venues.

Thus, in one business embodiment, the apparatus and method of the present invention can operate based on a subscription model. A third-party (non-restaurant) can design and implement all or any portion of the system of the present invention. That third party can have a price-tiered subscription approach in which incremental charges are assessed for implementing and delivering various functionality of the present system. For example, implementing and operating the VWL can be a first-tier charge. Maintaining, updating, providing research for the databases within the VWL may constitute a second-level of service which is independently priced. Add-on components and functionality such as the kitchen preparation application would be treated likewise. In this manner, one or more service providers can accept the responsibility for implementing one, more or all of the individual components of the present system depending on their respective abilities to do so and associated costs in providing those services and functionality. Over time, competition will emerge possibly driving down the overall cost of individual components as third-party implementers becomes more efficient. The ubiquity and flexibility of the overall system of the present invention lends itself to a plurality of competitive advantages that have yet to be realized.

The terms “a” or “an,” as used herein, are defined as one or more than one. The term “another,” as used herein, is defined as at least a second or more.

The terms “including” and/or “having”, as used herein, are defined as comprising (i.e., open transition).

The term “coupled” or “operatively coupled,” as used herein, is defined as connected, although not necessarily directly and mechanically.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

Although various embodiments, which incorporate the teachings of the present invention have been shown and described in detail herein, those skilled in the art can readily devise many other varied embodiments that still incorporate these teachings.

The invention claimed is:

1. A computer-based restaurant management system for storing and retrieving wines within a restaurant, said computer-based restaurant management system including a computer-based mobile network, said computer-based restaurant management system comprising:
at least one computer-based mobile device employed by a restaurant patron within said restaurant management system, said mobile device coupled to said computer-based mobile network, said mobile device including a processor and an associated memory for storing instructions executed by said processor, said mobile device including a virtual wine locker client application operated from said associated memory by said processor;
a computer-based cloud network, said computer-based cloud network coupled to said computer-based mobile network and said at least one computer-based mobile device, said computer-based cloud network implementing a virtual wine locker content management system for storing an inventory of wine for said restaurant patron, said virtual wine locker content management system including an application programing interface managed by said computer- based cloud network;
a database managed by said computer-based cloud network, said application programming interface coupled to said database and transmitting computer-based instructions between said virtual wine locker client application operating on said mobile device and said database, said database containing a plurality of data tables, said date tables including a wine locker table containing wine locker owner data, a locker wines table containing at least one bottle of wine having a identifying wine id, and a venue wine database containing a bottle sales price; and
wherein said application programming interface transmits said bottle sale price data to said virtual wine locker client application and said restaurant patron transmits a purchase message including said wine locker owner data to said application programming interface in response thereto, said application programming interface updating said locker wines table to include said wine having said identifying wine id.

2. The system of claim 1 wherein said.

3. The system of claim 2 wherein said

4. The system of claim 2 wherein said.

5. The system of claim 2 wherein.

6. The system of claim 2 wherein.

7. The system of claim 2.

8. The system of claim 2 wherein.

9. A computer-implemented method for storing and retrieving wines within a restaurant using a computer-based restaurant management system coupled to a computer-based mobile network, said computer-based restaurant management system including at least one computer-based mobile device employed by a restaurant patron, said at least one mobile device including a processor and an associated memory for storing instructions executed by said processor, said at least one mobile device including a virtual wine locker client application operating from said associated memory under the direction of said processor, said computer-based restaurant management system including a computer-based cloud network, said computer-based cloud network coupled to said computer-based mobile network and said at least one computer-based mobile device, said computer-based cloud network implementing a virtual wine locker content management system for storing an inventory of wine for said restaurant patron, said virtual wine locker content management system including an application programing interface managed by said computer-based cloud network; said method comprising:
transmitting with said applications program interface to said at least one computer-based mobile device a bottle sales price data from a venue wine data table, said database including said venue wine data table;
receiving said bottle sales price data at said virtual wine locker client application;
transmitting a purchase message including wine locker owner data from said virtual wine locker application on said at least one computer-based mobile device to said application programming interface, said wine locker owner data being contained within a wine locker table within said database; and
updating a locker wines table having said wine locker owner data with an identifying wine id from a locker wines table, said locker wines table.

10. The method of claim 9 further comprising.

11. The method of claim 10 wherein said step of

12. The method of claim 10 further comprising:
feeding back completed

13. The method of claim 9 further comprising:

14. The method of claim 9 wherein.

15. A computer-implemented system for, an module.

16. The system of claim 15 wherein said.

17. The system of claim 16 wherein said.

18. The system of claim 15 wherein said.

19. The system of claim 15 wherein said.
